(19) United States
(12) Patent Application Publication
(10) Pub. No.: US 2026/0003160 A1
(43) Pub. Date: Jan. 1, 2026

(54) IMAGING OPTICAL LENS ASSEMBLY, IMAGE CAPTURING UNIT AND ELECTRONIC DEVICE

(71) Applicant: LARGAN PRECISION CO., LTD., Taichung City (TW)

(72) Inventors: Huan You LIN, Taichung City (TW); Kuo-Jui WANG, Taichung City (TW); Guan-Jr LIAO, Taichung City (TW)

(73) Assignee: LARGAN PRECISION CO., LTD., Taichung City (TW)

(21) Appl. No.: 18/789,230

(22) Filed: Jul. 30, 2024

(30) Foreign Application Priority Data
Jun. 28, 2024 (TW) 113124284

(51) Int. Cl. G02B 9/64; G02B 13/00; H04N 23/55

(52) U.S. Cl. CPC G02B 9/64; G02B 13/0045; H04N 23/55

(57) ABSTRACT

An imaging optical lens assembly includes seven lens elements which are, in order from an object side to an image side along an optical path: a first lens element, a second lens element, a third lens element, a fourth lens element, a fifth lens element, a sixth lens element and a seventh lens element. The first lens element has negative refractive power. The second lens element with negative refractive power has an image-side surface being concave in a paraxial region thereof. The fifth lens element with negative refractive power has an image-side surface being concave in a paraxial region thereof. The sixth lens element has an image-side surface being concave in a paraxial region thereof. The seventh lens element has an image-side surface being concave in a paraxial region thereof and having at least one inflection point.

### RELATED APPLICATIONS

This application claims priority to Taiwan Application 113124284, filed on Jun. 28, 2024, which is incorporated by reference herein in its entirety.

### BACKGROUND

### Technical Field

The present disclosure relates to an imaging optical lens assembly, an image capturing unit and an electronic device, more particularly to an imaging optical lens assembly and an image capturing unit applicable to an electronic device.

### Description of Related Art

With the development of semiconductor manufacturing technology, the performance of image sensors has improved, and the pixel size thereof has been scaled down. Therefore, featuring high image quality becomes one of the indispensable features of an optical system nowadays.

Furthermore, due to the rapid changes in technology, electronic devices equipped with optical systems are trending towards multi-functionality for various applications, and therefore the functionality requirements for the optical systems have been increasing. However, it is difficult for a conventional optical system to obtain a balance among the requirements such as high image quality, low sensitivity, a proper aperture size, miniaturization and a desirable field of view.

### SUMMARY

According to one aspect of the present disclosure, an imaging optical lens assembly includes seven lens elements. The seven lens elements are, in order from an object side to an image side along an optical path, a first lens element, a second lens element, a third lens element, a fourth lens element, a fifth lens element, a sixth lens element and a seventh lens element. Each of the seven lens elements has an object-side surface facing toward the object side and an image-side surface facing toward the image side.

Preferably, the first lens element has negative refractive power. Preferably, the second lens element has negative refractive power. Preferably, the image-side surface of the second lens element is concave in a paraxial region thereof. Preferably, the fifth lens element has negative refractive power. Preferably, the image-side surface of the fifth lens element is concave in a paraxial region thereof. Preferably, the image-side surface of the sixth lens element is concave in a paraxial region thereof. Preferably, the image-side surface of the seventh lens element is concave in a paraxial region thereof. Preferably, the image-side surface of the seventh lens element has at least one inflection point.

When an axial distance between the object-side surface of the first lens element and the image-side surface of the seventh lens element is TD, a focal length of the imaging optical lens assembly is f, an axial distance between the object-side surface of the first lens element and an image surface is TL, and a central thickness of the third lens element is CT3, the following conditions are preferably satisfied:

$$2. < TD / f < 5.2 ; and$$

$$3. < TL / CT 3 < 8.00 .$$

According to another aspect of the present disclosure, an imaging optical lens assembly includes seven lens elements. The seven lens elements are, in order from an object side to an image side along an optical path, a first lens element, a second lens element, a third lens element, a fourth lens element, a fifth lens element, a sixth lens element and a seventh lens element. Each of the seven lens elements has an object-side surface facing toward the object side and an image-side surface facing toward the image side.

Preferably, the first lens element has negative refractive power. Preferably, the image-side surface of the second lens element is concave in a paraxial region thereof. Preferably, the fifth lens element has negative refractive power. Preferably, the image-side surface of the fifth lens element is concave in a paraxial region thereof. Preferably, the image-side surface of the sixth lens element is concave in a paraxial region thereof. Preferably, the image-side surface of the seventh lens element is concave in a paraxial region thereof. Preferably, the image-side surface of the seventh lens element has at least one inflection point.

When an axial distance between the object-side surface of the first lens element and the image-side surface of the seventh lens element is TD, a focal length of the imaging optical lens assembly is f, a maximum value among axial distances between each of all adjacent lens elements of the imaging optical lens assembly is ATmax, a curvature radius of the object-side surface of the second lens element is R3, and a curvature radius of the image-side surface of the second lens element is R4, the following conditions are preferably satisfied:

$$2. < TD / f < 6. ;$$

$$0.2 < ATmax / f < 0.85 ; and$$

$$0. < ( R 3 + R 4 ) / ( R 3 - R 4 ) < 10. .$$

According to another aspect of the present disclosure, an imaging optical lens assembly includes seven lens elements. The seven lens elements are, in order from an object side to an image side along an optical path, a first lens element, a second lens element, a third lens element, a fourth lens element, a fifth lens element, a sixth lens element and a seventh lens element. Each of the seven lens elements has an object-side surface facing toward the object side and an image-side surface facing toward the image side.

Preferably, the first lens element has negative refractive power. Preferably, the second lens element has negative refractive power. Preferably, the image-side surface of the second lens element is concave in a paraxial region thereof. Preferably, the fifth lens element has negative refractive power. Preferably, the image-side surface of the fifth lens element is concave in a paraxial region thereof. Preferably, the image-side surface of the sixth lens element is concave in a paraxial region thereof. Preferably, the image-side surface of the seventh lens element is concave in a paraxial region thereof. Preferably, the image-side surface of the seventh lens element has at least one inflection point.

When an axial distance between the object-side surface of the first lens element and the image-side surface of the seventh lens element is TD, a focal length of the imaging optical lens assembly is f, a composite focal length of the second lens element, the third lens element, the fourth lens element and the fifth lens element is f2345, a central thickness of the second lens element is CT2, a central thickness of the third lens element is CT3, and an axial distance between the second lens element and the third lens element is T23, the following conditions are preferably satisfied:

$$2. < TD / f < 5.2 ; and$$

$$0.8 < f 2345 / ( CT 2 + T 23 + CT 3 ) < 1.6 .$$

According to another aspect of the present disclosure, an image capturing unit includes one of the aforementioned imaging optical lens assemblies and an image sensor, wherein the image sensor is disposed on the image surface of the imaging optical lens assembly.

According to another aspect of the present disclosure, an electronic device includes the aforementioned image capturing unit.

### BRIEF DESCRIPTION OF THE DRAWINGS

The disclosure can be better understood by reading the following detailed description of the embodiments, with reference made to the accompanying drawings as follows:

FIG. 1 is a schematic view of an image capturing unit according to the 1st embodiment of the present disclosure;

FIG. 2 shows spherical aberration curves, astigmatic field curves and a distortion curve of the image capturing unit according to the 1st embodiment;

FIG. 3 is a schematic view of an image capturing unit according to the 2nd embodiment of the present disclosure;

FIG. 4 shows spherical aberration curves, astigmatic field curves and a distortion curve of the image capturing unit according to the 2nd embodiment;

FIG. 5 is a schematic view of an image capturing unit according to the 3rd embodiment of the present disclosure;

FIG. 6 shows spherical aberration curves, astigmatic field curves and a distortion curve of the image capturing unit according to the 3rd embodiment;

FIG. 7 is a schematic view of an image capturing unit according to the 4th embodiment of the present disclosure;

FIG. 8 shows spherical aberration curves, astigmatic field curves and a distortion curve of the image capturing unit according to the 4th embodiment;

FIG. 9 is a schematic view of an image capturing unit according to the 5th embodiment of the present disclosure;

FIG. 10 shows spherical aberration curves, astigmatic field curves and a distortion curve of the image capturing unit according to the 5th embodiment;

FIG. 11 is a schematic view of an image capturing unit according to the 6th embodiment of the present disclosure;

FIG. 12 shows spherical aberration curves, astigmatic field curves and a distortion curve of the image capturing unit according to the 6th embodiment;

FIG. 13 is a schematic view of an image capturing unit according to the 7th embodiment of the present disclosure;

FIG. 14 shows spherical aberration curves, astigmatic field curves and a distortion curve of the image capturing unit according to the 7th embodiment;

FIG. 15 is a schematic view of an image capturing unit according to the 8th embodiment of the present disclosure;

FIG. 16 shows spherical aberration curves, astigmatic field curves and a distortion curve of the image capturing unit according to the 8th embodiment;

FIG. 17 is a schematic view of an image capturing unit according to the 9th embodiment of the present disclosure;

FIG. 18 shows spherical aberration curves, astigmatic field curves and a distortion curve of the image capturing unit according to the 9th embodiment;

FIG. 19 is a schematic view of an image capturing unit according to the 10th embodiment of the present disclosure;

FIG. 20 shows spherical aberration curves, astigmatic field curves and a distortion curve of the image capturing unit according to the 10th embodiment;

FIG. 21 is a schematic view of an image capturing unit according to the 11th embodiment of the present disclosure;

FIG. 22 shows spherical aberration curves, astigmatic field curves and a distortion curve of the image capturing unit according to the 11th embodiment;

FIG. 23 is a schematic view of an image capturing unit according to the 12th embodiment of the present disclosure;

FIG. 24 shows spherical aberration curves, astigmatic field curves and a distortion curve of the image capturing unit according to the 12th embodiment;

FIG. 25 is a perspective view of an image capturing unit according to the 13th embodiment of the present disclosure;

FIG. 26 is a perspective view of an electronic device according to the 14th embodiment of the present disclosure;

FIG. 27 is another perspective view of the electronic device in FIG. 26;

FIG. 28 is a perspective view of an electronic device according to the 15th embodiment of the present disclosure;

FIG. 29 is another perspective view of the electronic device in FIG. 28;

FIG. 30 is a block diagram of the electronic device in FIG. 28;

FIG. 31 is a perspective view of an electronic device according to the 16th embodiment of the present disclosure;

FIG. 32 is a perspective view of an electronic device according to the 17th embodiment of the present disclosure;

FIG. 33 is a schematic view of an electronic device according to the 18th embodiment of the present disclosure;

FIG. 34 shows a schematic view of inflection points on lens surfaces and critical points on lens surfaces according to the 1st embodiment of the present disclosure;

FIG. 35 shows a schematic view of a configuration of a light-folding element in an imaging optical lens assembly according to one embodiment of the present disclosure;

FIG. 36 shows a schematic view of another configuration of a light-folding element in an imaging optical lens assembly according to one embodiment of the present disclosure; and

FIG. 37 shows a schematic view of a configuration of two light-folding elements in an imaging optical lens assembly according to one embodiment of the present disclosure.

### DETAILED DESCRIPTION

An imaging optical lens assembly includes seven lens elements. The seven lens elements are, in order from an object side to an image side along an optical path, a first lens element, a second lens element, a third lens element, a fourth lens element, a fifth lens element, a sixth lens element and a seventh lens element. Each of the seven lens elements has an object-side surface facing toward the object side and an image-side surface facing toward the image side.

The first lens element can have negative refractive power. Therefore, it is favorable for enlarging the field of view. The image-side surface of the first lens element can be concave in a paraxial region thereof. Therefore, it is favorable for adjusting the travelling direction of light, thereby converging light incident from a wide field of view.

The second lens element can have negative refractive power. Therefore, it is favorable for collaborating with the third lens element, thereby correcting spherical and chromatic aberrations. The image-side surface of the second lens element is concave in a paraxial region thereof. Therefore, it is favorable for adjusting the lens shape of the second lens element, thereby correcting aberrations.

The object-side surface of the third lens element can be convex in a paraxial region thereof. Therefore, it is favorable for adjusting the lens shape of the third lens element, thereby improving convergence capability of the third lens element.

The image-side surface of the fourth lens element can be convex in a paraxial region thereof. Therefore, it is favorable for adjusting the travelling direction of light, thereby correcting spherical aberration.

The fifth lens element can have negative refractive power. Therefore, it is favorable for correcting spherical and chromatic aberrations. The image-side surface of the fifth lens element is concave in a paraxial region thereof. Therefore, it is favorable for adjusting the lens shape of the fifth lens element, thereby enhancing the negative refractive power of the fifth lens element.

The image-side surface of the sixth lens element is concave in a paraxial region thereof. Therefore, it is favorable for correcting field curvature and distortion of the imaging optical lens assembly.

The seventh lens element can have negative refractive power. Therefore, it is favorable for balancing the refractive power configuration at the image end of the imaging optical lens assembly so as to correct aberrations. The image-side surface of the seventh lens element is concave in a paraxial region thereof. Therefore, it is favorable for reducing the back focal length.

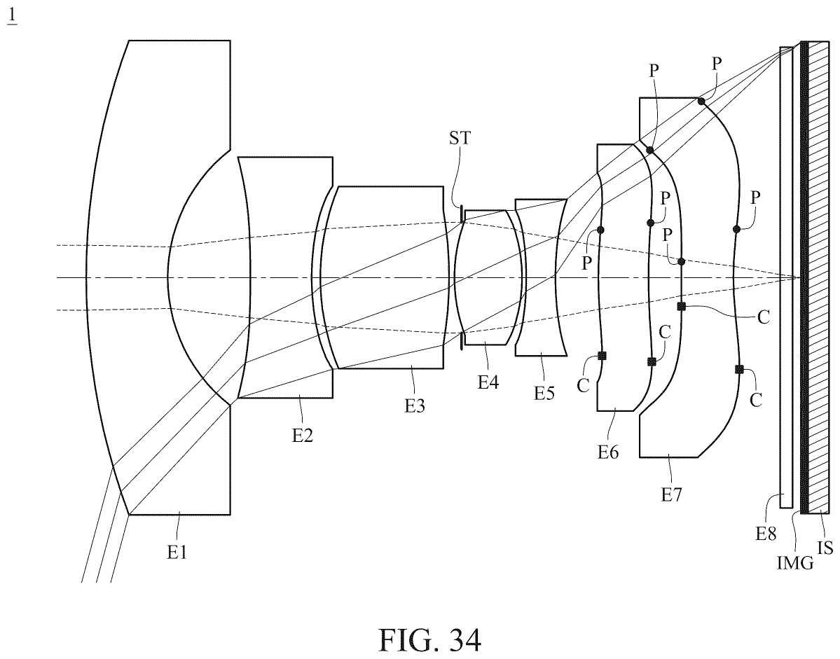

According to the present disclosure, the image-side surface of the seventh lens element has at least one inflection point. Therefore, it is favorable for correcting field curvature of the imaging optical lens assembly while reducing the total track length of the imaging optical lens assembly. Please refer to FIG. 34, which shows a schematic view of inflection points P on the image-side surface of the seventh lens element E7 according to the 1st embodiment of the present disclosure. The abovementioned inflection points P on the image-side surface of the seventh lens element E7, as well as the object-side surface of the sixth lens element E6, the image-side surface of the sixth lens element E6 and the object-side surface of the seventh lens element E7 in FIG. 34 are exemplary. Each of lens surfaces in various embodiments of the present disclosure may also have one or more inflection points.

According to the present disclosure, each of at least two of an Abbe number of the second lens element, an Abbe number of the third lens element and an Abbe number of the sixth lens element can be smaller than 40.0. Therefore, it is favorable for eliminating color distortion of images.

When an axial distance between the object-side surface of the first lens element and the image-side surface of the seventh lens element is TD, and a focal length of the imaging optical lens assembly is f, the following condition is satisfied: 2.00<TD/f<6.00. Therefore, it is favorable for balancing the total track length of the imaging optical lens assembly and controlling the field of view so as to form a characteristic of a wide field of view. Moreover, the following condition can also be satisfied: 2.00<TD/f<5.20. Moreover, the following condition can also be satisfied: 2.60<TD/f<5.00. Moreover, the following condition can also be satisfied: 2.86≤TD/f≤4.95.

When an axial distance between the object-side surface of the first lens element and an image surface is TL, and a central thickness of the third lens element is CT3, the following condition can be satisfied: 3.00<TL/CT3<8.00. Therefore, it is favorable for increasing the convergence capability of the third lens element. Moreover, the following condition can also be satisfied: 4.00<TL/CT3<6.50. Moreover, the following condition can also be satisfied: 4.00<TL/CT3<6.00. Moreover, the following condition can also be satisfied: 4.73≤TL/CT3≤5.73.

When a maximum value among axial distances between each of all adjacent lens elements of the imaging optical lens assembly is ATmax, and the focal length of the imaging optical lens assembly is f, the following condition can be satisfied: 0.20<ATmax/f<0.85. Therefore, it is favorable for balancing the size distribution of the imaging optical lens assembly, thereby increasing the assembly yield rate. Moreover, the following condition can also be satisfied: 0.25<ATmax/f<0.80. Moreover, the following condition can also be satisfied: 0.25<ATmax/f<0.65. Moreover, the following condition can also be satisfied: 0.31≤ATmax/f≤0.61.

When a curvature radius of the object-side surface of the second lens element is R3, and a curvature radius of the image-side surface of the second lens element is R4, the following condition can be satisfied: 0.00<(R3+R4)/(R3−R4)<10.00. Therefore, it is favorable for adjusting the lens shape and the refractive power of the second lens element, thereby harmonizing the incident angle of light from the wide field of view. Moreover, the following condition can also be satisfied: 0.10< (R3+R4)/(R3−R4)<8.00. Moreover, the following condition can also be satisfied: 0.40<(R3+R4)/(R3−R4)<6.00. Moreover, the following condition can also be satisfied: 0.70≤(R3+R4)/(R3−R4)≤4.15.

When a composite focal length of the second lens element, the third lens element, the fourth lens element and the fifth lens element is f2345, a central thickness of the second lens element is CT2, the central thickness of the third lens element is CT3, and an axial distance between the second lens element and the third lens element is T23, the following condition can be satisfied: 0.80<f2345/(CT2+T23+CT3)<1.60. Therefore, it is favorable for enhancing the correction ability for improving image quality. Moreover, the following condition can also be satisfied: 0.80<f2345/(CT2+T23+CT3)<1.40. Moreover, the following condition can also be satisfied: 0.89≤f2345/(CT2+T23+CT3)≤1.10.

When a curvature radius of the object-side surface of the fourth lens element is R7, and a focal length of the third lens element is f3, the following condition can be satisfied: 0.30<R7/f3<1.10. Therefore, it is favorable for preventing overly large refractive power of each of the third lens element and the fourth lens element, thereby correcting spherical aberration. Moreover, the following condition can also be satisfied: 0.50<R7/f3≤1.00.

When an axial distance between the first lens element and the second lens element is T12, and an axial distance between the fifth lens element and the sixth lens element is T56, the following condition can be satisfied: 0.25<T12/T56<4.00. Therefore, it is favorable for balancing the space configuration of the imaging optical lens assembly, such that the imaging optical lens assembly features the wide field of view. Moreover, the following condition can also be satisfied: 0.50<T12/T56<2.50.

When a maximum field of view of the imaging optical lens assembly is FOV, the following condition can be satisfied: 110.0 degrees<FOV<190.0 degrees. Therefore, it is favorable for having the wide field of view of the imaging optical lens assembly and enlarging the capturing range of the imaging optical lens assembly. Moreover, the following condition can also be satisfied: 120.0 degrees<FOV<180.0 degrees. Moreover, the following condition can also be satisfied: 130.0 degrees<FOV<170.0 degrees.

When the axial distance between the object-side surface of the first lens element and the image surface is TL, and the curvature radius of the image-side surface of the second lens element is R4, the following condition can be satisfied: 0.10<TL/R4<12.00. Therefore, it is favorable for controlling the ratio of the total track length of the imaging optical lens assembly to the curvature radius of the image-side surface of the second lens element, thereby reducing manufacturing difficulty. Moreover, the following condition can also be satisfied: 0.40<TL/R4<10.00.

When an axial distance between the image-side surface of the seventh lens element and the image surface is BL, and the focal length of the imaging optical lens assembly is f, the following condition can be satisfied: 0.00<BL/f<0.90. Therefore, it is favorable for reducing the back focal length so as to reduce the total track length of the imaging optical lens assembly. Moreover, the following condition can also be satisfied: 0.20<BL/f<0.70.

According to the present disclosure, the imaging optical lens assembly can further include an aperture stop. When an axial distance between the aperture stop and the image surface is SL, and the axial distance between the object-side surface of the first lens element and the image surface is TL, the following condition can be satisfied: 0.35<SL/TL<0.65. Therefore, it is favorable for effectively controlling the position of the aperture stop, thereby enlarging the field of view. Moreover, the following condition can also be satisfied: 0.40<SL/TL<0.60.

When the axial distance between the object-side surface of the first lens element and the image surface is TL, and the central thickness of the second lens element is CT2, the following condition can be satisfied: 11.00<TL/CT2<20.00. Therefore, it is favorable for preventing excessive thinness of the second lens element so as to facilitate the molding of the lens element.

When the axial distance between the aperture stop and the image surface is SL, and a maximum image height of the imaging optical lens assembly (which can be half of a diagonal length of an effective photosensitive area of the image sensor) is ImgH, the following condition can be satisfied: 1.20<SL/ImgH<1.70. Therefore, it is favorable for enlarging the image surface.

When the axial distance between the object-side surface of the first lens element and the image surface is TL, and the maximum image height of the imaging optical lens assembly is ImgH, the following condition can be satisfied: 2.00<TL/ImgH<4.00. Therefore, it is favorable for obtaining a proper balance between reduction in the total track length of the imaging optical lens assembly and enlargement of the image surface. Moreover, the following condition can also be satisfied: 2.20<TL/ImgH<3.60.

When an axial distance between the third lens element and the fourth lens element is T34, the central thickness of the third lens element is CT3, and a central thickness of the fourth lens element is CT4, the following condition can be satisfied: 0.25<(T34+CT4)/CT3<0.90. Therefore, it is favorable for balancing the refractive power distribution at the middle portion of the imaging optical lens assembly, thereby improving image quality. Moreover, the following condition can also be satisfied: 0.40<(T34+CT4)/CT3<0.85.

When the axial distance between the fifth lens element and the sixth lens element is T56, and a central thickness of the fifth lens element is CT5, the following condition can be satisfied: 0.10<T56/CT5<5.00. Therefore, it is favorable for adjusting the space configuration of lens elements at the image end of the imaging optical lens assembly, thereby reducing manufacturing tolerance. Moreover, the following condition can also be satisfied: 0.60<T56/CT5<3.00.

When an Abbe number of the fifth lens element is V5, the following condition can be satisfied: 5.00<V5<40.0. Therefore, a proper material selection of the fifth lens element is favorable for correcting chromatic aberration.

When an Abbe number of the seventh lens element is V7, the following condition can be satisfied: 5.00<V7<40.0. Therefore, it is favorable for balancing convergence capabilities in converging light with different wavelengths so as to correct chromatic aberration.

When the focal length of the imaging optical lens assembly is f, and a composite focal length of the fifth lens element and the sixth lens element is f56, the following condition can be satisfied: −2.50<f/f56<0.00. Therefore, it is favorable for balancing the refractive power at the image end of the imaging optical lens assembly. Moreover, the following condition can also be satisfied: −1.50<f/f56<−0.10.

When a composite focal length of the second lens element and the third lens element is f23, and a composite focal length of the fourth lens element and the fifth lens element is f45, the following condition can be satisfied: 0.00<f45/f23<2.00. Therefore, it is favorable for balancing the refractive power distributions of lens elements at the front and rear sides of the aperture stop, thereby correcting chromatic aberration. Moreover, the following condition can also be satisfied: 0.00<f45/f23<1.50.

When the axial distance between the object-side surface of the first lens element and the image surface is TL, the axial distance between the aperture stop and the image surface is SL, and a composite focal length of the first lens element, the second lens element and the third lens element is f123, the following condition can be satisfied: −2.00<(TL−SL)/f123<2.00. Therefore, it is favorable for adjusting the size and refractive power at the object end of the imaging optical lens assembly, thereby enlarging the field of view. Moreover, the following condition can also be satisfied: −1.50<(TL−SL)/f123<1.50. Moreover, the following condition can also be satisfied: −1.20<(TL−SL)/f123<0.70.

When the axial distance between the aperture stop and the image surface is SL, and a composite focal length of the fourth lens element, the fifth lens element, the sixth lens element and the seventh lens element is f4567, the following condition can be satisfied: 0.00<SL/f4567<2.20. Therefore, it is favorable for adjusting the size and refractive power distribution at the image end of the imaging optical lens assembly. Moreover, the following condition can also be satisfied: 0.50<SL/f4567<2.00.

When a composite focal length of the first lens element and the second lens element is f12, and the composite focal length of the fifth lens element and the sixth lens element is f56, the following condition can be satisfied: 0.20<f12/f56<1.30. Therefore, it is favorable for enhancing the ability in receiving light from the wide field of view and obtaining a proper balance in correcting aberrations. Moreover, the following condition can also be satisfied: 0.30<f12/f56<1.20.

When an entrance pupil diameter of the imaging optical lens assembly is EPD, the axial distance between the aperture stop and the image surface is SL, the maximum image height of the imaging optical lens assembly is ImgH, and the central thickness of the fourth lens element is CT4, the following condition can be satisfied: 0.50<(EPD×SL)/(ImgH×CT4)<2.50. Therefore, it is favorable for increasing illuminance and reducing sensitivity of lens elements located between the aperture stop and the image end of the imaging optical lens assembly, while enlarging the aperture. Moreover, the following condition can also be satisfied: 0.70<(EPD×SL)/(ImgH×CT4)<2.20.

When the central thickness of the second lens element is CT2, the central thickness of the third lens element is CT3, the central thickness of the fourth lens element is CT4, the central thickness of the fifth lens element is CT5, the axial distance between the second lens element and the third lens element is T23, and an axial distance between the fourth lens element and the fifth lens element is T45, the following condition can be satisfied: 1.40<(CT2+T23+CT3)/(CT4+T45+CT5)<2.60. Therefore, it is favorable for adjusting the space configuration at the middle portion of the imaging optical lens assembly, thereby correcting aberrations.

When the focal length of the imaging optical lens assembly is f, and the curvature radius of the object-side surface of the second lens element is R3, the following condition can be satisfied: −0.5<f/R3<0.5. Therefore, it is favorable for enlarging the field of view, controlling the sensitivity of the second lens element and reducing flare and ghost image.

When the composite focal length of the fourth lens element and the fifth lens element is f45, the central thickness of the fourth lens element is CT4, the central thickness of the fifth lens element is CT5, and the axial distance between the fourth lens element and the fifth lens element is T45, the following condition can be satisfied: 2.00<f45/(CT4+T45+CT5)<7.00. Therefore, it is favorable for adjusting the refractive power distribution at the middle portion of the imaging optical lens assembly and reducing assembly difficulty. Moreover, the following condition can also be satisfied: 2.00<f45/(CT4+T45+CT5)<5.50.

According to the present disclosure, the aforementioned features and conditions can be utilized in numerous combinations so as to achieve corresponding effects.

According to the present disclosure, the lens elements of the imaging optical lens assembly can be made of either glass or plastic material. When the lens elements are made of glass material, the refractive power distribution of the imaging optical lens assembly may be more flexible, and the influence on imaging caused by external environment temperature change may be reduced. The glass lens element can either be made by grinding or molding. When the lens elements are made of plastic material, the manufacturing costs can be effectively reduced. Furthermore, surfaces of each lens element can be arranged to be spherical or aspheric. Spherical lens elements are simple in manufacture. Aspheric lens element design allows more control variables for eliminating aberrations thereof and reducing the required number of lens elements, and the total track length of the imaging optical lens assembly can therefore be effectively shortened. Additionally, the aspheric surfaces may be formed by plastic injection molding or glass molding.

According to the present disclosure, when a lens surface is aspheric, it means that the lens surface has an aspheric shape throughout its optically effective area, or a portion(s) thereof.

According to the present disclosure, one or more of the lens elements' material may optionally include an additive which generates light absorption and interference effects and alters the lens elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material lens element by injection molding. Moreover, the additive may be coated on the lens surfaces to provide the abovementioned effects.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, unless otherwise stated, when the lens element has a convex surface, it indicates that the surface is convex in the paraxial region thereof; when the lens element has a concave surface, it indicates that the surface is concave in the paraxial region thereof. Moreover, when a region of refractive power or focus of a lens element is not defined, it indicates that the region of refractive power or focus of the lens element is in the paraxial region thereof.

According to the present disclosure, an inflection point is a point on the surface of the lens element at which the surface changes from concave to convex, or vice versa. A critical point is a non-axial point of the lens surface where its tangent is perpendicular to the optical axis. Please refer to FIG. 34, which shows a schematic view of critical points C in off-axis regions of the object-side surface of the sixth lens element E6, the image-side surface of the sixth lens element E6, the object-side surface of the seventh lens element E7 and the image-side surface of the seventh lens element E7 according to the 1st embodiment of the present disclosure. The abovementioned critical points C in off-axis regions of the object-side surface of the sixth lens element E6, the image-side surface of the sixth lens element E6, the object-side surface of the seventh lens element E7 and the image-side surface of the seventh lens element E7 in FIG. 34 are exemplary. Each of lens surfaces in various embodiments of the present disclosure may also have one or more critical points in an off-axis region thereof.

According to the present disclosure, the image surface of the imaging optical lens assembly, based on the corresponding image sensor, can be flat or curved, especially a curved surface being concave facing towards the object side of the imaging optical lens assembly.

According to the present disclosure, an image correction unit, such as a field flattener, can be optionally disposed between the lens element closest to the image side of the imaging optical lens assembly along the optical path and the image surface for correction of aberrations such as field curvature. The optical properties of the image correction unit, such as curvature, thickness, index of refraction, position and surface shape (convex or concave surface with spherical, aspheric, diffractive or Fresnel types), can be adjusted according to the design of the image capturing unit. In general, a preferable image correction unit is, for example, a thin transparent element having a concave object-side surface and a planar image-side surface, and the thin transparent element is disposed near the image surface.

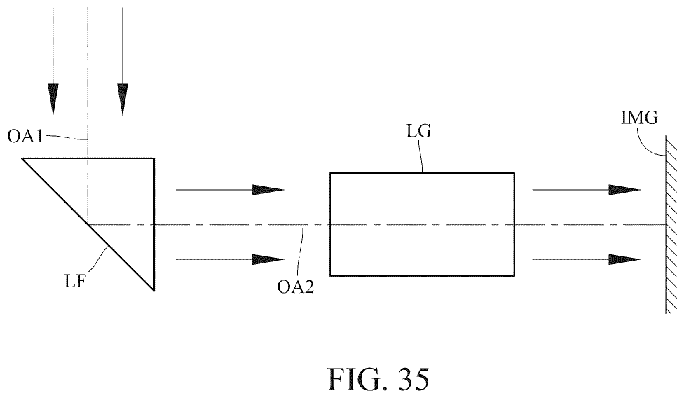

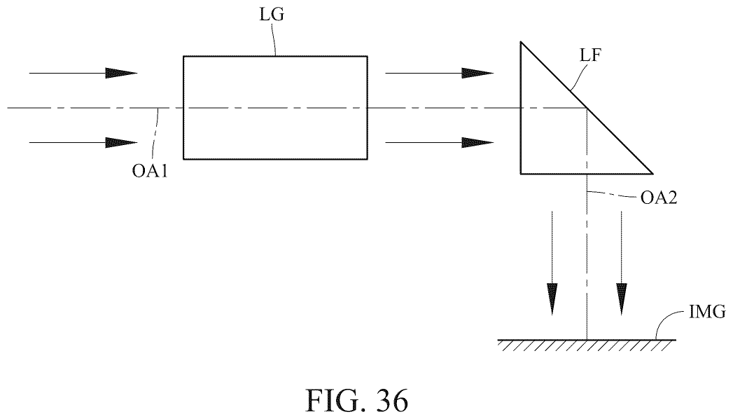

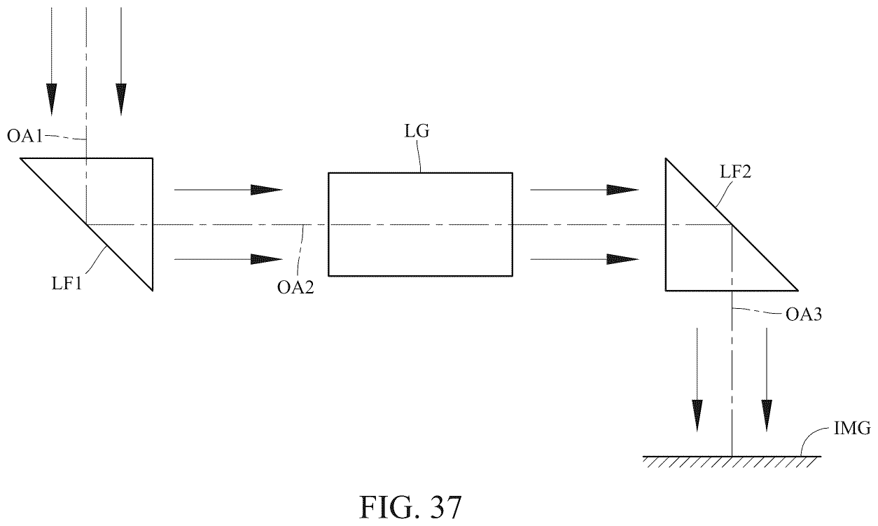

According to the present disclosure, at least one light-folding element, such as a prism or a mirror which can have a surface being planar, spherical, aspheric or in free-form, can be optionally disposed between an imaged object and the image surface on the imaging optical path, such that the imaging optical lens assembly can be more flexible in space arrangement, and therefore the dimensions of an electronic device is not restricted by the total track length of the imaging optical lens assembly. Specifically, please refer to FIG. 35 and FIG. 36. FIG. 35 shows a schematic view of a configuration of a light-folding element in an imaging optical lens assembly according to one embodiment of the present disclosure, and FIG. 36 shows a schematic view of another configuration of a light-folding element in an imaging optical lens assembly according to one embodiment of the present disclosure. In FIG. 35 and FIG. 36, the imaging optical lens assembly can have, in order from an imaged object (not shown in the figures) to an image surface IMG along an optical path, a first optical axis OA1, a light-folding element LF and a second optical axis OA2. The light-folding element LF can be disposed between the imaged object and a lens group LG of the imaging optical lens assembly as shown in FIG. 35 or disposed between a lens group LG of the imaging optical lens assembly and the image surface IMG as shown in FIG. 36. Furthermore, please refer to FIG. 37, which shows a schematic view of a configuration of two light-folding elements in an imaging optical lens assembly according to one embodiment of the present disclosure. In FIG. 37, the imaging optical lens assembly can have, in order from an imaged object (not shown in the figure) to an image surface IMG along an optical path, a first optical axis OA1, a first light-folding element LF1, a second optical axis OA2, a second light-folding element LF2 and a third optical axis OA3. The first light-folding element LF1 is disposed between the imaged object and a lens group LG of the imaging optical lens assembly, the second light-folding element LF2 is disposed between the lens group LG of the imaging optical lens assembly and the image surface IMG, and the travelling direction of light on the first optical axis OA1 can be the same direction as the travelling direction of light on the third optical axis OA3 as shown in FIG. 37. The imaging optical lens assembly can be optionally provided with three or more light-folding elements, and the present disclosure is not limited to the type, amount and position of the light-folding elements of the embodiments disclosed in the aforementioned figures.

According to the present disclosure, the imaging optical lens assembly can include at least one stop, such as an aperture stop, a glare stop or a field stop. Said glare stop or said field stop is set for eliminating the stray light and thereby improving image quality thereof.

According to the present disclosure, an aperture stop can be configured as a front stop or a middle stop. A front stop disposed between an imaged object and the first lens element can provide a longer distance between an exit pupil of the imaging optical lens assembly and the image surface to produce a telecentric effect, and thereby improves the image-sensing efficiency of an image sensor (for example, CCD or CMOS). A middle stop disposed between the first lens element and the image surface is favorable for enlarging the viewing angle of the imaging optical lens assembly and thereby provides a wider field of view for the same.

According to the present disclosure, the imaging optical lens assembly can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material or a liquid-crystal layer. The aperture control unit controls the amount of incident light or exposure time to enhance the capability of image quality adjustment. In addition, the aperture control unit can be the aperture stop of the present disclosure, which changes the f-number to obtain different image effects, such as the depth of field or lens speed.

According to the present disclosure, the imaging optical lens assembly can include one or more optical elements for limiting the form of light passing through the imaging optical lens assembly. Each optical element can be, but not limited to, a filter, a polarizer, etc., and each optical element can be, but not limited to, a single-piece element, a composite component, a thin film, etc. The optical element can be located at the object side or the image side of the imaging optical lens assembly or between any two adjacent lens elements so as to allow light in a specific form to pass through, thereby meeting application requirements.

According to the present disclosure, the imaging optical lens assembly can include at least one optical lens element, an optical element, or a carrier, which has at least one surface with a low reflection layer. The low reflection layer can effectively reduce stray light generated due to light reflection at the interface. The low reflection layer can be disposed in an optical non-effective area of an object-side surface or an image-side surface of the said optical lens element, or a connection surface between the object-side surface and the image-side surface. The said optical element can be a light-blocking element, an annular spacer, a barrel element, a cover glass, a blue glass, a filter, a color filter, an optical path folding element, a prism, a mirror, etc. The said carrier can be a base for supporting a lens assembly, a micro lens disposed on an image sensor, a substrate surrounding the image sensor, a glass plate for protecting the image sensor, etc.

According to the present disclosure, the object side and the image side are defined in accordance with the direction of the optical axis, and the axial optical data are calculated along the optical axis. Furthermore, if the optical axis is folded by a light-folding element, the axial optical data are also calculated along the folded optical axis.

According to the above description of the present disclosure, the following specific embodiments are provided for further explanation.

### 1st Embodiment

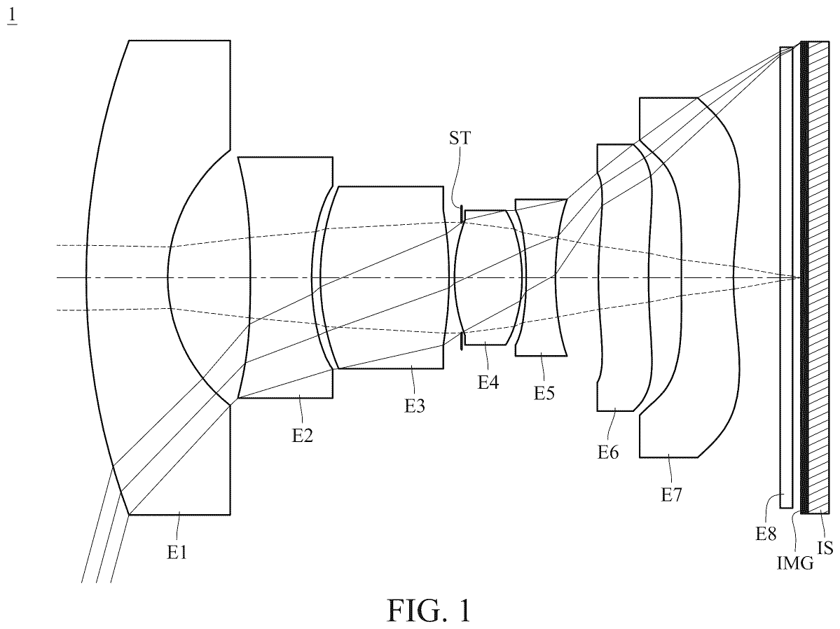

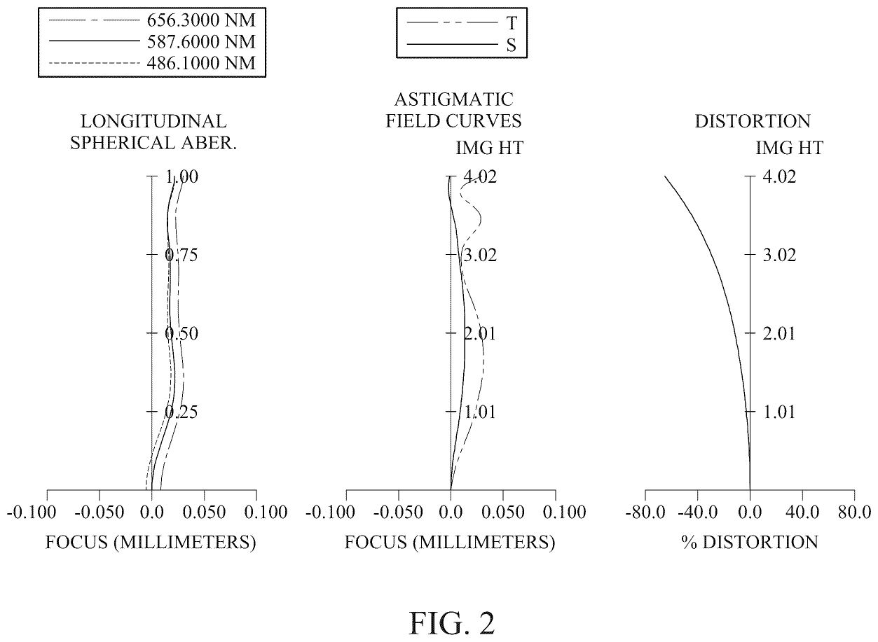

FIG. 1 is a schematic view of an image capturing unit according to the 1st embodiment of the present disclosure. FIG. 2 shows, in order from left to right, spherical aberration curves, astigmatic field curves and a distortion curve of the image capturing unit according to the 1st embodiment. In FIG. 1, the image capturing unit 1 includes the imaging optical lens assembly (its reference numeral is omitted) of the present disclosure and an image sensor IS. The imaging optical lens assembly includes, in order from an object side to an image side along an optical axis, a first lens element E1, a second lens element E2, a third lens element E3, an aperture stop ST, a fourth lens element E4, a fifth lens element E5, a sixth lens element E6, a seventh lens element E7, a filter E8 and an image surface IMG. The imaging optical lens assembly includes seven lens elements (E1, E2, E3, E4, E5, E6 and E7) with no additional lens element disposed between each of the adjacent seven lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being concave in a paraxial region thereof and an image-side surface being concave in a paraxial region thereof. The second lens element E2 is made of plastic material and has the object-side surface and the image-side surface being both aspheric.

The third lens element E3 with positive refractive power has an object-side surface being convex in a paraxial region thereof and an image-side surface being convex in a paraxial region thereof. The third lens element E3 is made of glass material and has the object-side surface and the image-side surface being both spherical.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The seventh lens element E7 with negative refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has two inflection points. The object-side surface of the seventh lens element E7 has one critical point in an off-axis region thereof. The image-side surface of the seventh lens element E7 has one critical point in an off-axis region thereof.

The filter E8 is made of glass material and located between the seventh lens element E7 and the image surface IMG, and will not affect the focal length of the imaging optical lens assembly. The image sensor IS is disposed on or near the image surface IMG of the imaging optical lens assembly.

In this embodiment, each of an Abbe number of the second lens element E2 and an Abbe number of the third lens element E3 is smaller than 40.0.

The equation of the aspheric surface profiles of the aforementioned lens elements of the 1st embodiment is expressed as follows:

$$X ( Y ) = ( {Y}^{2} / R ) / ( 1 + s q r t ( 1 - ( 1 + k ) \times {( Y / R )}^{2} ) ) + {\sum }_{i} ( Ai ) \times ( {Y}^{i} ) ,$$

where,
X is the displacement in parallel with an optical axis from an axial vertex on the aspheric surface to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient, and in the embodiments, i may be, but is not limited to, 4, 6, 8, 10, 12, 14, 16, 18, 20, 22, 24, 26, 28 and 30.

In the imaging optical lens assembly of the image capturing unit 1 according to the 1st embodiment, when a focal length of the imaging optical lens assembly is f, an f-number of the imaging optical lens assembly is Fno, and half of a maximum field of view of the imaging optical lens assembly is HFOV, these parameters have the following values: f=3.11 millimeters (mm), Fno=2.80, and HFOV=74.9 degrees (deg.).

When the maximum field of view of the imaging optical lens assembly is FOV, the following condition is satisfied: FOV=149.9 degrees.

When an axial distance between the object-side surface of the first lens element E1 and the image surface IMG is TL, and a maximum image height of the imaging optical lens assembly is ImgH, the following condition is satisfied: TL/ImgH=3.04.

When an axial distance between the aperture stop ST and the image surface IMG is SL, and the maximum image height of the imaging optical lens assembly is ImgH, the following condition is satisfied: SL/ImgH=1.44.

When the axial distance between the aperture stop ST and the image surface

IMG is SL, and the axial distance between the object-side surface of the first lens element E1 and the image surface IMG is TL, the following condition is satisfied: SL/TL=0.47.

When an axial distance between the object-side surface of the first lens element E1 and the image-side surface of the seventh lens element E7 is TD, and the focal length of the imaging optical lens assembly is f, the following condition is satisfied: TD/f=3.56.

When an axial distance between the image-side surface of the seventh lens element E7 and the image surface IMG is BL, and the focal length of the imaging optical lens assembly is f, the following condition is satisfied: BL/f=0.37.

When the axial distance between the object-side surface of the first lens element E1 and the image surface IMG is TL, and a central thickness of the second lens element E2 is CT2, the following condition is satisfied: TL/CT2=11.66.

When the axial distance between the object-side surface of the first lens element E1 and the image surface IMG is TL, and a central thickness of the third lens element E3 is CT3, the following condition is satisfied: TL/CT3=5.55.

When the axial distance between the object-side surface of the first lens element E1 and the image surface IMG is TL, and a curvature radius of the image-side surface of the second lens element E2 is R4, the following condition is satisfied: TL/R4=2.78.

When a maximum value among axial distances between each of all adjacent lens elements of the imaging optical lens assembly is ATmax, and the focal length of the imaging optical lens assembly is f, the following condition is satisfied: ATmax/f=0.45. In this embodiment, an axial distance between two adjacent lens elements is a distance in a paraxial region between two adjacent lens surfaces of the two adjacent lens elements. In this embodiment, an axial distance between the first lens element E1 and the second lens element E2 is larger than each of the axial distances between all the other two adjacent lens elements of the imaging optical lens assembly, and ATmax is equal to the axial distance between the first lens element E1 and the second lens element E2.

When an entrance pupil diameter of the imaging optical lens assembly is EPD, the axial distance between the aperture stop ST and the image surface IMG is SL, the maximum image height of the imaging optical lens assembly is ImgH, and a central thickness of the fourth lens element E4 is CT4, the following condition is satisfied: (EPD×SL)/(ImgH×CT4)=1.39.

When the focal length of the imaging optical lens assembly is f, and a composite focal length of the fifth lens element E5 and the sixth lens element E6 is f56, the following condition is satisfied: f/f56=−0.69.

When the focal length of the imaging optical lens assembly is f, and a curvature radius of the object-side surface of the second lens element E2 is R3, the following condition is satisfied: f/R3=−0.12.

When a composite focal length of the first lens element E1 and the second lens element E2 is f12, and the composite focal length of the fifth lens element E5 and the sixth lens element E6 is f56, the following condition is satisfied: f12/f56=0.50.

When a composite focal length of the second lens element E2 and the third lens element E3 is f23, and a composite focal length of the fourth lens element E4 and the fifth lens element E5 is f45, the following condition is satisfied: f45/f23=0.88.

When the composite focal length of the fourth lens element E4 and the fifth lens element E5 is f45, the central thickness of the fourth lens element E4 is CT4, a central thickness of the fifth lens element E5 is CT5, and an axial distance between the fourth lens element E4 and the fifth lens element E5 is T45, the following condition is satisfied: f45/(CT4+T45+CT5)=3.41.

When a composite focal length of the second lens element E2, the third lens element E3, the fourth lens element E4 and the fifth lens element E5 is f2345, the central thickness of the second lens element E2 is CT2, the central thickness of the third lens element E3 is CT3, and an axial distance between the second lens element E2 and the third lens element E3 is T23, the following condition is satisfied: f2345/(CT2+T23+CT3)=0.89.

When the curvature radius of the object-side surface of the second lens element E2 is R3, and the curvature radius of the image-side surface of the second lens element E2 is R4, the following condition is satisfied: (R3+R4)/(R3−R4)=0.70.

When a curvature radius of the object-side surface of the fourth lens element E4 is R7, and a focal length of the third lens element E3 is f3, the following condition is satisfied: R7/f3=0.81.

When the axial distance between the aperture stop ST and the image surface IMG is SL, and a composite focal length of the fourth lens element E4, the fifth lens element E5, the sixth lens element E6 and the seventh lens element E7 is f4567, the following condition is satisfied: SL/f4567=0.94.

When the axial distance between the first lens element E1 and the second lens element E2 is T12, and an axial distance between the fifth lens element E5 and the sixth lens element E6 is T56, the following condition is satisfied: T12/T56=1.92. When the axial distance between the fifth lens element E5 and the sixth lens element E6 is T56, and the central thickness of the fifth lens element E5 is CT5, the following condition is satisfied: T56/CT5=1.47.

When an axial distance between the third lens element E3 and the fourth lens element E4 is T34, the central thickness of the third lens element E3 is CT3, and the central thickness of the fourth lens element E4 is CT4, the following condition is satisfied: (T34+CT4)/CT3=0.57.

When the axial distance between the object-side surface of the first lens element E1 and the image surface IMG is TL, the axial distance between the aperture stop ST and the image surface IMG is SL, and a composite focal length of the first lens element E1, the second lens element E2 and the third lens element E3 is f123, the following condition is satisfied: (TL−SL)/f123=0.25.

When the central thickness of the second lens element E2 is CT2, the central thickness of the third lens element E3 is CT3, the central thickness of the fourth lens element E4 is CT4, the central thickness of the fifth lens element E5 is CT5, the axial distance between the second lens element E2 and the third lens element E3 is T23, and the axial distance between the fourth lens element E4 and the fifth lens element E5 is T45, the following condition is satisfied: (CT2+T23+CT3)/(CT4+T45+CT5)=1.97.

When an Abbe number of the fifth lens element E5 is V5, the following condition is satisfied: V5=19.5.

When an Abbe number of the seventh lens element E7 is V7, the following condition is satisfied: V7=25.6.

The detailed optical data of the 1st embodiment are shown in Table 1A and the aspheric surface data are shown in Table 1B below.

TABLE 1A
1st Embodiment
f = 3.11 mm, Fno = 2.80, HFOV = 74.9 deg.

| Surface # | | Curvature Radius | | Thickness | Material | Index | Abbe # | Focal Length |
|---|---|---|---|---|---|---|---|---|
| 0 | Object | Infinity | | 1000.000 | | | | |
| 1 | Lens 1 | 11.6289 | (SPH) | 1.394 | Glass | 1.804 | 46.6 | −4.87 |
| 2 | | 2.7709 | (SPH) | 1.414 | | | | |
| 3 | Lens 2 | −24.9354 | (ASP) | 1.049 | Plastic | 1.650 | 21.8 | −5.67 |
| 4 | | 4.3925 | (ASP) | 0.148 | | | | |
| 5 | Lens 3 | 4.0461 | (SPH) | 2.202 | Glass | 1.805 | 25.5 | 3.48 |
| 6 | | −6.8806 | (SPH) | 0.213 | | | | |
| 7 | Ape. Stop | Plano | | −0.120 | | | | |
| 8 | Lens 4 | 2.8243 | (ASP) | 1.155 | Plastic | 1.544 | 56.0 | 2.75 |
| 9 | | −2.7203 | (ASP) | 0.072 | | | | |
| 10 | Lens 5 | −5.6237 | (ASP) | 0.500 | Plastic | 1.669 | 19.5 | −3.99 |
| 11 | | 5.2633 | (ASP) | 0.735 | | | | |
| 12 | Lens 6 | 7.8432 | (ASP) | 0.858 | Plastic | 1.544 | 56.0 | 35.92 |
| 13 | | 12.5960 | (ASP) | 0.561 | | | | |
| 14 | Lens 7 | 37.1470 | (ASP) | 0.891 | Plastic | 1.614 | 25.6 | −9.54 |
| 15 | | 5.0100 | (ASP) | 0.800 | | | | |

| | | | | | | | |
|---|---|---|---|---|---|---|---|
| 16 | Filter | Plano | 0.210 | Glass | 1.517 | 64.2 | — |
| 17 | | Plano | 0.146 | | | | |
| 18 | Image | Plano | — | | | | |

Note:
Reference wavelength is 587.6 nm (d-line).

TABLE 1B
Aspheric Coefficients

| Surface # | 3 | 4 | 8 | 9 |
|---|---|---|---|---|
| k= | −9.89859E+01 | −6.09571E+00 | −1.01890E+00 | −2.20775E−01 |
| A4= | −1.464165776E−02 | 7.974908758E−03 | 6.391631302E−03 | 5.229311221E−03 |
| A6= | 6.023508487E−03 | 1.408038575E−02 | 1.634900551E−02 | −1.149235187E−01 |
| A8= | −6.896481716E−03 | −3.255796380E−02 | −4.677425112E−02 | 7.684239389E−01 |
| A10= | 5.918563037E−03 | 5.344519382E−02 | 6.678888416E−02 | −2.658749585E+00 |
| A12= | −3.173939168E−03 | −5.342648163E−02 | −5.047763190E−02 | 5.537163247E+00 |
| A14= | 1.068724279E−03 | 3.308685672E−02 | 1.383459940E−02 | −7.428653837E+00 |
| A16= | −2.189005807E−04 | −1.231388174E−02 | — | 6.439512348E+00 |
| A18= | 2.487490232E−05 | 2.518889962E−03 | — | −3.484882331E+00 |
| A20= | −1.200855011E−06 | −2.169153278E−04 | — | 1.071473398E+00 |
| A22= | — | — | — | −1.430967747E−01 |

| Surface # | 10 | 11 | 12 | 13 |
|---|---|---|---|---|
| k= | −9.44509E+01 | −8.43895E+01 | −2.00927E+01 | −2.33636E+01 |
| A4= | −1.024453314E−01 | 6.393208227E−02 | −5.723039520E−03 | 5.050226398E−03 |
| A6= | 1.545115262E−01 | −7.123360645E−02 | −1.224627648E−03 | −1.517873586E−03 |
| A8= | −2.453558793E−01 | 1.084852891E−01 | −8.715790605E−03 | −9.415961803E−03 |
| A10= | 2.746717017E−01 | −1.244400527E−01 | 8.117326071E−03 | 9.220600546E−03 |
| A12= | −2.269353559E−01 | 9.649416215E−02 | 1.881305674E−03 | −4.407191831E−03 |
| A14= | 1.097970427E−01 | −4.808765372E−02 | −7.975500582E−03 | 1.180262936E−03 |
| A16= | −2.233048954E−02 | 1.395483425E−02 | 5.877731915E−03 | −1.796486198E−04 |
| A18= | — | −1.782775167E−03 | −2.085866123E−03 | 1.440629952E−05 |
| A20= | — | — | 3.731125946E−04 | −4.670251785E−07 |
| A22= | — | — | −2.708325997E−05 | — |

| Surface # | 14 | 15 |
|---|---|---|
| k= | −8.75370E+01 | −7.34329E+00 |
| A4= | −3.244322432E−02 | −3.362925140E−02 |
| A6= | 1.606815536E−02 | 1.530230058E−02 |
| A8= | −5.438888787E−03 | −6.325591404E−03 |
| A10= | −1.715615223E−02 | −1.951615483E−04 |
| A12= | 3.120771364E−02 | 2.008645374E−03 |
| A14= | −2.721168168E−02 | −1.292541586E−03 |
| A16= | 1.489052633E−02 | 4.598746251E−04 |
| A18= | −5.500171744E−03 | −1.064935288E−04 |
| A20= | 1.406585315E−03 | 1.683764894E−05 |
| A22= | −2.497886662E−04 | −1.835674393E−06 |
| A24= | 3.028903942E−05 | 1.358635216E−07 |
| A26= | −2.396664147E−06 | −6.519008871E−09 |
| A28= | 1.117009592E−07 | 1.828370817E−10 |
| A30= | −2.328132431E−09 | −2.273917175E−12 |

In Table 1A, the curvature radius, the thickness and the focal length are shown in millimeters (mm). Surface numbers 0-18 represent the surfaces sequentially arranged from the object side to the image side along the optical axis. In Table 1B, k represents the conic coefficient of the equation of the aspheric surface profiles. A4-A30 represent the aspheric coefficients ranging from the 4th order to the 30th order. The tables presented below for each embodiment are the corresponding schematic parameter and aberration curves, and the definitions of the tables are the same as Table 1A and Table 1B of the 1st embodiment. Therefore, an explanation in this regard will not be provided again.

### 2nd Embodiment

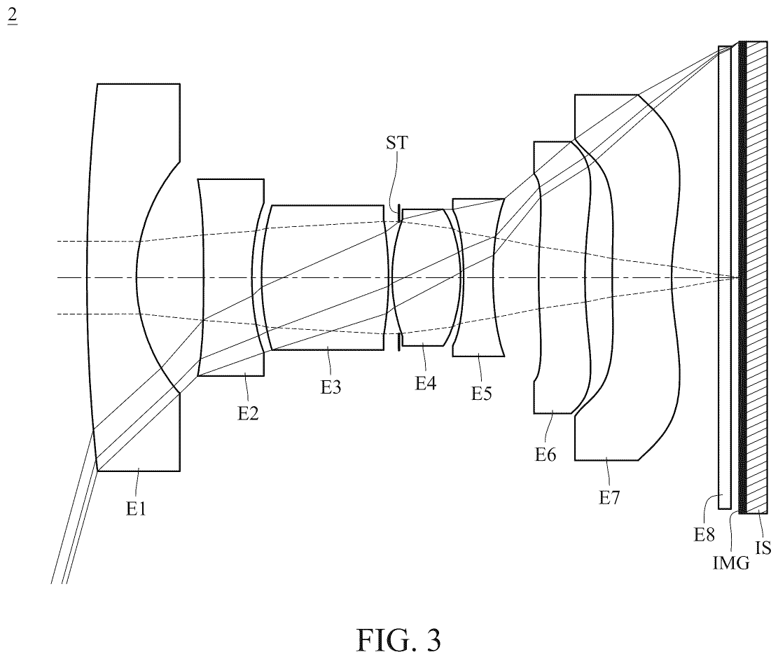

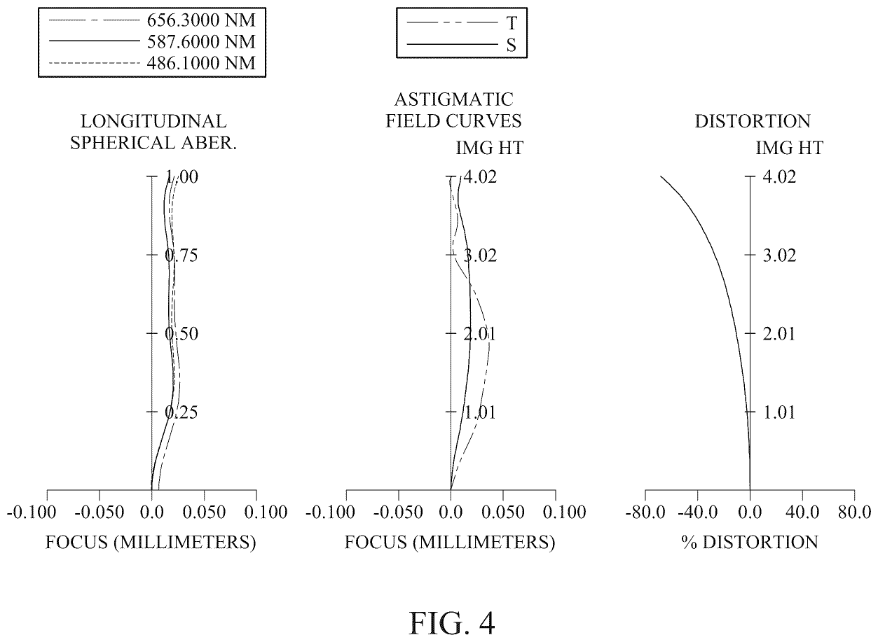

FIG. 3 is a schematic view of an image capturing unit according to the 2nd embodiment of the present disclosure. FIG. 4 shows, in order from left to right, spherical aberration curves, astigmatic field curves and a distortion curve of the image capturing unit according to the 2nd embodiment. In FIG. 3, the image capturing unit 2 includes the imaging optical lens assembly (its reference numeral is omitted) of the present disclosure and an image sensor IS. The imaging optical lens assembly includes, in order from an object side to an image side along an optical axis, a first lens element E1, a second lens element E2, a third lens element E3, an aperture stop ST, a fourth lens element E4, a fifth lens element E5, a sixth lens element E6, a seventh lens element E7, a filter E8 and an image surface IMG. The imaging optical lens assembly includes seven lens elements (E1, E2, E3, E4, E5, E6 and E7) with no additional lens element disposed between each of the adjacent seven lens elements.

The first lens element E1 with negative refractive power has an object-side surface being convex in a paraxial region thereof and an image-side surface being concave in a paraxial region thereof. The first lens element E1 is made of plastic material and has the object-side surface and the image-side surface being both aspheric.

The second lens element E2 with negative refractive power has an object-side surface being concave in a paraxial region thereof and an image-side surface being concave in a paraxial region thereof. The second lens element E2 is made of plastic material and has the object-side surface and the image-side surface being both aspheric.

The third lens element E3 with positive refractive power has an object-side surface being convex in a paraxial region thereof and an image-side surface being convex in a paraxial region thereof. The third lens element E3 is made of glass material and has the object-side surface and the image-side surface being both aspheric.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The seventh lens element E7 with negative refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has two inflection points. The object-side surface of the seventh lens element E7 has one critical point in an off-axis region thereof. The image-side surface of the seventh lens element E7 has one critical point in an off-axis region thereof.

The filter E8 is made of glass material and located between the seventh lens element E7 and the image surface IMG, and will not affect the focal length of the imaging optical lens assembly. The image sensor IS is disposed on or near the image surface IMG of the imaging optical lens assembly.

In this embodiment, each of an Abbe number of the second lens element E2 and an Abbe number of the third lens element E3 is smaller than 40.0.

The detailed optical data of the 2nd embodiment are shown in Table 2A and the aspheric surface data are shown in Table 2B below.

TABLE 2A
2nd Embodiment
f = 3.48 mm, Fno = 2.80, HFOV = 74.7 deg.

| Surface # | | Curvature Radius | | Thickness | Material | Index | Abbe # | Focal Length |
|---|---|---|---|---|---|---|---|---|
| 0 | Object | Infinity | | 1000.000 | | | | |
| 1 | Lens 1 | 31.0447 | (ASP) | 0.843 | Plastic | 1.544 | 56.0 | −6.22 |
| 2 | | 3.0221 | (ASP) | 1.145 | | | | |
| 3 | Lens 2 | −58.8235 | (ASP) | 0.823 | Plastic | 1.650 | 21.8 | −6.43 |
| 4 | | 4.5238 | (ASP) | 0.165 | | | | |
| 5 | Lens 3 | 4.4055 | (ASP) | 2.164 | Glass | 1.741 | 27.8 | 3.73 |
| 6 | | −5.8765 | (ASP) | 0.178 | | | | |
| 7 | Ape. Stop | Plano | | −0.117 | | | | |
| 8 | Lens 4 | 2.9274 | (ASP) | 1.166 | Plastic | 1.544 | 56.0 | 2.77 |
| 9 | | −2.6743 | (ASP) | 0.053 | | | | |
| 10 | Lens 5 | −5.2323 | (ASP) | 0.500 | Plastic | 1.660 | 20.4 | −4.12 |
| 11 | | 5.8768 | (ASP) | 0.779 | | | | |
| 12 | Lens 6 | 10.8708 | (ASP) | 0.789 | Plastic | 1.544 | 56.0 | −69.70 |
| 13 | | 8.2327 | (ASP) | 0.464 | | | | |
| 14 | Lens 7 | 13.3005 | (ASP) | 1.012 | Plastic | 1.584 | 28.2 | −10.96 |
| 15 | | 4.2009 | (ASP) | 0.800 | | | | |

| | | | | | | | |
|---|---|---|---|---|---|---|---|
| 16 | Filter | Plano | 0.210 | Glass | 1.517 | 64.2 | — |
| 17 | | Plano | 0.141 | | | | |
| 18 | Image | Plano | — | | | | |

Note:
Reference wavelength is 587.6 nm (d-line).

TABLE 2B
Aspheric Coefficients

| Surface # | 1 | 2 | 3 | 4 |
|---|---|---|---|---|
| k= | 9.98449E+00 | 2.90622E−02 | −9.67102E+01 | −5.91263E+00 |
| A4= | −8.481439626E−05 | −7.101592711E−04 | −1.557971226E−02 | 3.871679182E−03 |
| A6= | 2.031796485E−05 | 1.297862892E−03 | 9.251270871E−03 | 3.132860343E−02 |
| A8= | 6.941086136E−08 | −7.361650854E−04 | −1.091160672E−02 | −5.540349038E−02 |
| A10= | −3.491887629E−07 | 1.969740156E−04 | 8.094562395E−03 | 6.163210841E−02 |
| A12= | 2.637599729E−08 | −3.111389060E−05 | −3.690074271E−03 | −4.587260725E−02 |
| A14= | −4.955265721E−10 | 2.707375888E−06 | 1.087811166E−03 | 2.386562498E−02 |
| A16= | — | — | −2.046252800E−04 | −8.158812506E−03 |
| A18= | — | — | 2.238331577E−05 | 1.595370254E−03 |
| A20= | — | — | −1.080775191E−06 | −1.311967542E−04 |

| Surface # | 5 | 6 | 8 | 9 |
|---|---|---|---|---|
| k= | 1.86645E−01 | 3.21987E−01 | −9.26696E−01 | −1.59640E−01 |
| A4= | −1.769801143E−03 | 2.861926285E−03 | 1.267451435E−02 | 1.561664618E−02 |
| A6= | 1.184617963E−02 | −1.031061361E−02 | −1.196577295E−02 | −1.792208970E−01 |
| A8= | −1.924172893E−02 | 1.452109748E−02 | 1.407650849E−02 | 1.040801754E+00 |
| A10= | 1.402507405E−02 | −1.051120477E−02 | −1.105565793E−02 | −3.482020052E+00 |
| A12= | −4.918575078E−03 | 3.419103506E−03 | 3.999423256E−03 | 7.180102149E+00 |
| A14= | 6.762422415E−04 | −1.978142447E−04 | −1.688080118E−03 | −9.592065093E+00 |
| A16= | — | — | — | 8.330256940E+00 |
| A18= | — | — | — | −4.547161266E+00 |
| A20= | — | — | — | 1.418486446E+00 |
| A22= | — | — | — | −1.929642141E−01 |
| Surface # | 10 | 11 | 12 | 13 |
| k= | −9.65393E+01 | −8.61589E+01 | −1.95334E+01 | −2.62845E+01 |
| A4= | −1.025151120E−01 | 5.823074734E−02 | −1.161303812E−02 | 5.021362197E−03 |
| A6= | 1.592915755E−01 | −4.445010219E−02 | 2.634679710E−02 | 6.016484780E−03 |
| A8= | −2.621010861E−01 | 4.242184271E−02 | −7.145455964E−02 | −1.856876968E−02 |
| A10= | 2.823556860E−01 | −2.528823425E−02 | 8.682871995E−02 | 1.439020100E−02 |
| A12= | −2.022086088E−01 | 4.196025512E−03 | −6.064934477E−02 | −6.104304618E−03 |
| A14= | 8.148218950E−02 | 4.086760839E−03 | 2.490593901E−02 | 1.539866706E−03 |
| A16= | −1.381165359E−02 | −2.443721946E−03 | −5.532509344E−03 | −2.315831384E−04 |
| A18= | — | 4.114742768E−04 | 4.106142147E−04 | 1.922714989E−05 |
| A20= | — | — | 6.452566145E−05 | −6.790901681E−07 |
| A22= | — | — | −1.096412108E−05 | — |

| Surface # | 14 | 15 |
|---|---|---|
| k= | −1.95676E+01 | −6.02814E+00 |
| A4= | −3.653822816E−02 | −3.201389683E−02 |
| A6= | 2.478132852E−02 | 1.183537092E−02 |
| A8= | −3.069915180E−02 | −5.912031684E−03 |
| A10= | 2.720819189E−02 | 1.859371090E−03 |
| A12= | −1.694176314E−02 | 7.605435925E−05 |
| A14= | 7.750509525E−03 | −3.647323081E−04 |
| A16= | −2.879023815E−03 | 1.753531401E−04 |
| A18= | 9.355742052E−04 | −4.704304676E−05 |
| A20= | −2.562243525E−04 | 8.203554395E−06 |
| A22= | 5.292778293E−05 | −9.673860162E−07 |
| A24= | −7.457408732E−06 | 7.691564405E−08 |
| A26= | 6.569817837E−07 | −3.964423367E−09 |
| A28= | −3.199646241E−08 | 1.199479007E−10 |
| A30= | 6.424313492E−10 | −1.621012254E−12 |

In the 2nd embodiment, the equation of the aspheric surface profiles of the aforementioned lens elements is the same as the equation of the 1st embodiment. Also, the definitions of these parameters shown in Table 2C are the same as those stated in the 1st embodiment with corresponding values for the 2nd embodiment, so an explanation in this regard will not be provided again.

Moreover, these parameters can be calculated from Table 2A and Table 2B as the following values and satisfy the following conditions:

TABLE 2C
Schematic Parameters

| | | | |
|---|---|---|---|
| f [mm] | 3.48 | f/R3 | −0.06 |
| Fno | 2.80 | f12/f56 | 0.76 |
| HFOV [deg.] | 74.7 | f45/f23 | 0.86 |
| FOV [deg.] | 149.4 | f45/(CT4 + T45 + CT5) | 3.44 |
| TL/ImgH | 2.76 | f2345/(CT2 + T23 + CT3) | 0.98 |
| SL/ImgH | 1.44 | (R3 + R4)/(R3 − R4) | 0.86 |
| SL/TL | 0.52 | R7/f3 | 0.78 |
| TD/f | 2.86 | SL/f4567 | 0.81 |
| BL/f | 0.33 | T12/T56 | 1.47 |
| TL/CT2 | 13.51 | T56/CT5 | 1.56 |
| TL/CT3 | 5.14 | (T34 + CT4)/CT3 | 0.57 |
| TL/R4 | 2.46 | (TL − SL)/f123 | 0.29 |
| ATmax/f | 0.33 | (CT2 + T23 + CT3)/(CT4 + T45 + CT5) | 1.83 |
| (EPD × SL)/(ImgH × CT4) | 1.54 | V5 | 20.4 |
| f/f56 | −0.93 | V7 | 28.2 |

### 3rd Embodiment

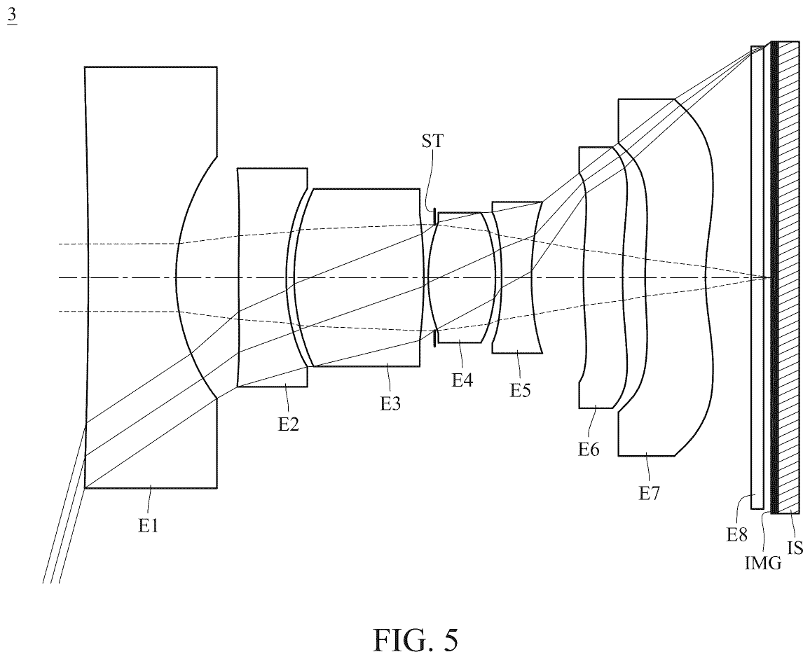

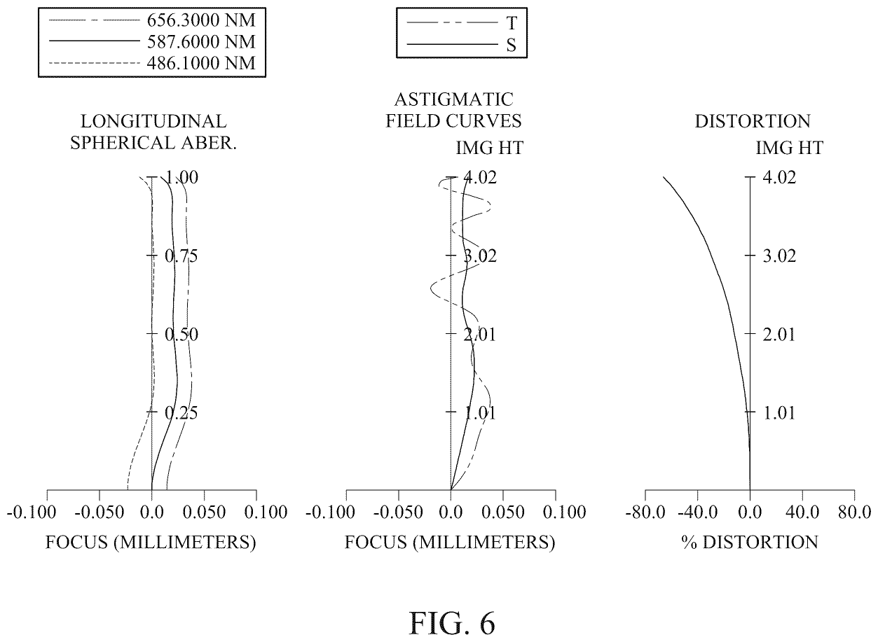

FIG. 5 is a schematic view of an image capturing unit according to the 3rd embodiment of the present disclosure. FIG. 6 shows, in order from left to right, spherical aberration curves, astigmatic field curves and a distortion curve of the image capturing unit according to the 3rd embodiment. In FIG. 5, the image capturing unit 3 includes the imaging optical lens assembly (its reference numeral is omitted) of the present disclosure and an image sensor IS. The imaging optical lens assembly includes, in order from an object side to an image side along an optical axis, a first lens element E1, a second lens element E2, a third lens element E3, an aperture stop ST, a fourth lens element E4, a fifth lens element E5, a sixth lens element E6, a seventh lens element E7, a filter E8 and an image surface IMG. The imaging optical lens assembly includes seven lens elements (E1, E2, E3, E4, E5, E6 and E7) with no additional lens element disposed between each of the adjacent seven lens elements.

The first lens element E1 with negative refractive power has an object-side surface being concave in a paraxial region thereof and an image-side surface being concave in a paraxial region thereof. The first lens element E1 is made of glass material and has the object-side surface and the image-side surface being both aspheric. The object-side surface of the first lens element E1 has one inflection point.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has two inflection points. The object-side surface of the second lens element E2 has one critical point in an off-axis region thereof.

The third lens element E3 with positive refractive power has an object-side surface being convex in a paraxial region thereof and an image-side surface being convex in a paraxial region thereof. The third lens element E3 is made of glass material and has the object-side surface and the image-side surface being both aspheric.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The seventh lens element E7 with negative refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has two inflection points. The object-side surface of the seventh lens element E7 has one critical point in an off-axis region thereof. The image-side surface of the seventh lens element E7 has one critical point in an off-axis region thereof.

The filter E8 is made of glass material and located between the seventh lens element E7 and the image surface IMG, and will not affect the focal length of the imaging optical lens assembly. The image sensor IS is disposed on or near the image surface IMG of the imaging optical lens assembly.

In this embodiment, each of an Abbe number of the second lens element E2, an Abbe number of the third lens element E3 and an Abbe number of the sixth lens element E6 is smaller than 40.0.

The detailed optical data of the 3rd embodiment are shown in Table 3A and the aspheric surface data are shown in Table 3B below.

TABLE 3A
3rd Embodiment
f = 3.22 mm, Fno = 2.80, HFOV = 74.9 deg.

| Surface # | | Curvature Radius | | Thickness | Material | Index | Abbe # | Focal Length |
|---|---|---|---|---|---|---|---|---|
| 0 | Object | Infinity | | 1000.000 | | | | |
| 1 | Lens 1 | −76.5476 | (ASP) | 1.496 | Glass | 1.697 | 56.2 | −4.58 |
| 2 | | 3.3553 | (ASP) | 1.068 | | | | |
| 3 | Lens 2 | 24.4281 | (ASP) | 0.813 | Plastic | 1.660 | 20.4 | −6.86 |
| 4 | | 3.7676 | (ASP) | 0.135 | | | | |
| 5 | Lens 3 | 3.6536 | (ASP) | 2.212 | Glass | 1.805 | 25.5 | 3.44 |
| 6 | | −8.3818 | (ASP) | 0.186 | | | | |
| 7 | Ape. Stop | Plano | | −0.110 | | | | |
| 8 | Lens 4 | 2.7225 | (ASP) | 1.148 | Plastic | 1.535 | 55.9 | 2.79 |
| 9 | | −2.8149 | (ASP) | 0.104 | | | | |
| 10 | Lens 5 | −6.5829 | (ASP) | 0.509 | Plastic | 1.657 | 21.3 | −4.03 |
| 11 | | 4.5558 | (ASP) | 0.886 | | | | |
| 12 | Lens 6 | 8.1280 | (ASP) | 0.669 | Plastic | 1.639 | 23.5 | 101.93 |
| 13 | | 8.9898 | (ASP) | 0.386 | | | | |
| 14 | Lens 7 | 7.6644 | (ASP) | 1.029 | Plastic | 1.680 | 18.2 | −13.97 |
| 15 | | 4.0114 | (ASP) | 0.781 | | | | |

| | | | | | | | |
|---|---|---|---|---|---|---|---|
| 16 | Filter | Plano | 0.210 | Glass | 1.517 | 64.2 | — |
| 17 | | Plano | 0.129 | | | | |
| 18 | Image | Plano | — | | | | |

Note:
Reference wavelength is 587.6 nm (d-line).

TABLE 3B
Aspheric Coefficients

| Surface # | 1 | 2 | 3 | 4 |
|---|---|---|---|---|
| k= | −9.06222E+01 | −1.61749E−01 | 9.89160E+01 | −5.56404E+00 |
| A4= | 9.293699998E−05 | −1.298941069E−03 | −1.376067548E−02 | 1.389824019E−02 |
| A6= | −2.650962601E−05 | 1.743740541E−03 | 4.928936606E−03 | −4.151704673E−03 |
| A8= | 1.089179831E−05 | −1.739774493E−03 | −8.800276534E−03 | −8.620215884E−04 |
| A10= | −1.636274316E−06 | 8.715007479E−04 | 1.089428364E−02 | 1.894624845E−02 |
| A12= | 1.065379373E−07 | −2.062862641E−04 | −7.562621517E−03 | −2.919952220E−02 |
| A14= | −2.476093857E−09 | 1.877767357E−05 | 3.072836201E−03 | 2.196667026E−02 |
| A16= | — | — | −7.282137480E−04 | −9.067797319E−03 |
| A18= | — | — | 9.320292592E−05 | 1.971556338E−03 |
| A20= | — | — | −4.960659043E−06 | −1.764862841E−04 |

| Surface # | 5 | 6 | 8 | 9 |
|---|---|---|---|---|
| k= | 6.72210E−02 | 1.00625E−01 | −9.02540E−01 | −2.12617E−01 |
| A4= | 1.030754827E−03 | 3.148976696E−03 | 1.260815469E−02 | 1.263961252E−02 |
| A6= | −4.242736914E−03 | −4.511738955E−03 | 6.163852386E−03 | −2.526833544E−01 |
| A8= | 5.123373305E−03 | −3.205764365E−03 | −4.945752065E−02 | 1.720295752E+00 |
| A10= | −3.205736174E−03 | 1.230413710E−02 | 9.244646047E−02 | −6.321984276E+00 |
| A12= | 1.071165791E−03 | −1.126611924E−02 | −8.475805675E−02 | 1.440565677E+01 |
| A14= | −1.411859336E−04 | 3.541565535E−03 | 2.885538327E−02 | −2.135513996E+01 |
| A16= | — | — | — | 2.051221216E+01 |
| A18= | — | — | — | −1.227989143E+01 |
| A20= | — | — | — | 4.156034848E+00 |
| A22= | — | — | — | −6.063149379E−01 |

| Surface # | 10 | 11 | 12 | 13 |
|---|---|---|---|---|
| k= | −9.59712E+01 | −8.77377E+01 | −3.99287E+01 | −4.18873E+01 |
| A4= | −9.898821958E−02 | 7.642243687E−02 | −9.546976507E−03 | 1.471413877E−02 |
| A6= | 1.046483057E−01 | −1.408245162E−01 | 1.040355024E−02 | −2.582788002E−02 |
| A8= | −5.442217898E−02 | 2.746856125E−01 | −7.551634547E−03 | 2.340464200E−02 |
| A10= | −6.289909592E−02 | −3.566385793E−01 | −3.143414363E−02 | −1.632245188E−02 |
| A12= | 9.000595080E−02 | 3.006318235E−01 | 5.893156161E−02 | 7.458766974E−03 |
| A14= | −4.511218700E−02 | −1.589375177E−01 | −4.744596358E−02 | −2.145738896E−03 |
| A16= | 8.806362535E−03 | 4.788814659E−02 | 2.140903200E−02 | 3.704412111E−04 |
| A18= | — | −6.252066577E−03 | −5.633963488E−03 | −3.493947346E−05 |
| A20= | — | — | 8.114893092E−04 | 1.382159054E−06 |
| A22= | — | — | −4.970919572E−05 | — |

| Surface # | 14 | 15 |
|---|---|---|
| k= | −3.63387E+01 | −1.07771E+01 |
| A4= | −2.673237539E−02 | −9.058272953E−03 |
| A6= | 6.593776981E−02 | −8.916439638E−03 |
| A8= | −2.605719004E−01 | −1.508438665E−02 |
| A10= | 4.890551918E−01 | 3.155147865E−02 |
| A12= | −5.602332450E−01 | −2.633131273E−02 |
| A14= | 4.318442470E−01 | 1.331056846E−02 |
| A16= | −2.330919651E−01 | −4.501337927E−03 |
| A18= | 8.952664126E−02 | 1.056231439E−03 |
| A20= | −2.453835792E−02 | −1.741535437E−04 |
| A22= | 4.756363057E−03 | 2.010767744E−05 |
| A24= | −6.361226899E−04 | −1.591673271E−06 |
| A26= | 5.580212442E−05 | 8.229386148E−08 |
| A28= | −2.888443040E−06 | −2.503584080E−09 |
| A30= | 6.685805490E−08 | 3.399293149E−11 |

In the 3rd embodiment, the equation of the aspheric surface profiles of the aforementioned lens elements is the same as the equation of the 1st embodiment. Also, the definitions of these parameters shown in Table 3C are the same as those stated in the 1st embodiment with corresponding values for the 3rd embodiment, so an explanation in this regard will not be provided again.

Moreover, these parameters can be calculated from Table 3A and Table 3B as the following values and satisfy the following conditions:

TABLE 3C
Schematic Parameters

| | | | |
|---|---|---|---|
| f [mm] | 3.22 | f/R3 | 0.13 |
| Fno | 2.80 | f12/f56 | 0.58 |
| HFOV [deg.] | 74.9 | f45/f23 | 0.95 |
| FOV [deg.] | 149.7 | f45/(CT4 + T45 + CT5) | 3.31 |
| TL/ImgH | 2.90 | f2345/(CT2 + T23 + CT3) | 0.94 |
| SL/ImgH | 1.43 | (R3 + R4)/(R3 − R4) | 1.36 |
| SL/TL | 0.49 | R7/f3 | 0.79 |
| TD/f | 3.27 | SL/f4567 | 0.98 |
| BL/f | 0.35 | T12/T56 | 1.21 |
| TL/CT2 | 14.33 | T56/CT5 | 1.74 |
| TL/CT3 | 5.27 | (T34 + CT4)/CT3 | 0.55 |
| TL/R4 | 3.09 | (TL − SL)/f123 | 0.20 |
| ATmax/f | 0.33 | (CT2 + T23 + CT3)/(CT4 + T45 + CT5) | 1.79 |
| (EPD × SL)/(ImgH × CT4) | 1.44 | V5 | 21.3 |
| f/f56 | −0.78 | V7 | 18.2 |

### 4th Embodiment

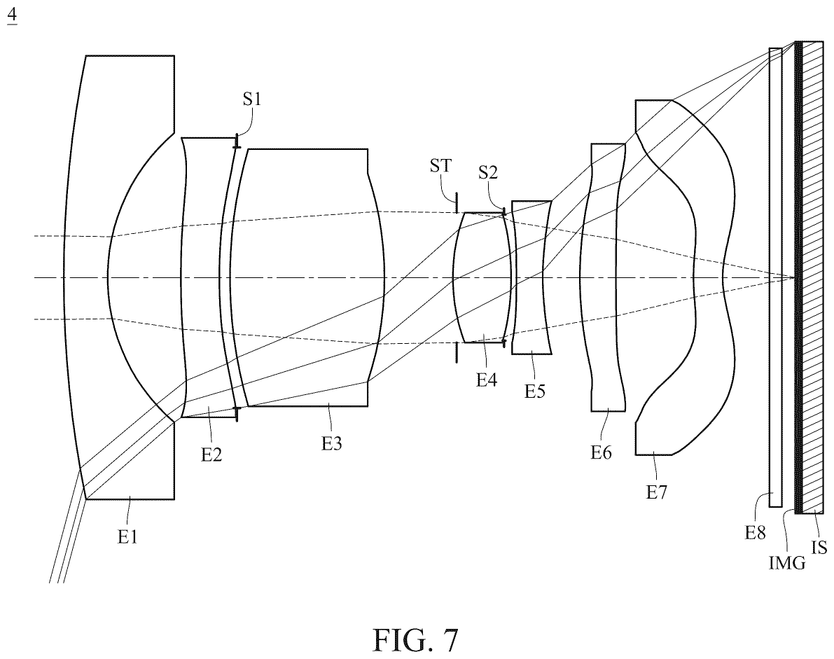

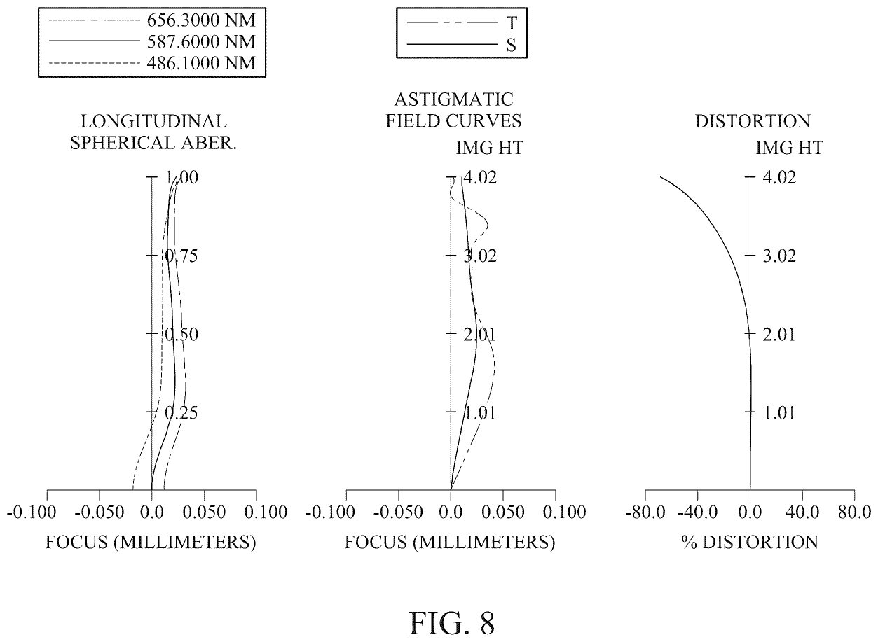

FIG. 7 is a schematic view of an image capturing unit according to the 4th embodiment of the present disclosure. FIG. 8 shows, in order from left to right, spherical aberration curves, astigmatic field curves and a distortion curve of the image capturing unit according to the 4th embodiment. In FIG. 7, the image capturing unit 4 includes the imaging optical lens assembly (its reference numeral is omitted) of the present disclosure and an image sensor IS. The imaging optical lens assembly includes, in order from an object side to an image side along an optical axis, a first lens element E1, a second lens element E2, a stop S1, a third lens element E3, an aperture stop ST, a fourth lens element E4, a stop S2, a fifth lens element E5, a sixth lens element E6, a seventh lens element E7, a filter E8 and an image surface IMG. The imaging optical lens assembly includes seven lens elements (E1, E2, E3, E4, E5, E6 and E7) with no additional lens element disposed between each of the adjacent seven lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has two inflection points. The object-side surface of the second lens element E2 has one critical point in an off-axis region thereof.

The third lens element E3 with positive refractive power has an object-side surface being convex in a paraxial region thereof and an image-side surface being convex in a paraxial region thereof. The third lens element E3 is made of glass material and has the object-side surface and the image-side surface being both spherical.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has three inflection points. The object-side surface of the sixth lens element E6 has one critical point in an off-axis region thereof. The image-side surface of the sixth lens element E6 has one critical point in an off-axis region thereof.

The seventh lens element E7 with negative refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has three inflection points. The image-side surface of the seventh lens element E7 has one inflection point. The object-side surface of the seventh lens element E7 has one critical point in an off-axis region thereof. The image-side surface of the seventh lens element E7 has one critical point in an off-axis region thereof.

The filter E8 is made of glass material and located between the seventh lens element E7 and the image surface IMG, and will not affect the focal length of the imaging optical lens assembly. The image sensor IS is disposed on or near the image surface IMG of the imaging optical lens assembly.

In this embodiment, each of an Abbe number of the second lens element E2 and an Abbe number of the third lens element E3 is smaller than 40.0.

The detailed optical data of the 4th embodiment are shown in Table 4A and the aspheric surface data are shown in Table 4B below.

TABLE 4A
4th Embodiment
f = 3.42 mm, Fno = 2.40, HFOV = 75.0 deg.

| Surface # | | Curvature Radius | | Thickness | Material | Index | Abbe # | Focal Length |
|---|---|---|---|---|---|---|---|---|
| 0 | Object | Infinity | | 1000.000 | | | | |
| 1 | Lens 1 | 19.0964 | (SPH) | 0.750 | Glass | 1.804 | 46.6 | −4.98 |
| 2 | | 3.2546 | (SPH) | 1.254 | | | | |
| 3 | Lens 2 | 16.4167 | (ASP) | 0.657 | Plastic | 1.669 | 19.5 | −40.31 |
| 4 | | 10.0408 | (ASP) | 0.300 | | | | |
| 5 | Stop | Plano | | −0.118 | | | | |
| 6 | Lens 3 | 7.8879 | (SPH) | 2.642 | Glass | 1.613 | 37.0 | 5.78 |
| 7 | | −5.6152 | (SPH) | 1.231 | | | | |
| 8 | Ape. Stop | Plano | | −0.062 | | | | |
| 9 | Lens 4 | 3.2612 | (ASP) | 0.994 | Plastic | 1.534 | 56.0 | 3.78 |
| 10 | | −4.7579 | (ASP) | −0.120 | | | | |
| 11 | Stop | Plano | | 0.211 | | | | |
| 12 | Lens 5 | −104.6689 | (ASP) | 0.450 | Plastic | 1.660 | 20.4 | −6.17 |
| 13 | | 4.2412 | (ASP) | 0.635 | | | | |
| 14 | Lens 6 | 5.9366 | (ASP) | 0.617 | Plastic | 1.551 | 44.8 | 13.68 |
| 15 | | 26.9784 | (ASP) | 1.325 | | | | |
| 16 | Lens 7 | 3.2304 | (ASP) | 0.500 | Plastic | 1.566 | 37.4 | −7.66 |
| 17 | | 1.7472 | (ASP) | 0.800 | | | | |

| | | | | | | | |
|---|---|---|---|---|---|---|---|
| 18 | Filter | Plano | 0.210 | Glass | 1.517 | 64.2 | — |
| 19 | | Plano | 0.228 | | | | |
| 20 | Image | Plano | — | | | | |

Note:
Reference wavelength is 587.6 nm (d-line).
An effective radius of the stop S1 (Surface 5) is 2.229 mm.
An effective radius of the stop S2 (Surface 11) is 1.078 mm.

TABLE 4B
Aspheric Coefficients

| Surface # | 3 | 4 | 9 | 10 |
|---|---|---|---|---|
| k= | 2.80312E+01 | 0.00000E+00 | 0.00000E+00 | 0.00000E+00 |
| A4= | 5.193292653E−03 | 1.000292901E−02 | 7.189875061E−03 | −4.406329934E−02 |
| A6= | −2.173583524E−03 | −1.478541330E−03 | −2.022629055E−03 | 5.195292643E−02 |
| A8= | 2.356300421E−04 | −2.500627432E−04 | 1.682482338E−02 | 2.697802637E−01 |
| A10= | −1.423258206E−04 | −1.213406426E−05 | −6.965712958E−02 | −1.572066016E+00 |
| A12= | 2.956607523E−05 | 9.115926230E−06 | 1.431466271E−01 | 4.083663817E+00 |
| A14= | −2.081200183E−06 | 4.145319280E−06 | −1.720449441E−01 | −6.603332180E+00 |
| A16= | 2.500881968E−08 | −1.174980193E−06 | 1.199860493E−01 | 7.115082212E+00 |
| A18= | — | 7.832056674E−08 | −4.522835531E−02 | −5.140436699E+00 |
| A20= | — | — | 7.103914028E−03 | 2.400029661E+00 |
| A22= | — | — | — | −6.548865848E−01 |
| A24= | — | — | — | 7.917008408E−02 |

| Surface # | 12 | 13 | 14 | 15 |
|---|---|---|---|---|
| k= | −8.72011E+00 | −9.00000E+01 | 1.72851E+00 | −6.16885E−01 |
| A4= | −1.064951635E−01 | 8.418901979E−02 | −3.460114116E−02 | −3.261627247E−02 |
| A6= | 1.859717774E−01 | −2.785229214E−01 | 7.081970610E−02 | 4.859220460E−02 |
| A8= | −3.201352214E−01 | 7.827447794E−01 | −1.232874872E−01 | −5.149417569E−02 |
| A10= | 4.119911632E−01 | −1.605808033E+00 | 1.708041314E−01 | 4.877204628E−02 |
| A12= | −3.939269171E−01 | 2.287321722E+00 | −1.739007420E−01 | −3.588435279E−02 |
| A14= | 2.766086624E−01 | −2.211584560E+00 | 1.265142114E−01 | 1.941759468E−02 |
| A16= | −1.390425854E−01 | 1.420717506E+00 | −6.510656827E−02 | −7.487618382E−03 |
| A18= | 4.562309163E−02 | −5.820037594E−01 | 2.340267646E−02 | 2.016472578E−03 |
| A20= | −7.242965040E−03 | 1.397451655E−01 | −5.735221948E−03 | −3.735227262E−04 |
| A22= | — | −1.613397989E−02 | 9.120359222E−04 | 4.650477804E−05 |
| A24= | — | 4.271029899E−04 | −8.472427365E−05 | −3.714442809E−06 |
| A26= | — | — | 3.484304066E−06 | 1.719636808E−07 |
| A28= | — | — | — | −3.510632543E−09 |

| Surface # | 16 | 17 |
|---|---|---|
| k= | −4.34287E+01 | −8.67675E+00 |
| A4= | −2.727515107E−02 | 7.354704644E−03 |
| A6= | −1.790722597E−01 | −1.189916689E−01 |
| A8= | 2.960585168E−01 | 1.666543528E−01 |
| A10= | −3.170961937E−01 | −1.448181600E−01 |
| A12= | 2.320593402E−01 | 8.590582957E−02 |
| A14= | −1.168790190E−01 | −3.596289173E−02 |
| A16= | 4.085484090E−02 | 1.082712267E−02 |
| A18= | −9.946279582E−03 | −2.366389459E−03 |
| A20= | 1.677509315E−03 | 3.753793813E−04 |
| A22= | −1.920332895E−04 | −4.272123177E−05 |
| A24= | 1.423433389E−05 | 3.394869773E−06 |
| A26= | −6.161957291E−07 | −1.786244184E−07 |
| A28= | 1.182545475E−08 | 5.585078766E−09 |
| A30= | — | −7.847237494E−11 |

In the 4th embodiment, the equation of the aspheric surface profiles of the aforementioned lens elements is the same as the equation of the 1st embodiment. Also, the definitions of these parameters shown in Table 4C are the same as those stated in the 1st embodiment with corresponding values for the 4th embodiment, so an explanation in this regard will not be provided again.

Moreover, these parameters can be calculated from Table 4A and Table 4B as the following values and satisfy the following conditions:

TABLE 4C
Schematic Parameters

| | | | |
|---|---|---|---|
| f [mm] | 3.42 | f/R3 | 0.21 |
| Fno | 2.40 | f12/f56 | 0.35 |
| HFOV [deg.] | 75.0 | f45/f23 | 1.12 |
| FOV [deg.] | 149.9 | f45/(CT4 + T45 + CT5) | 4.85 |
| TL/ImgH | 3.11 | f2345/(CT2 + T23 + CT3) | 1.10 |
| SL/ImgH | 1.44 | (R3 + R4)/(R3 − R4) | 4.15 |
| SL/TL | 0.46 | R7/f3 | 0.56 |
| TD/f | 3.29 | SL/f4567 | 0.91 |
| BL/f | 0.36 | T12/T56 | 1.97 |
| TL/CT2 | 19.03 | T56/CT5 | 1.41 |
| TL/CT3 | 4.73 | (T34 + CT4)/CT3 | 0.82 |
| TL/R4 | 1.25 | (TL − SL)/f123 | 0.25 |
| ATmax/f | 0.39 | (CT2 + T23 + CT3)/(CT4 + T45 + CT5) | 2.27 |
| (EPD × SL)/(ImgH × CT4) | 2.07 | V5 | 20.4 |
| f/f56 | −0.28 | V7 | 37.4 |

### 5th Embodiment

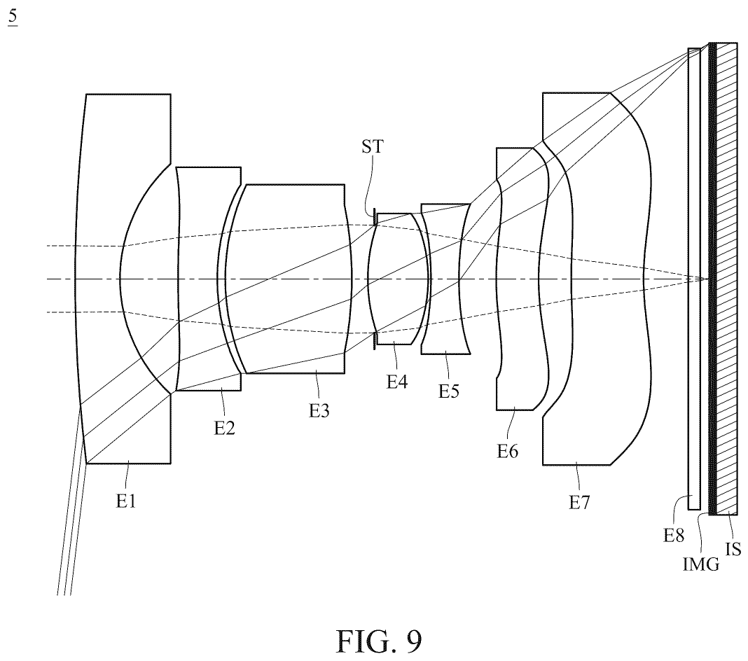

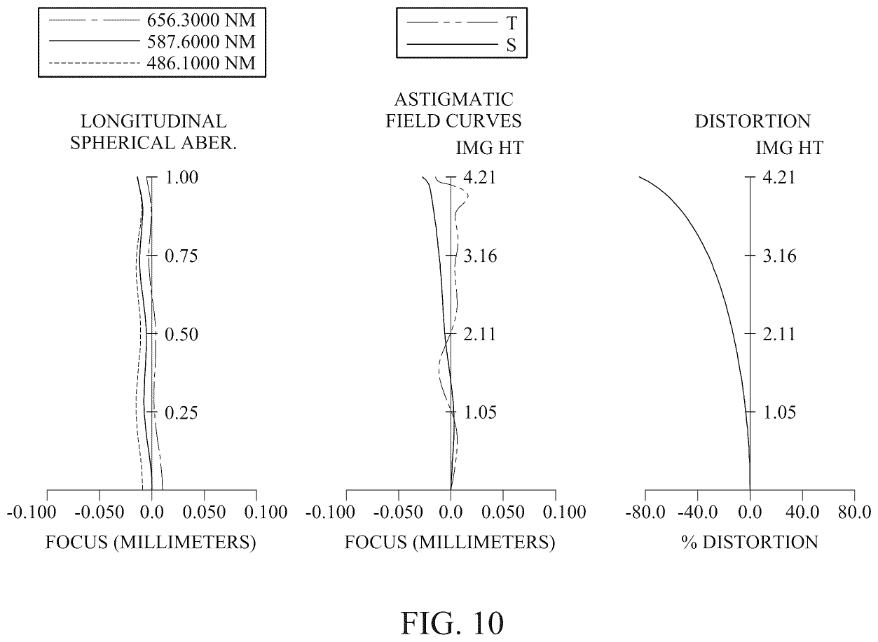

FIG. 9 is a schematic view of an image capturing unit according to the 5th embodiment of the present disclosure. FIG. 10 shows, in order from left to right, spherical aberration curves, astigmatic field curves and a distortion curve of the image capturing unit according to the 5th embodiment. In FIG. 9, the image capturing unit 5 includes the imaging optical lens assembly (its reference numeral is omitted) of the present disclosure and an image sensor IS. The imaging optical lens assembly includes, in order from an object side to an image side along an optical axis, a first lens element E1, a second lens element E2, a third lens element E3, an aperture stop ST, a fourth lens element E4, a fifth lens element E5, a sixth lens element E6, a seventh lens element E7, a filter E8 and an image surface IMG. The imaging optical lens assembly includes seven lens elements (E1, E2, E3, E4, E5, E6 and E7) with no additional lens element disposed between each of the adjacent seven lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has two inflection points. The object-side surface of the second lens element E2 has one critical point in an off-axis region thereof.

The third lens element E3 with positive refractive power has an object-side surface being convex in a paraxial region thereof and an image-side surface being convex in a paraxial region thereof. The third lens element E3 is made of glass material and has the object-side surface and the image-side surface being both spherical.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The seventh lens element E7 with negative refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has one inflection point. The object-side surface of the seventh lens element E7 has one critical point in an off-axis region thereof. The image-side surface of the seventh lens element E7 has one critical point in an off-axis region thereof.

The filter E8 is made of glass material and located between the seventh lens element E7 and the image surface IMG, and will not affect the focal length of the imaging optical lens assembly. The image sensor IS is disposed on or near the image surface IMG of the imaging optical lens assembly.

In this embodiment, each of an Abbe number of the second lens element E2 and an Abbe number of the third lens element E3 is smaller than 40.0.

The detailed optical data of the 5th embodiment are shown in Table 5A and the aspheric surface data are shown in Table 5B below.

TABLE 5A
5th Embodiment
f = 3.32 mm, Fno = 2.80, HFOV = 83.2 deg.

| Surface # | | Curvature Radius | | Thickness | Material | Index | Abbe # | Focal Length |
|---|---|---|---|---|---|---|---|---|
| 0 | Object | Infinity | | 1000.000 | | | | |
| 1 | Lens 1 | 27.1408 | (SPH) | 0.800 | Glass | 1.804 | 46.5 | −3.92 |
| 2 | | 2.7895 | (SPH) | 1.036 | | | | |
| 3 | Lens 2 | 13.7486 | (ASP) | 0.700 | Plastic | 1.660 | 20.4 | −7.91 |
| 4 | | 3.7063 | (ASP) | 0.141 | | | | |
| 5 | Lens 3 | 3.9399 | (SPH) | 2.259 | Glass | 1.805 | 25.5 | 3.40 |
| 6 | | −6.6928 | (SPH) | 0.404 | | | | |
| 7 | Ape. Stop | Plano | | −0.118 | | | | |
| 8 | Lens 4 | 2.9846 | (ASP) | 1.075 | Plastic | 1.544 | 56.0 | 2.81 |
| 9 | | −2.7372 | (ASP) | 0.050 | | | | |
| 10 | Lens 5 | −5.7282 | (ASP) | 0.500 | Plastic | 1.669 | 19.5 | −4.13 |
| 11 | | 5.5372 | (ASP) | 0.665 | | | | |
| 12 | Lens 6 | 5.4452 | (ASP) | 0.757 | Plastic | 1.544 | 56.0 | −171.23 |
| 13 | | 4.8925 | (ASP) | 0.582 | | | | |
| 14 | Lens 7 | 9.7574 | (ASP) | 1.289 | Plastic | 1.660 | 20.4 | −13.75 |
| 15 | | 4.4546 | (ASP) | 0.800 | | | | |

| | | | | | | | |
|---|---|---|---|---|---|---|---|
| 16 | Filter | Plano | 0.210 | Glass | 1.517 | 64.2 | — |
| 17 | | Plano | 0.160 | | | | |
| 18 | Image | Plano | — | | | | |

Note:
Reference wavelength is 587.6 nm (d-line).

TABLE 5B
Aspheric Coefficients

| Surface # | 3 | 4 | 8 | 9 |
|---|---|---|---|---|
| k= | −6.65713E+01 | −6.09055E+00 | −2.91780E+00 | −6.17404E−01 |
| A4= | −1.100157335E−02 | 1.075529494E−02 | 1.898601664E−02 | −2.416787333E−02 |
| A6= | 1.195138237E−03 | −2.922038888E−03 | −2.223836595E−02 | 1.078058431E−01 |
| A8= | −1.214129136E−03 | 7.481581045E−03 | 5.874229516E−02 | −4.054770734E−01 |
| A10= | 1.199962720E−03 | −9.817727078E−03 | −9.839433354E−02 | 1.226202969E+00 |
| A12= | −8.194948223E−04 | 8.038049424E−03 | 7.550298581E−02 | −2.753118560E+00 |
| A14= | 3.410134384E−04 | −4.246654735E−03 | −2.461180184E−02 | 4.072692853E+00 |
| A16= | −8.270963747E−05 | 1.433462030E−03 | — | −3.876741931E+00 |
| A18= | 1.081306110E−05 | −2.804498851E−04 | — | 2.284561800E+00 |
| A20= | −5.857475247E−07 | 2.422643682E−05 | — | −7.567257530E−01 |
| A22= | — | — | — | 1.074724842E−01 |

| Surface # | 10 | 11 | 12 | 13 |
|---|---|---|---|---|
| k= | −9.81240E+01 | −9.00000E+01 | −8.37472E+00 | −5.90644E+00 |
| A4= | −9.833700843E−02 | 5.845994208E−02 | −1.218793773E−02 | −2.771706938E−04 |
| A6= | 1.589672792E−01 | −6.062975941E−02 | 1.699201716E−02 | −2.257899240E−03 |
| A8= | −2.214025027E−01 | 9.649587694E−02 | −6.211350091E−02 | −4.230785111E−03 |
| A10= | 2.147402914E−01 | −1.065055861E−01 | 9.327164086E−02 | 3.686606965E−03 |
| A12= | −1.678831840E−01 | 7.914513933E−02 | −8.449993850E−02 | −1.455151331E−03 |
| A14= | 8.075781874E−02 | −3.930935562E−02 | 4.962219125E−02 | 3.103536497E−04 |
| A16= | −1.589242905E−02 | 1.191655596E−02 | −1.906416612E−02 | −3.537870669E−05 |
| A18= | — | −1.629156913E−03 | 4.623171429E−03 | 1.714575492E−06 |
| A20= | — | — | −6.409352857E−04 | −4.375700361E−09 |
| A22= | — | — | 3.849413099E−05 | — |

| Surface # | 14 | 15 |
|---|---|---|
| k= | −9.21455E+01 | −2.09375E+01 |
| A4= | −2.224810643E−02 | −1.032104565E−02 |
| A6= | 8.166163811E−03 | −1.817097714E−03 |
| A8= | −1.640644448E−02 | 1.251602002E−03 |
| A10= | 2.652538837E−02 | −1.622691319E−05 |
| A12= | −2.690575371E−02 | −2.462642000E−04 |
| A14= | 1.798212975E−02 | 1.215383019E−04 |
| A16= | −8.297448266E−03 | −3.161301484E−05 |
| A18= | 2.702581150E−03 | 5.206867346E−06 |
| A20= | −6.235754238E−04 | −5.670281128E−07 |
| A22= | 1.006918001E−04 | 4.046137769E−08 |
| A24= | −1.104976186E−05 | −1.786475029E−09 |
| A26= | 7.794050195E−07 | 4.167341959E−11 |
| A28= | −3.161521035E−08 | −2.448696421E−13 |
| A30= | 5.550249573E−10 | −5.305285457E−15 |

In the 5th embodiment, the equation of the aspheric surface profiles of the aforementioned lens elements is the same as the equation of the 1st embodiment. Also, the definitions of these parameters shown in Table 5C are the same as those stated in the 1st embodiment with corresponding values for the 5th embodiment, so an explanation in this regard will not be provided again.

Moreover, these parameters can be calculated from Table 5A and Table 5B as the following values and satisfy the following conditions:

TABLE 5C
Schematic Parameters

| | | | |
|---|---|---|---|
| f [mm] | 3.32 | f/R3 | 0.24 |
| Fno | 2.80 | f12/f56 | 0.61 |
| HFOV [deg.] | 83.2 | f45/f23 | 1.15 |
| FOV [deg.] | 166.3 | f45/(CT4 + T45 + CT5) | 3.80 |
| TL/ImgH | 2.69 | f2345/(CT2 + T23 + CT3) | 0.96 |
| SL/ImgH | 1.42 | (R3 + R4)/(R3 − R4) | 1.74 |
| SL/TL | 0.53 | R7/f3 | 0.88 |
| TD/f | 3.06 | SL/f4567 | 0.91 |
| BL/f | 0.35 | T12/T56 | 1.56 |
| TL/CT2 | 16.16 | T56/CT5 | 1.33 |
| TL/CT3 | 5.01 | (T34 + CT4)/CT3 | 0.60 |
| TL/R4 | 3.05 | (TL − SL)/f123 | 0.23 |
| ATmax/f | 0.31 | (CT2 + T23 + CT3)/ | 1.91 |
| | | (CT4 + T45 + CT5) | |
| (EPD × SL)/(ImgH × CT4) | 1.57 | V5 | 19.5 |
| f/f56 | −0.87 | V7 | 20.4 |

### 6th Embodiment

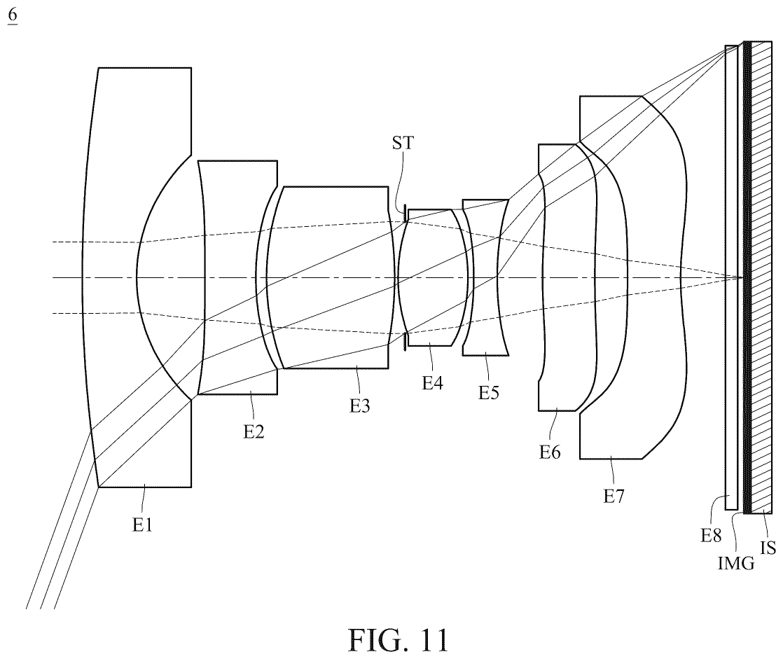

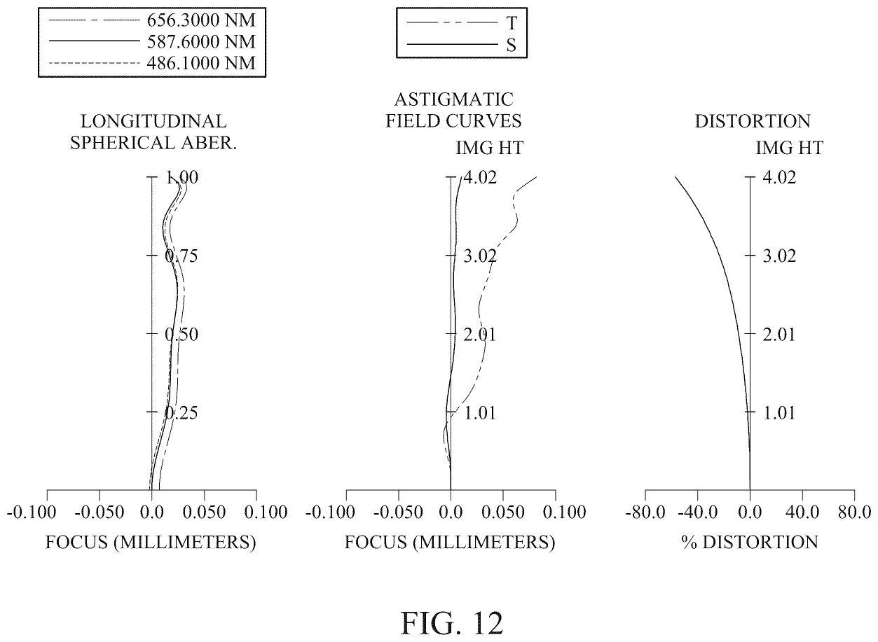

FIG. 11 is a schematic view of an image capturing unit according to the 6th embodiment of the present disclosure. FIG. 12 shows, in order from left to right, spherical aberration curves, astigmatic field curves and a distortion curve of the image capturing unit according to the 6th embodiment. In FIG. 11, the image capturing unit 6 includes the imaging optical lens assembly (its reference numeral is omitted) of the present disclosure and an image sensor IS. The imaging optical lens assembly includes, in order from an object side to an image side along an optical axis, a first lens element E1, a second lens element E2, a third lens element E3, an aperture stop ST, a fourth lens element E4, a fifth lens element E5, a sixth lens element E6, a seventh lens element E7, a filter E8 and an image surface IMG. The imaging optical lens assembly includes seven lens elements (E1, E2, E3, E4, E5, E6 and E7) with no additional lens element disposed between each of the adjacent seven lens elements.

The first lens element E1 with negative refractive power has an object-side surface being convex in a paraxial region thereof and an image-side surface being concave in a paraxial region thereof. The first lens element E1 is made of plastic material and has the object-side surface and the image-side surface being both aspheric.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The object-side surface of the second lens element E2 has one critical point in an off-axis region thereof.

The third lens element E3 with positive refractive power has an object-side surface being convex in a paraxial region thereof and an image-side surface being convex in a paraxial region thereof. The third lens element E3 is made of glass material and has the object-side surface and the image-side surface being both aspheric.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The seventh lens element E7 with negative refractive power has an object-side surface being concave in a paraxial region thereof and an image-side surface being concave in a paraxial region thereof. The seventh lens element E7 is made of plastic material and has the object-side surface and the image-side surface being both aspheric. The object-side surface of the seventh lens element E7 has one inflection point. The image-side surface of the seventh lens element E7 has two inflection points. The image-side surface of the seventh lens element E7 has one critical point in an off-axis region thereof.

The filter E8 is made of glass material and located between the seventh lens element E7 and the image surface IMG, and will not affect the focal length of the imaging optical lens assembly. The image sensor IS is disposed on or near the image surface IMG of the imaging optical lens assembly.

In this embodiment, each of an Abbe number of the second lens element E2 and an Abbe number of the third lens element E3 is smaller than 40.0.

The detailed optical data of the 6th embodiment are shown in Table 6A and the aspheric surface data are shown in Table 6B below.

TABLE 6A
6th Embodiment
f = 3.41 mm, Fno = 2.80, HFOV = 70.0 deg.

| Surface # | | Curvature Radius | | Thickness | Material | Index | Abbe # | Focal Length |
|---|---|---|---|---|---|---|---|---|
| 0 | Object | Infinity | | 1000.000 | | | | |
| 1 | Lens 1 | 22.5690 | (ASP) | 0.926 | Plastic | 1.544 | 55.5 | −5.79 |
| 2 | | 2.7246 | (ASP) | 1.162 | | | | |
| 3 | Lens 2 | 308.9825 | (ASP) | 0.869 | Plastic | 1.656 | 21.3 | −6.56 |
| 4 | | 4.2391 | (ASP) | 0.183 | | | | |
| 5 | Lens 3 | 4.2482 | (ASP) | 2.182 | Glass | 1.741 | 27.8 | 3.71 |
| 6 | | −6.0692 | (ASP) | 0.177 | | | | |
| 7 | Ape. Stop | Plano | | −0.118 | | | | |
| 8 | Lens 4 | 2.9299 | (ASP) | 1.190 | Plastic | 1.544 | 55.9 | 2.81 |
| 9 | | −2.7303 | (ASP) | 0.099 | | | | |
| 10 | Lens 5 | −5.6815 | (ASP) | 0.400 | Plastic | 1.660 | 20.4 | −4.00 |
| 11 | | 5.0620 | (ASP) | 0.773 | | | | |
| 12 | Lens 6 | 9.5446 | (ASP) | 0.891 | Plastic | 1.544 | 56.0 | 31.46 |
| 13 | | 20.8683 | (ASP) | 0.556 | | | | |
| 14 | Lens 7 | −65.7048 | (ASP) | 0.906 | Plastic | 1.584 | 28.2 | −7.90 |
| 15 | | 4.9915 | (ASP) | 0.762 | | | | |

| | | | | | | | |
|---|---|---|---|---|---|---|---|
| 16 | Filter | Plano | 0.210 | Glass | 1.517 | 64.2 | — |
| 17 | | Plano | 0.105 | | | | |
| 18 | Image | Plano | — | | | | |

Note:
Reference wavelength is 587.6 nm (d-line).

TABLE 6B
Aspheric Coefficients

| Surface # | 1 | 2 | 3 | 4 |
|---|---|---|---|---|
| k= | −7.58654E−02 | −1.99746E−01 | −4.96866E+01 | −5.61208E+00 |
| A4= | −8.349143924E−05 | −8.522818659E−04 | −1.374862925E−02 | 1.774396146E−03 |
| A6= | 2.305880558E−05 | 1.625276436E−03 | 6.018141765E−03 | 5.082391009E−02 |
| A8= | 2.277944571E−07 | −1.167451162E−03 | −7.268425765E−03 | −1.171843685E−01 |
| A10= | −4.393631569E−07 | 4.089167295E−04 | 5.397525886E−03 | 1.638568323E−01 |
| A12= | 2.881849584E−08 | −7.129940252E−05 | −2.316394374E−03 | −1.456010639E−01 |
| A14= | −4.087262144E−10 | 5.101575187E−06 | 6.137515940E−04 | 8.336840308E−02 |
| A16= | — | — | −1.001169231E−04 | −2.946486068E−02 |
| A18= | — | — | 9.218172865E−06 | 5.792337387E−03 |
| A20= | — | — | −3.646843050E−07 | −4.803303315E−04 |
| Surface # | 5 | 6 | 8 | 9 |
| k= | −4.31582E−02 | −2.85537E−03 | −9.70522E−01 | −2.58555E−01 |
| A4= | −4.033058016E−04 | 5.688031881E−03 | 1.368358350E−02 | 3.847177107E−02 |
| A6= | 7.249505269E−03 | −2.326623562E−02 | −1.019506256E−02 | −5.340874405E−01 |
| A8= | −1.418024729E−02 | 4.271529622E−02 | −5.867706848E−03 | 4.460553448E+00 |
| A10= | 1.134192361E−02 | −4.360898654E−02 | 3.569095983E−02 | −2.271988534E+01 |
| A12= | −4.201720335E−03 | 2.298937396E−02 | −4.351844454E−02 | 7.102133089E+01 |
| A14= | 6.000382764E−04 | −4.749558707E−03 | 1.603699782E−02 | −1.397137582E+02 |
| A16= | — | — | — | 1.728828563E+02 |
| A18= | — | — | — | −1.305004908E+02 |
| A20= | — | — | — | 5.490823151E+01 |
| A22= | — | — | — | −9.875242031E+00 |
| Surface # | 10 | 11 | 12 | 13 |
| k= | −9.51283E+01 | −8.51861E+01 | −4.84415E+01 | −5.74954E+01 |
| A4= | −9.455353053E−02 | 6.489068937E−02 | −1.031977816E−01 | 5.956853911E−03 |
| A6= | 9.970467361E−02 | −8.186096111E−02 | 2.352230799E−01 | −3.840320945E−03 |
| A8= | −1.022903514E−01 | 1.337125417E−01 | −2.059977145E+00 | −2.773903079E−03 |
| A10= | 7.765494657E−02 | −1.486886862E−01 | 5.893776475E+00 | 2.076527453E−03 |
| A12= | −6.584202943E−02 | 1.050235801E−01 | −7.083688906E+00 | −5.516426722E−04 |
| A14= | 3.473548646E−02 | −4.593527068E−02 | −3.312229683E+00 | 1.765568421E−05 |
| A16= | −7.013132809E−03 | 1.141759338E−02 | 2.200400262E+01 | 1.902766878E−05 |
| A18= | — | −1.224031785E−03 | −2.933302450E+01 | −3.584509802E−06 |
| A20= | — | — | 1.789859929E+01 | 2.036082152E−07 |
| A22= | — | — | −4.368478717E+00 | — |

| Surface # | 14 | 15 |
|---|---|---|
| k= | −3.27311E+01 | −6.55001E+00 |
| A4= | −1.290983875E+00 | −3.387117728E+00 |
| A6= | 9.516362760E+00 | 1.222381348E+01 |
| A8= | −1.260682027E+02 | −4.338273235E+01 |
| A10= | 1.147664035E+03 | −1.159905574E+01 |
| A12= | −7.109606726E+03 | 1.242624826E+03 |
| A14= | 3.052056060E+04 | −8.034470169E+03 |
| A16= | −9.249998207E+04 | 2.923987637E+04 |
| A18= | 2.000901407E+05 | −7.012339601E+04 |
| A20= | −3.093446212E+05 | 1.157273405E+05 |
| A22= | 3.383366903E+05 | −1.323182328E+05 |
| A24= | −2.550771041E+05 | 1.029987061E+05 |
| A26= | 1.258595862E+05 | −5.207303638E+04 |
| A28= | −3.652984356E+04 | 1.541009369E+04 |
| A30= | 4.723509148E+03 | −2.024841779E+03 |

In the 6th embodiment, the equation of the aspheric surface profiles of the aforementioned lens elements is the same as the equation of the 1st embodiment. Also, the definitions of these parameters shown in Table 6C are the same as those stated in the 1st embodiment with corresponding values for the 6th embodiment, so an explanation in this regard will not be provided again.

Moreover, these parameters can be calculated from Table 6A and Table 6B as the following values and satisfy the following conditions:

TABLE 6C
Schematic Parameters

| | | | |
|---|---|---|---|
| f [mm] | 3.41 | f/R3 | 0.01 |
| Fno | 2.80 | f12/f56 | 0.59 |
| HFOV [deg.] | 70.0 | f45/f23 | 0.91 |
| FOV [deg.] | 139.9 | f45/(CT4 + T45 + CT5) | 3.66 |
| TL/ImgH | 2.80 | f2345/(CT2 + T23 + CT3) | 0.97 |
| SL/ImgH | 1.44 | (R3 + R4)/(R3 − R4) | 1.03 |
| SL/TL | 0.51 | R7/f3 | 0.79 |
| TD/f | 2.99 | SL/f4567 | 0.83 |
| BL/f | 0.32 | T12/T56 | 1.50 |
| TL/CT2 | 12.97 | T56/CT5 | 1.93 |
| TL/CT3 | 5.17 | (T34 + CT4)/CT3 | 0.57 |
| TL/R4 | 2.66 | (TL − SL)/f123 | 0.28 |
| ATmax/f | 0.34 | (CT2 + T23 + CT3)/ | 1.91 |
| | | (CT4 + T45 + CT5) | |
| (EPD × SL)/(ImgH × CT4) | 1.47 | V5 | 20.4 |
| f/f56 | −0.73 | V7 | 28.2 |

### 7th Embodiment

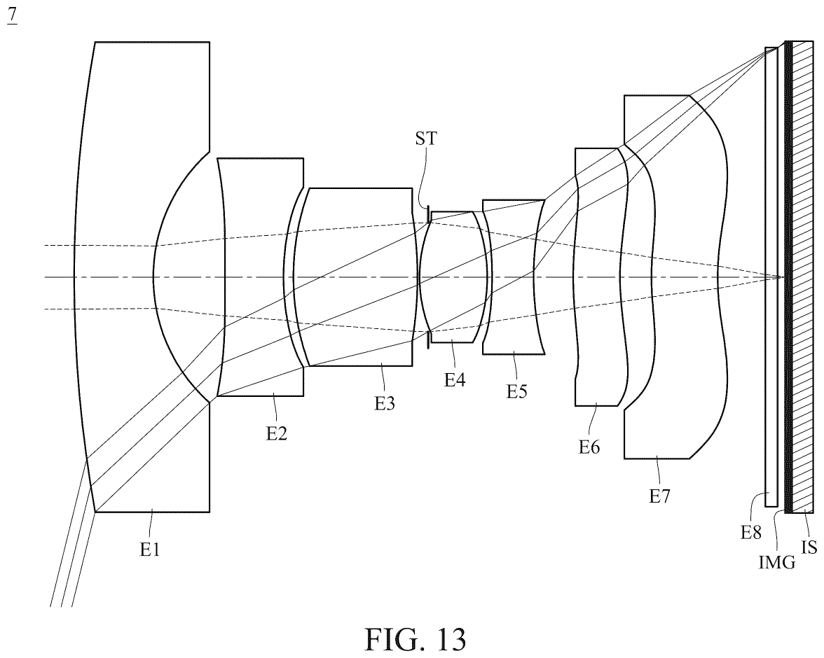

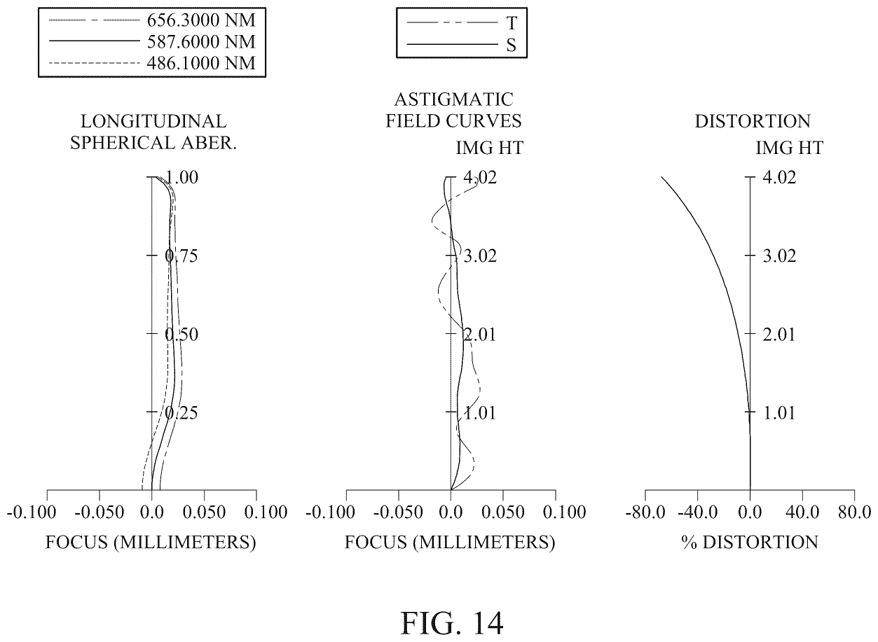

FIG. 13 is a schematic view of an image capturing unit according to the 7th embodiment of the present disclosure. FIG. 14 shows, in order from left to right, spherical aberration curves, astigmatic field curves and a distortion curve of the image capturing unit according to the 7th embodiment. In FIG. 13, the image capturing unit 7 includes the imaging optical lens assembly (its reference numeral is omitted) of the present disclosure and an image sensor IS. The imaging optical lens assembly includes, in order from an object side to an image side along an optical axis, a first lens element E1, a second lens element E2, a third lens element E3, an aperture stop ST, a fourth lens element E4, a fifth lens element E5, a sixth lens element E6, a seventh lens element E7, a filter E8 and an image surface IMG. The imaging optical lens assembly includes seven lens elements (E1, E2, E3, E4, E5, E6 and E7) with no additional lens element disposed between each of the adjacent seven lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being concave in a paraxial region thereof and an image-side surface being concave in a paraxial region thereof. The second lens element E2 is made of plastic material and has the object-side surface and the image-side surface being both aspheric.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The image-side surface of the third lens element E3 has one inflection point.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has one inflection point. The object-side surface of the seventh lens element E7 has one critical point in an off-axis region thereof. The image-side surface of the seventh lens element E7 has one critical point in an off-axis region thereof.

The filter E8 is made of glass material and located between the seventh lens element E7 and the image surface IMG, and will not affect the focal length of the imaging optical lens assembly. The image sensor IS is disposed on or near the image surface IMG of the imaging optical lens assembly.

In this embodiment, each of an Abbe number of the second lens element E2, an Abbe number of the third lens element E3 and an Abbe number of the sixth lens element E6 is smaller than 40.0.

The detailed optical data of the 7th embodiment are shown in Table 7A and the aspheric surface data are shown in Table 7B below.

TABLE 7A
7th Embodiment
f = 3.07 mm, Fno = 2.80, HFOV = 76.2 deg.

| Surface # | | Curvature Radius | | Thickness | Material | Index | Abbe # | Focal Length |
|---|---|---|---|---|---|---|---|---|
| 0 | Object | Infinity | | 1000.000 | | | | |
| 1 | Lens 1 | 22.7631 | (SPH) | 1.351 | Glass | 1.651 | 55.9 | −5.21 |
| 2 | | 2.8819 | (SPH) | 1.229 | | | | |
| 3 | Lens 2 | −178.5714 | (ASP) | 1.000 | Plastic | 1.615 | 25.3 | −6.77 |
| 4 | | 4.2729 | (ASP) | 0.170 | | | | |
| 5 | Lens 3 | 4.4060 | (ASP) | 2.121 | Plastic | 1.615 | 25.3 | 4.66 |
| 6 | | −6.6892 | (ASP) | 0.182 | | | | |
| 7 | Ape. Stop | Plano | | −0.146 | | | | |
| 8 | Lens 4 | 2.4749 | (ASP) | 1.157 | Plastic | 1.544 | 56.0 | 2.64 |
| 9 | | −2.8634 | (ASP) | 0.083 | | | | |
| 10 | Lens 5 | −6.8433 | (ASP) | 0.711 | Plastic | 1.669 | 19.5 | −4.23 |
| 11 | | 5.0325 | (ASP) | 0.677 | | | | |
| 12 | Lens 6 | 5.9750 | (ASP) | 0.800 | Plastic | 1.567 | 37.4 | −28.40 |
| 13 | | 4.1460 | (ASP) | 0.538 | | | | |
| 14 | Lens 7 | 4.4153 | (ASP) | 1.134 | Plastic | 1.614 | 25.6 | 77.35 |
| 15 | | 4.3927 | (ASP) | 0.813 | | | | |

| | | | | | | | |
|---|---|---|---|---|---|---|---|
| 16 | Filter | Plano | 0.210 | Glass | 1.517 | 64.2 | — |
| 17 | | Plano | 0.130 | | | | |
| 18 | Image | Plano | — | | | | |

Note:
Reference wavelength is 587.6 nm (d-line).

TABLE 7B
Aspheric Coefficients

| Surface # | 3 | 4 | 5 | 6 |
|---|---|---|---|---|
| k= | −9.90000E+01 | −6.38028E+00 | 4.80061E−01 | −4.54538E−01 |
| A4= | −5.890717534E−03 | 1.798405109E−02 | 4.839593832E−03 | 3.600124064E−03 |
| A6= | −9.174454880E−03 | −2.025051729E−02 | −1.479059690E−02 | −1.494577627E−02 |
| A8= | 9.167247752E−03 | 1.581078650E−02 | 1.683996484E−02 | 2.656500445E−02 |
| A10= | −4.879314735E−03 | 1.365430791E−02 | −7.860026721E−03 | −2.237076575E−02 |
| A12= | 1.536238374E−03 | −3.388051839E−02 | 1.276617810E−03 | 7.266145064E−03 |
| A14= | −2.434458117E−04 | 2.963381740E−02 | — | — |
| A16= | 2.972184148E−06 | −1.402407783E−02 | — | — |
| A18= | 4.485462855E−06 | 3.514002065E−03 | — | — |
| A20= | −4.381529252E−07 | −3.620972333E−04 | — | — |

| Surface # | 8 | 9 | 10 | 11 |
|---|---|---|---|---|
| k= | −7.85001E−01 | 6.84023E−03 | −9.70613E+01 | −8.95659E+01 |
| A4= | 1.004106569E−02 | −3.911162115E−03 | −8.175997677E−02 | 7.627131458E−02 |
| A6= | 4.264283847E−03 | −5.003719275E−02 | 1.072104904E−01 | −1.103026444E−01 |
| A8= | −2.746761476E−02 | 4.233176836E−01 | −2.785698472E−01 | 1.607686382E−01 |
| A10= | 5.489027170E−02 | −1.732606985E+00 | 5.033542036E−01 | −1.809534497E−01 |
| A12= | −5.020885872E−02 | 4.094261115E+00 | −5.252646399E−01 | 1.518263694E−01 |
| A14= | 1.615754325E−02 | −5.897344755E+00 | 2.747422139E−01 | −8.522035852E−02 |
| A16= | — | 5.212226445E+00 | −5.624471509E−02 | 2.759138297E−02 |
| A18= | — | −2.757075777E+00 | — | −3.819690159E−03 |
| A20= | — | 8.002559394E−01 | — | — |
| A22= | — | −9.781447168E−02 | — | — |

| Surface # | 12 | 13 | 14 | 15 |
|---|---|---|---|---|
| k= | −2.28639E+01 | −4.73962E+01 | −3.44839E+01 | −3.87979E+00 |
| A4= | −2.660214371E−02 | 9.462197466E−04 | −4.310787692E−02 | −1.220229995E−04 |
| A6= | 4.737673580E−02 | −1.399729401E−02 | 1.414983925E−01 | −7.654815651E−03 |
| A8= | −6.103484736E−02 | 2.693251651E−02 | −4.362294410E−01 | −2.243829453E−02 |
| A10= | 4.976712377E−02 | −2.414977739E−02 | 7.296591883E−01 | 3.427937912E−02 |
| A12= | −3.027901150E−02 | 1.164195617E−02 | −7.748977957E−01 | −2.388202262E−02 |
| A14= | 1.351268613E−02 | −3.306914238E−03 | 5.613875309E−01 | 1.029770935E−02 |
| A16= | −4.052769825E−03 | 5.532263898E−04 | −2.870069531E−01 | −3.001265671E−03 |
| A18= | 7.123605086E−04 | −5.041448945E−05 | 1.051076919E−01 | 6.123183557E−04 |
| A20= | −5.586354259E−05 | 1.930439150E−06 | −2.763591608E−02 | −8.846514106E−05 |
| A22= | 2.745690709E−07 | — | 5.165281487E−03 | 9.005469343E−06 |
| A24= | — | — | −6.688405095E−04 | −6.313041979E−07 |
| A26= | — | — | 5.697549335E−05 | 2.898978197E−08 |
| A28= | — | — | −2.869547663E−06 | −7.845447296E−10 |
| A30= | — | — | 6.469879709E−08 | 9.481152425E−12 |

In the 7th embodiment, the equation of the aspheric surface profiles of the aforementioned lens elements is the same as the equation of the 1st embodiment. Also, the definitions of these parameters shown in Table 7C are the same as those stated in the 1st embodiment with corresponding values for the 7th embodiment, so an explanation in this regard will not be provided again.

Moreover, these parameters can be calculated from Table 7A and Table 7B as the following values and satisfy the following conditions:

TABLE 7C
Schematic Parameters

| | | | |
|---|---|---|---|
| f [mm] | 3.07 | f/R3 | −0.02 |
| Fno | 2.80 | f12/f56 | 0.76 |
| HFOV [deg.] | 76.2 | f45/f23 | 0.43 |
| FOV [deg.] | 152.4 | f45/(CT4 + T45 + CT5) | 2.44 |
| TL/ImgH | 3.02 | f2345/(CT2 + T23 + CT3) | 0.96 |
| SL/ImgH | 1.52 | (R3 + R4)/(R3 − R4) | 0.95 |
| SL/TL | 0.50 | R7/f3 | 0.53 |
| TD/f | 3.59 | SL/f4567 | 1.40 |
| BL/f | 0.38 | T12/T56 | 1.82 |
| TL/CT2 | 12.16 | T56/CT5 | 0.95 |
| TL/CT3 | 5.73 | (T34 + CT4)/CT3 | 0.56 |
| TL/R4 | 2.85 | (TL − SL)/f123 | −0.25 |
| ATmax/f | 0.40 | (CT2 + T23 + CT3)/ | 1.69 |
| | | (CT4 + T45 + CT5) | |
| (EPD × SL)/(ImgH × CT4) | 1.44 | V5 | 19.5 |
| f/f56 | −0.90 | V7 | 25.6 |

### 8th Embodiment

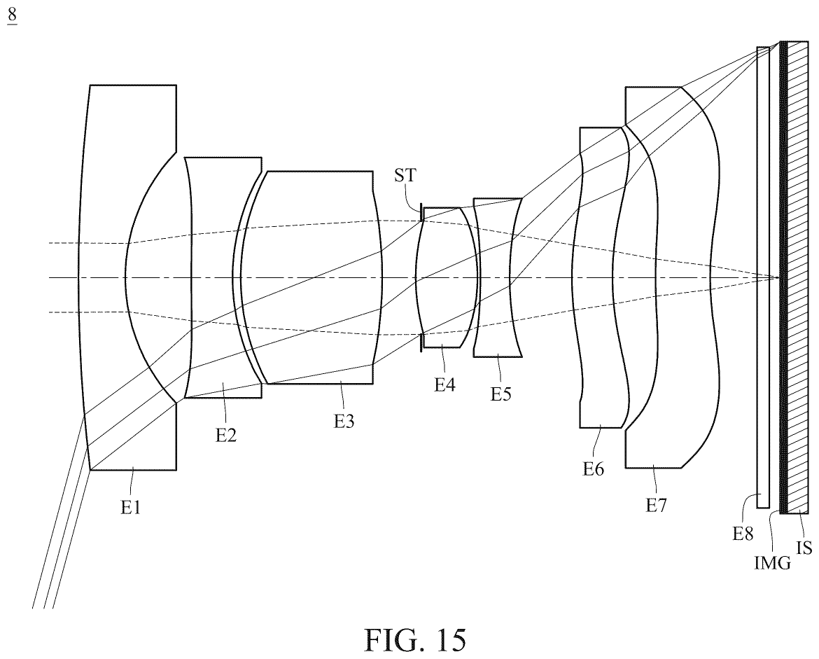

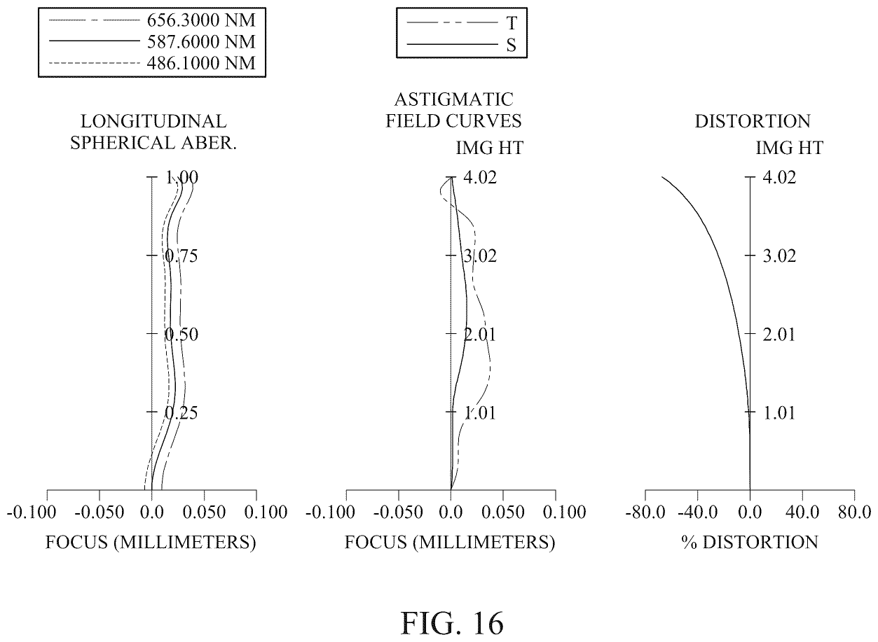

FIG. 15 is a schematic view of an image capturing unit according to the 8th embodiment of the present disclosure. FIG. 16 shows, in order from left to right, spherical aberration curves, astigmatic field curves and a distortion curve of the image capturing unit according to the 8th embodiment. In FIG. 15, the image capturing unit 8 includes the imaging optical lens assembly (its reference numeral is omitted) of the present disclosure and an image sensor IS. The imaging optical lens assembly includes, in order from an object side to an image side along an optical axis, a first lens element E1, a second lens element E2, a third lens element E3, an aperture stop ST, a fourth lens element E4, a fifth lens element E5, a sixth lens element E6, a seventh lens element E7, a filter E8 and an image surface IMG. The imaging optical lens assembly includes seven lens elements (E1, E2, E3, E4, E5, E6 and E7) with no additional lens element disposed between each of the adjacent seven lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The object-side surface of the second lens element E2 has one critical point in an off-axis region thereof.

The third lens element E3 with positive refractive power has an object-side surface being convex in a paraxial region thereof and an image-side surface being convex in a paraxial region thereof. The third lens element E3 is made of glass material and has the object-side surface and the image-side surface being both spherical.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The seventh lens element E7 with negative refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has two inflection points. The object-side surface of the seventh lens element E7 has one critical point in an off-axis region thereof. The image-side surface of the seventh lens element E7 has one critical point in an off-axis region thereof.

The filter E8 is made of glass material and located between the seventh lens element E7 and the image surface IMG, and will not affect the focal length of the imaging optical lens assembly. The image sensor IS is disposed on or near the image surface IMG of the imaging optical lens assembly.

In this embodiment, each of an Abbe number of the second lens element E2 and an Abbe number of the third lens element E3 is smaller than 40.0.

The detailed optical data of the 8th embodiment are shown in Table 8A and the aspheric surface data are shown in Table 8B below.

TABLE 8A
8th Embodiment
f = 3.31 mm, Fno = 2.80, HFOV = 74.9 deg.

| Surface # | | Curvature Radius | | Thickness | Material | Index | Abbe # | Focal Length |
|---|---|---|---|---|---|---|---|---|
| 0 | Object | Infinity | | 1000.000 | | | | |
| 1 | Lens 1 | 27.0651 | (SPH) | 0.800 | Glass | 1.804 | 46.5 | −4.38 |
| 2 | | 3.0755 | (SPH) | 1.127 | | | | |
| 3 | Lens 2 | 32.1076 | (ASP) | 0.704 | Plastic | 1.660 | 20.4 | −6.03 |
| 4 | | 3.5106 | (ASP) | 0.138 | | | | |
| 5 | Lens 3 | 3.8134 | (SPH) | 2.417 | Glass | 1.805 | 25.5 | 3.40 |
| 6 | | −6.9531 | (SPH) | 0.663 | | | | |
| 7 | Ape. Stop | Plano | | −0.091 | | | | |
| 8 | Lens 4 | 3.3826 | (ASP) | 1.054 | Plastic | 1.544 | 56.0 | 3.01 |
| 9 | | −2.8335 | (ASP) | 0.050 | | | | |
| 10 | Lens 5 | −9.2802 | (ASP) | 0.500 | Plastic | 1.669 | 19.5 | −4.85 |
| 11 | | 5.1051 | (ASP) | 1.062 | | | | |
| 12 | Lens 6 | 4.8693 | (ASP) | 0.693 | Plastic | 1.544 | 56.0 | 298.28 |
| 13 | | 4.7682 | (ASP) | 0.736 | | | | |
| 14 | Lens 7 | 10.6530 | (ASP) | 0.933 | Plastic | 1.660 | 20.4 | −19.13 |
| 15 | | 5.5763 | (ASP) | 0.800 | | | | |

| | | | | | | | |
|---|---|---|---|---|---|---|---|
| 16 | Filter | Plano | 0.210 | Glass | 1.517 | 64.2 | — |
| 17 | | Plano | 0.183 | | | | |
| 18 | Image | Plano | — | | | | |

Note:
Reference wavelength is 587.6 nm (d-line).

TABLE 8B
Aspheric Coefficients

| Surface # | 3 | 4 | 8 | 9 |
|---|---|---|---|---|
| k= | 8.36334E+01 | −5.00991E+00 | −5.35436E+00 | −9.39380E−01 |
| A4= | −8.667974587E−03 | 1.094839434E−02 | 1.368813872E−02 | 3.705127758E−03 |
| A6= | −6.650635443E−03 | −6.206825894E−04 | −1.052086782E−03 | −1.074323183E−01 |
| A8= | 9.047184883E−03 | −1.111028068E−03 | −1.695132127E−02 | 6.663642961E−01 |
| A10= | −6.961352770E−03 | 2.330095102E−03 | 1.958254602E−02 | −2.252677411E+00 |
| A12= | 3.290708734E−03 | −1.961092761E−03 | −1.537967179E−02 | 4.441532687E+00 |
| A14= | −9.665359154E−04 | 9.344974089E−04 | 3.459597937E−03 | −5.467399925E+00 |
| A16= | 1.705468182E−04 | −2.618445719E−04 | — | 4.245225529E+00 |
| A18= | −1.637366383E−05 | 4.086584939E−05 | — | −2.020230067E+00 |
| A20= | 6.468706970E−07 | −2.772965330E−06 | — | 5.372315268E−01 |
| A22= | — | — | — | −6.088593646E−02 |
| Surface # | 10 | 11 | 12 | 13 |
| k= | −9.74871E+01 | −9.00000E+01 | −1.32994E+00 | −3.20756E+00 |
| A4= | −4.291792833E−02 | 6.992532607E−02 | −1.469478337E−02 | 9.307641959E−03 |
| A6= | 8.585089971E−02 | −8.544473192E−02 | 1.665646000E−02 | −1.514160223E−02 |
| A8= | −1.659813405E−01 | 1.262360681E−01 | −3.139601087E−02 | 9.418982936E−03 |
| A10= | 2.012134292E−01 | −1.340279675E−01 | 3.123599688E−02 | −4.218756597E−03 |
| A12= | −1.480363033E−01 | 9.850598941E−02 | −1.950609974E−02 | 1.258481544E−03 |
| A14= | 5.512913042E−02 | −4.745934505E−02 | 7.923331635E−03 | −2.421034447E−04 |
| A16= | −7.466727072E−03 | 1.328015630E−02 | −2.084039846E−03 | 2.865644145E−05 |
| A18= | — | −1.607238084E−03 | 3.415155584E−04 | −1.900695579E−06 |
| A20= | — | — | −3.163456728E−05 | 5.411190503E−08 |
| A22= | — | — | 1.261769099E−06 | — |

| Surface # | 14 | 15 |
|---|---|---|
| k= | −6.07116E+01 | −1.39253E+01 |
| A4= | 4.976704400E−03 | 2.614505631E−02 |
| A6= | −2.016761873E−03 | −3.586321362E−02 |
| A8= | −4.549995929E−02 | 1.763668675E−02 |
| A10= | 7.222274834E−02 | −4.871224242E−03 |
| A12= | −6.009237999E−02 | 6.409235237E−04 |
| A14= | 3.234782972E−02 | 3.336795838E−05 |
| A16= | −1.204364772E−02 | −2.939321004E−05 |
| A18= | 3.184208606E−03 | 5.406368389E−06 |
| A20= | −6.018911735E−04 | −4.965327958E−07 |
| A22= | 8.067965918E−05 | 1.849395927E−08 |
| A24= | −7.479184438E−06 | 7.242806081E−10 |
| A26= | 4.554406305E−07 | −1.090019553E−10 |
| A28= | −1.637566863E−08 | 4.508674474E−12 |
| A30= | 2.632975341E−10 | −6.779488384E−14 |

In the 8th embodiment, the equation of the aspheric surface profiles of the aforementioned lens elements is the same as the equation of the 1st embodiment. Also, the definitions of these parameters shown in Table 8C are the same as those stated in the 1st embodiment with corresponding values for the 8th embodiment, so an explanation in this regard will not be provided again.

Moreover, these parameters can be calculated from Table 8A and Table 8B as the following values and satisfy the following conditions:

TABLE 8C
Schematic Parameters

| | | | |
|---|---|---|---|
| f [mm] | 3.31 | f/R3 | 0.10 |
| Fno | 2.80 | f12/f56 | 0.47 |
| HFOV [deg.] | 74.9 | f45/f23 | 0.96 |
| FOV [deg.] | 149.9 | f45/(CT4 + T45 + CT5) | 3.78 |
| TL/ImgH | 2.98 | f2345/(CT2 + T23 + CT3) | 1.00 |
| SL/ImgH | 1.52 | (R3 + R4)/(R3 − R4) | 1.25 |
| SL/TL | 0.51 | R7/f3 | 1.00 |
| TD/f | 3.26 | SL/f4567 | 1.02 |
| BL/f | 0.36 | T12/T56 | 1.06 |
| TL/CT2 | 17.02 | T56/CT5 | 2.12 |
| TL/CT3 | 4.96 | (T34 + CT4)/CT3 | 0.67 |
| TL/R4 | 3.41 | (TL − SL)/f123 | 0.16 |
| ATmax/f | 0.34 | (CT2 + T23 + CT3)/ | 2.03 |
| | | (CT4 + T45 + CT5) | |
| (EPD × SL)/(ImgH × CT4) | 1.72 | V5 | 19.5 |
| f/f56 | −0.70 | V7 | 20.4 |

### 9th Embodiment

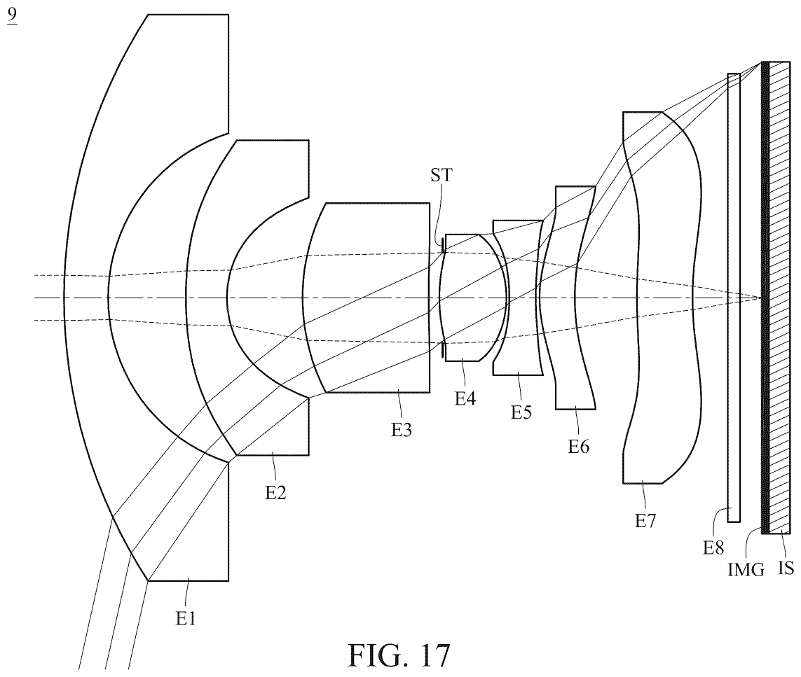

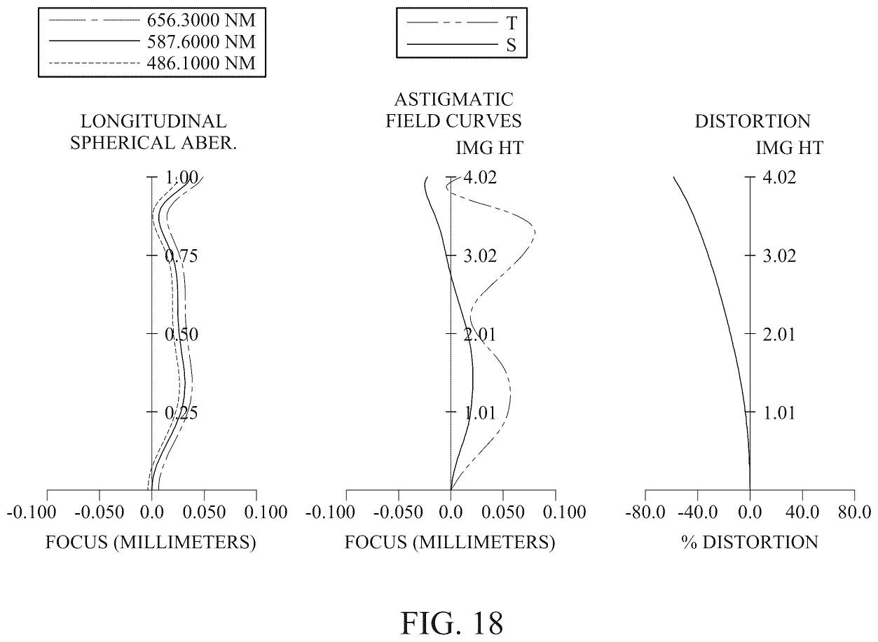

FIG. 17 is a schematic view of an image capturing unit according to the 9th embodiment of the present disclosure. FIG. 18 shows, in order from left to right, spherical aberration curves, astigmatic field curves and a distortion curve of the image capturing unit according to the 9th embodiment. In FIG. 17, the image capturing unit 9 includes the imaging optical lens assembly (its reference numeral is omitted) of the present disclosure and an image sensor IS. The imaging optical lens assembly includes, in order from an object side to an image side along an optical axis, a first lens element E1, a second lens element E2, a third lens element E3, an aperture stop ST, a fourth lens element E4, a fifth lens element E5, a sixth lens element E6, a seventh lens element E7, a filter E8 and an image surface IMG. The imaging optical lens assembly includes seven lens elements (E1, E2, E3, E4, E5, E6 and E7) with no additional lens element disposed between each of the adjacent seven lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point.

The third lens element E3 with positive refractive power has an object-side surface being convex in a paraxial region thereof and an image-side surface being concave in a paraxial region thereof. The third lens element E3 is made of glass material and has the object-side surface and the image-side surface being both spherical.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point. The object-side surface of the sixth lens element E6 has one critical point in an off-axis region thereof.

The seventh lens element E7 with negative refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has one inflection point. The object-side surface of the seventh lens element E7 has one critical point in an off-axis region thereof. The image-side surface of the seventh lens element E7 has one critical point in an off-axis region thereof.

The filter E8 is made of glass material and located between the seventh lens element E7 and the image surface IMG, and will not affect the focal length of the imaging optical lens assembly. The image sensor IS is disposed on or near the image surface IMG of the imaging optical lens assembly.

In this embodiment, each of an Abbe number of the third lens element E3 and an Abbe number of the sixth lens element E6 is smaller than 40.0.

The detailed optical data of the 9th embodiment are shown in Table 9A and the aspheric surface data are shown in Table 9B below.

TABLE 9A
9th Embodiment
f = 2.16 mm, Fno = 2.80, HFOV = 77.5 deg.

| Surface # | | Curvature Radius | | Thickness | Material | Index | Abbe # | Focal Length |
|---|---|---|---|---|---|---|---|---|
| 0 | Object | Infinity | | 1000.000 | | | | |
| 1 | Lens 1 | 8.8608 | (SPH) | 0.750 | Glass | 1.804 | 46.5 | −5.82 |
| 2 | | 2.9470 | (SPH) | 1.325 | | | | |
| 3 | Lens 2 | 6.4312 | (ASP) | 0.700 | Plastic | 1.544 | 56.0 | −4.58 |
| 4 | | 1.7261 | (ASP) | 1.287 | | | | |
| 5 | Lens 3 | 3.4675 | (SPH) | 2.150 | Glass | 1.728 | 28.3 | 5.23 |
| 6 | | 28.5714 | (SPH) | 0.236 | | | | |
| 7 | Ape. Stop | Plano | | −0.055 | | | | |
| 8 | Lens 4 | 2.8262 | (ASP) | 1.142 | Plastic | 1.544 | 56.0 | 2.11 |
| 9 | | −1.6532 | (ASP) | 0.050 | | | | |
| 10 | Lens 5 | −3.1918 | (ASP) | 0.450 | Plastic | 1.669 | 19.5 | −2.78 |
| 11 | | 4.6933 | (ASP) | 0.065 | | | | |
| 12 | Lens 6 | 2.1225 | (ASP) | 0.600 | Plastic | 1.587 | 28.3 | 7.30 |
| 13 | | 3.7660 | (ASP) | 1.059 | | | | |
| 14 | Lens 7 | 9.5347 | (ASP) | 0.947 | Plastic | 1.544 | 56.0 | −24.92 |
| 15 | | 5.4019 | (ASP) | 0.600 | | | | |

| | | | | | | | |
|---|---|---|---|---|---|---|---|
| 16 | Filter | Plano | 0.210 | Glass | 1.517 | 64.2 | — |
| 17 | | Plano | 0.371 | | | | |
| 18 | Image | Plano | — | | | | |

Note:
Reference wavelength is 587.6 nm (d-line).

TABLE 9B
Aspheric Coefficients

| Surface # | 3 | 4 | 8 | 9 |
|---|---|---|---|---|
| k= | 0.00000E+00 | −7.29104E−01 | 0.00000E+00 | −3.73710E−01 |
| A4= | 1.589230994E−02 | 4.530324047E−02 | −1.795326588E−02 | 7.922773018E−02 |
| A6= | −4.538309052E−03 | −1.547189168E−02 | 1.340952978E−01 | −9.526858516E−01 |
| A8= | 1.178315254E−03 | 2.671438825E−02 | −1.348476727E+00 | 4.859247974E+00 |
| A10= | −2.012351994E−04 | −2.412392140E−02 | 6.916272183E+00 | −1.626351303E+01 |
| A12= | 1.886407711E−05 | 1.293866972E−02 | −2.249686582E+01 | 3.589650252E+01 |
| A14= | −7.517280622E−07 | −2.972236250E−03 | 4.638458129E+01 | −5.241328390E+01 |
| A16= | — | −2.723048162E−04 | −5.894342354E+01 | 4.975534269E+01 |
| A18= | — | 2.652546375E−04 | 4.176390793E+01 | −2.939164143E+01 |
| A20= | — | −3.622551328E−05 | −1.256133680E+01 | 9.762459056E+00 |
| A22= | — | — | — | −1.384265625E+00 |

| Surface # | 10 | 11 | 12 | 13 |
|---|---|---|---|---|
| k= | 9.51177E−02 | −9.00000E+01 | −4.00684E+00 | −2.21672E+00 |
| A4= | 8.604772095E−03 | 3.310350273E−03 | −8.655787573E−02 | 7.025189408E−03 |
| A6= | −3.946352108E−01 | −9.954491938E−02 | 1.163826662E−01 | −8.585911237E−03 |
| A8= | 1.264673259E+00 | 2.989421062E−01 | −1.089253554E−01 | 5.231279863E−03 |
| A10= | −2.473138496E+00 | −4.356690386E−01 | 6.114592911E−02 | −3.289709308E−03 |
| A12= | 3.107895324E+00 | 3.828913037E−01 | −1.477971531E−02 | 1.320286276E−03 |
| A14= | −2.550605344E+00 | −2.024957438E−01 | −4.699055793E−03 | −3.281275961E−04 |
| A16= | 1.324676435E+00 | 5.918595567E−02 | 4.509406675E−03 | 4.871927640E−05 |
| A18= | −4.022854010E−01 | −7.303977940E−03 | −1.196191594E−03 | −3.886558727E−06 |
| A20= | 5.807531655E−02 | — | 8.772841585E−05 | 1.254095267E−07 |
| A22= | — | — | 6.440938754E−06 | — |

| Surface # | 14 | 15 |
|---|---|---|
| k= | 3.24972E+00 | −3.16959E+01 |
| A4= | −1.435863042E−02 | 2.066960955E−02 |
| A6= | −8.326494031E−03 | −2.492321278E−02 |
| A8= | 1.386151484E−03 | 1.255954353E−02 |
| A10= | 3.782335545E−03 | −4.422244797E−03 |
| A12= | −3.440177182E−03 | 1.165079520E−03 |
| A14= | 1.571237496E−03 | −2.365672911E−04 |
| A16= | −4.615628901E−04 | 3.752486827E−05 |
| A18= | 9.326414427E−05 | −4.677590697E−06 |
| A20= | −1.312943129E−05 | 4.530884788E−07 |
| A22= | 1.264873906E−06 | −3.276508521E−08 |
| A24= | −7.940329444E−08 | 1.638616281E−09 |
| A26= | 2.922979534E−09 | −4.963236048E−11 |
| A28= | −4.782874354E−11 | 6.757933835E−13 |

In the 9th embodiment, the equation of the aspheric surface profiles of the aforementioned lens elements is the same as the equation of the 1st embodiment. Also, the definitions of these parameters shown in Table 9C are the same as those stated in the 1st embodiment with corresponding values for the 9th embodiment, so an explanation in this regard will not be provided again.

Moreover, these parameters can be calculated from Table 9A and Table 9B as the following values and satisfy the following conditions:

TABLE 9C
Schematic Parameters

| | | | |
|---|---|---|---|
| f [mm] | 2.16 | f/R3 | 0.34 |
| Fno | 2.80 | f12/f56 | 0.51 |
| HFOV [deg.] | 77.5 | f45/f23 | 0.06 |
| FOV [deg.] | 154.9 | f45/(CT4 + T45 + CT5) | 3.16 |
| TL/ImgH | 2.95 | f2345/(CT2 + T23 + CT3) | 1.00 |
| SL/ImgH | 1.35 | (R3 + R4)/(R3 − R4) | 1.73 |
| SL/TL | 0.46 | R7/f3 | 0.54 |
| TD/f | 4.95 | SL/f4567 | 1.71 |
| BL/f | 0.55 | T12/T56 | 20.38 |
| TL/CT2 | 16.98 | T56/CT5 | 0.14 |
| TL/CT3 | 5.53 | (T34 + CT4)/CT3 | 0.62 |
| TL/R4 | 6.89 | (TL − SL)/f123 | −0.81 |
| ATmax/f | 0.61 | (CT2 + T23 + CT3)/ | 2.52 |
| | | (CT4 + T45 + CT5) | |
| (EPD × SL)/(ImgH × CT4) | 0.92 | V5 | 19.5 |
| f/f56 | −0.50 | V7 | 56.0 |

### 10th Embodiment

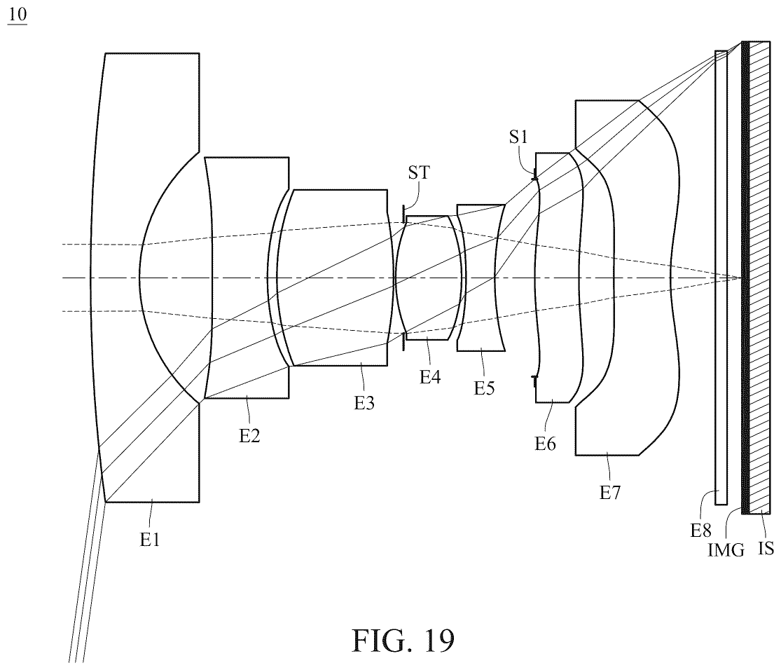

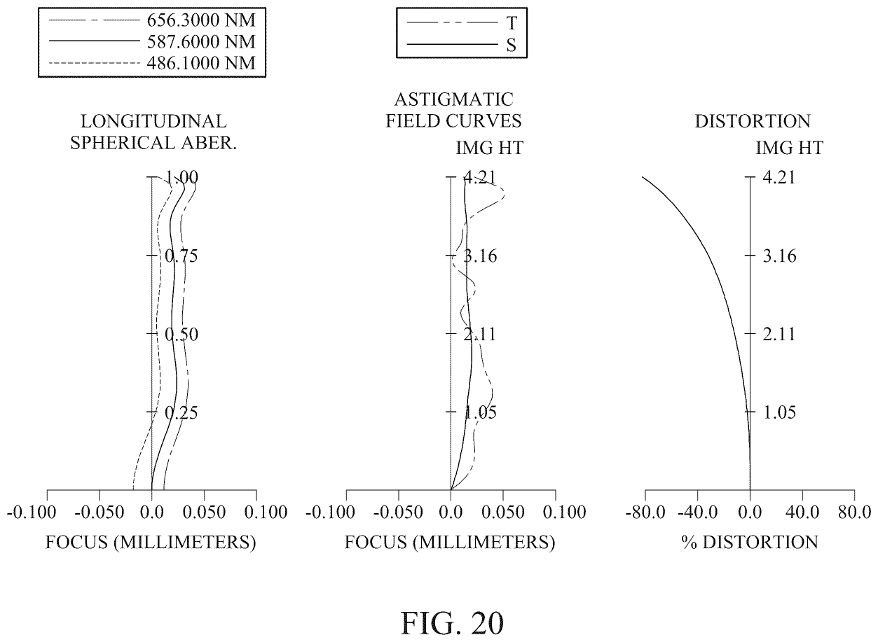

FIG. 19 is a schematic view of an image capturing unit according to the 10th embodiment of the present disclosure. FIG. 20 shows, in order from left to right, spherical aberration curves, astigmatic field curves and a distortion curve of the image capturing unit according to the 10th embodiment. In FIG. 19, the image capturing unit 10 includes the imaging optical lens assembly (its reference numeral is omitted) of the present disclosure and an image sensor IS. The imaging optical lens assembly includes, in order from an object side to an image side along an optical axis, a first lens element E1, a second lens element E2, a third lens element E3, an aperture stop ST, a fourth lens element E4, a fifth lens element E5, a stop S1, a sixth lens element E6, a seventh lens element E7, a filter E8 and an image surface IMG. The imaging optical lens assembly includes seven lens elements (E1, E2, E3, E4, E5, E6 and E7) with no additional lens element disposed between each of the adjacent seven lens elements.

The first lens element E1 with negative refractive power has an object-side surface being convex in a paraxial region thereof and an image-side surface being concave in a paraxial region thereof. The first lens element E1 is made of plastic material and has the object-side surface and the image-side surface being both aspheric.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has two inflection points. The object-side surface of the second lens element E2 has one critical point in an off-axis region thereof.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The seventh lens element E7 with negative refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has one inflection point. The object-side surface of the seventh lens element E7 has one critical point in an off-axis region thereof. The image-side surface of the seventh lens element E7 has one critical point in an off-axis region thereof.

The filter E8 is made of glass material and located between the seventh lens element E7 and the image surface IMG, and will not affect the focal length of the imaging optical lens assembly. The image sensor IS is disposed on or near the image surface IMG of the imaging optical lens assembly.

In this embodiment, each of an Abbe number of the second lens element E2 and an Abbe number of the third lens element E3 is smaller than 40.0.

The detailed optical data of the 10th embodiment are shown in Table 10A and the aspheric surface data are shown in Table 10B below.

TABLE 10A
10th Embodiment
f = 3.35 mm, Fno = 2.80, HFOV = 82.1 deg.

| Surface # | | Curvature Radius | | Thickness | Material | Index | Abbe # | Focal Length |
|---|---|---|---|---|---|---|---|---|
| 0 | Object | Infinity | | 1000.000 | | | | |
| 1 | Lens 1 | 31.8841 | (ASP) | 0.873 | Plastic | 1.544 | 56.0 | −5.84 |
| 2 | | 2.8632 | (ASP) | 1.302 | | | | |
| 3 | Lens 2 | 251.6066 | (ASP) | 0.987 | Plastic | 1.639 | 23.5 | −6.67 |
| 4 | | 4.1824 | (ASP) | 0.169 | | | | |
| 5 | Lens 3 | 4.2653 | (ASP) | 2.086 | Plastic | 1.615 | 25.3 | 4.42 |
| 6 | | −6.0971 | (ASP) | 0.178 | | | | |
| 7 | Ape. Stop | Plano | | −0.139 | | | | |
| 8 | Lens 4 | 2.6772 | (ASP) | 1.179 | Plastic | 1.544 | 56.0 | 2.73 |
| 9 | | −2.8233 | (ASP) | 0.078 | | | | |
| 10 | Lens 5 | −6.5319 | (ASP) | 0.515 | Plastic | 1.656 | 21.3 | −4.18 |
| 11 | | 4.8711 | (ASP) | 0.715 | | | | |
| 12 | Stop | Plano | | 0.000 | | | | |
| 13 | Lens 6 | 6.3128 | (ASP) | 0.789 | Plastic | 1.544 | 56.0 | 32.12 |
| 14 | | 9.4487 | (ASP) | 0.625 | | | | |
| 15 | Lens 7 | 16.0608 | (ASP) | 1.013 | Plastic | 1.566 | 37.4 | −10.39 |
| 16 | | 4.2075 | (ASP) | 0.802 | | | | |

| | | | | | | | |
|---|---|---|---|---|---|---|---|
| 17 | Filter | Plano | 0.210 | Glass | 1.517 | 64.2 | — |
| 18 | | Plano | 0.266 | | | | |
| 19 | Image | Plano | — | | | | |

Note:
Reference wavelength is 587.6 nm (d-line).
An effective radius of the stop S1 (Surface 12) is 1.765 mm.

TABLE 10B
Aspheric Coefficients

| Surface # | 1 | 2 | 3 | 4 |
|---|---|---|---|---|
| k= | 1.00405E+01 | −5.68855E−02 | 9.90000E+01 | −5.92881E+00 |
| A4= | −3.153668064E−05 | −1.862296594E−03 | −1.300014652E−02 | 7.170564917E−03 |
| A6= | 1.875961711E−05 | 3.262823379E−03 | 3.901862788E−03 | 7.186585223E−03 |
| A8= | −2.551099351E−06 | −2.344135127E−03 | −3.172071377E−03 | 5.680198139E−03 |
| A10= | 1.326773316E−07 | 9.297263441E−04 | 2.047246354E−03 | −2.122879929E−02 |
| A12= | −2.394990643E−09 | −2.180084234E−04 | −8.085021425E−04 | 2.687430390E−02 |
| A14= | — | 2.810463974E−05 | 1.984792330E−04 | −1.914773438E−02 |
| A16= | — | −1.527829584E−06 | −2.956055332E−05 | 8.060796113E−03 |
| A18= | — | — | 2.434383582E−06 | −1.852426819E−03 |
| A20= | — | — | −8.374732231E−08 | 1.790812241E−04 |

| Surface # | 5 | 6 | 8 | 9 |
|---|---|---|---|---|
| k= | 2.68829E−01 | −2.69030E−01 | −7.81896E−01 | −6.07268E−02 |
| A4= | −3.005841620E−03 | 2.783705587E−03 | 9.882079190E−03 | −5.427349967E−03 |
| A6= | 8.168399897E−03 | −5.766262333E−03 | 1.160624043E−02 | −5.834601427E−02 |
| A8= | −6.607749210E−03 | 4.651059464E−03 | −5.284688046E−02 | 4.598305184E−01 |
| A10= | 1.799103479E−03 | −1.809608029E−03 | 8.761127933E−02 | −1.461722759E+00 |
| A12= | 6.214752952E−05 | 2.735256714E−04 | −6.955673856E−02 | 2.631266621E+00 |
| A14= | −6.773334271E−05 | — | 2.005240899E−02 | −2.999536593E+00 |
| A16= | 6.949531131E−17 | — | — | 2.201494344E+00 |
| A18= | — | — | — | −1.012120093E+00 |
| A20= | — | — | — | 2.662115967E−01 |
| A22= | — | — | — | −3.065528117E−02 |

| Surface # | 10 | 11 | 13 | 14 |
|---|---|---|---|---|
| k= | −9.79719E+01 | −9.01155E+01 | −1.80400E+01 | −4.36948E+01 |
| A4= | −9.337939415E−02 | 7.520831511E−02 | −1.452410055E−02 | −7.513052378E−04 |
| A6= | 1.134586813E−01 | −1.274060117E−01 | 2.706287240E−02 | 8.475926451E−03 |
| A8= | −1.281831013E−01 | 2.426363536E−01 | −5.517262957E−02 | −1.579506206E−02 |
| A10= | 7.343667290E−02 | −3.246771680E−01 | 5.979348714E−02 | 1.071747821E−02 |
| A12= | −2.303693819E−02 | 2.821738412E−01 | −3.881650068E−02 | −3.981893868E−03 |
| A14= | 3.324344131E−05 | −1.504908779E−01 | 1.488223272E−02 | 8.041254254E−04 |
| A16= | 1.660122113E−03 | 4.456874135E−02 | −3.036662490E−03 | −7.793931695E−05 |
| A18= | — | −5.588641650E−03 | 1.775950714E−04 | 1.687036201E−06 |
| A20= | — | — | 4.086404190E−05 | 1.549315487E−07 |
| A22= | — | — | −5.870370819E−06 | — |

| Surface # | 15 | 16 |
|---|---|---|
| k= | −9.60493E+01 | −6.23295E+00 |
| A4= | −5.412450274E−02 | −1.773648499E−02 |
| A6= | 1.481410509E−01 | 1.034987459E−02 |
| A8= | −4.060214098E−01 | −2.636756145E−02 |
| A10= | 6.768254427E−01 | 2.927186536E−02 |
| A12= | −7.415633329E−01 | −1.851961816E−02 |
| A14= | 5.603424620E−01 | 7.579396007E−03 |
| A16= | −3.000850498E−01 | −2.127736270E−03 |
| A18= | 1.153946025E−01 | 4.213567877E−04 |
| A20= | −3.190949731E−02 | −5.943301857E−05 |
| A22= | 6.279095401E−03 | 5.937433386E−06 |
| A24= | −8.565510537E−04 | −4.104612529E−07 |
| A26= | 7.688995153E−05 | 1.867215573E−08 |
| A28= | −4.080995516E−06 | −5.027268741E−10 |
| A30= | 9.695609304E−08 | 6.068286959E−12 |

In the 10th embodiment, the equation of the aspheric surface profiles of the aforementioned lens elements is the same as the equation of the 1st embodiment. Also, the definitions of these parameters shown in Table 10C are the same as those stated in the 1st embodiment with corresponding values for the 10th embodiment, so an explanation in this regard will not be provided again.

Moreover, these parameters can be calculated from Table 10A and Table 10B as the following values and satisfy the following conditions:

TABLE 10C
Schematic Parameters

| | | | |
|---|---|---|---|
| f [mm] | 3.35 | f/R3 | 0.01 |
| Fno | 2.80 | f12/f56 | 0.57 |
| HFOV [deg.] | 82.1 | f45/f23 | 0.54 |
| FOV [deg.] | 164.2 | f45/(CT4 + T45 + CT5) | 3.03 |
| TL/ImgH | 2.77 | f2345/(CT2 + T23 + CT3) | 1.03 |
| SL/ImgH | 1.44 | (R3 + R4)/(R3 − R4) | 1.03 |
| SL/TL | 0.52 | R7/f3 | 0.61 |
| TD/f | 3.10 | SL/f4567 | 1.18 |
| BL/f | 0.38 | T12/T56 | 1.82 |
| TL/CT2 | 11.80 | T56/CT5 | 1.39 |
| TL/CT3 | 5.58 | (T34 + CT4)/CT3 | 0.58 |
| TL/R4 | 2.79 | (TL − SL)/f123 | −0.05 |
| ATmax/f | 0.39 | (CT2 + T23 + CT3)/ | 1.83 |
| | | (CT4 + T45 + CT5) | |
| (EPD × SL)/(ImgH × CT4) | 1.46 | V5 | 21.3 |
| f/f56 | −0.70 | V7 | 37.4 |

### 11th Embodiment

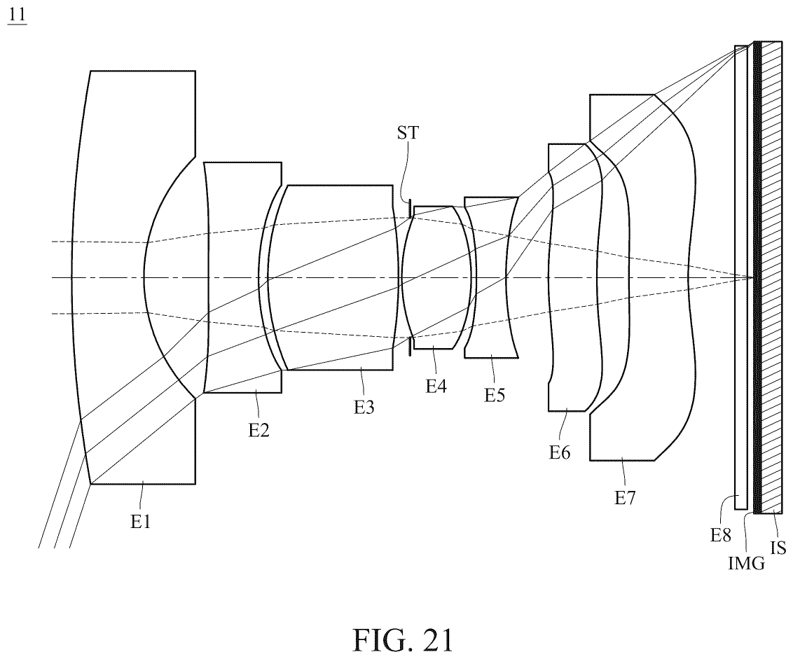

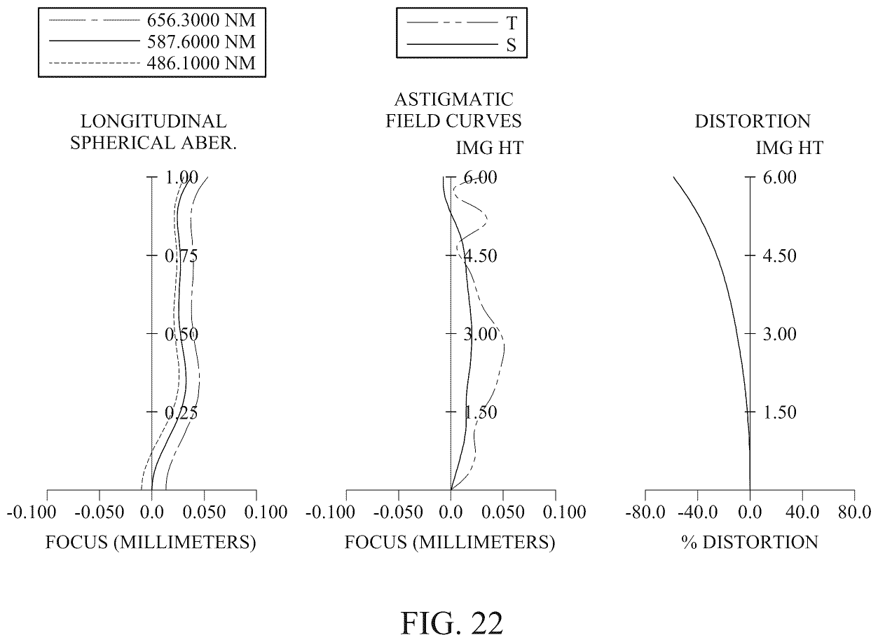

FIG. 21 is a schematic view of an image capturing unit according to the 11th embodiment of the present disclosure. FIG. 22 shows, in order from left to right, spherical aberration curves, astigmatic field curves and a distortion curve of the image capturing unit according to the 11th embodiment. In FIG. 21, the image capturing unit 11 includes the imaging optical lens assembly (its reference numeral is omitted) of the present disclosure and an image sensor IS. The imaging optical lens assembly includes, in order from an object side to an image side along an optical axis, a first lens element E1, a second lens element E2, a third lens element E3, an aperture stop ST, a fourth lens element E4, a fifth lens element E5, a sixth lens element E6, a seventh lens element E7, a filter E8 and an image surface IMG. The imaging optical lens assembly includes seven lens elements (E1, E2, E3, E4, E5, E6 and E7) with no additional lens element disposed between each of the adjacent seven lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both aspheric.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The object-side surface of the second lens element E2 has one critical point in an off-axis region thereof.

The third lens element E3 with positive refractive power has an object-side surface being convex in a paraxial region thereof and an image-side surface being convex in a paraxial region thereof. The third lens element E3 is made of glass material and has the object-side surface and the image-side surface being both aspheric.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The seventh lens element E7 with negative refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has two inflection points. The object-side surface of the seventh lens element E7 has one critical point in an off-axis region thereof. The image-side surface of the seventh lens element E7 has one critical point in an off-axis region thereof.

The filter E8 is made of glass material and located between the seventh lens element E7 and the image surface IMG, and will not affect the focal length of the imaging optical lens assembly. The image sensor IS is disposed on or near the image surface IMG of the imaging optical lens assembly.

In this embodiment, each of an Abbe number of the second lens element E2 and an Abbe number of the third lens element E3 is smaller than 40.0.

The detailed optical data of the 11th embodiment are shown in Table 11A and the aspheric surface data are shown in Table 11B below.

TABLE 11A
11th Embodiment
f = 4.77 mm, Fno = 2.60, HFOV = 71.8 deg.

| Surface # | | Curvature Radius | | Thickness | Material | Index | Abbe # | Focal Length |
|---|---|---|---|---|---|---|---|---|
| 0 | Object | Infinity | | 1000.000 | | | | |
| 1 | Lens 1 | 29.0732 | (ASP) | 1.834 | Glass | 1.804 | 46.5 | −6.33 |
| 2 | | 4.2093 | (ASP) | 1.639 | | | | |
| 3 | Lens 2 | 60.3412 | (ASP) | 1.274 | Plastic | 1.660 | 20.4 | −9.98 |
| 4 | | 5.8891 | (ASP) | 0.236 | | | | |
| 5 | Lens 3 | 5.7036 | (ASP) | 3.320 | Glass | 1.803 | 25.5 | 5.14 |
| 6 | | −11.0910 | (ASP) | 0.293 | | | | |
| 7 | Ape. Stop | Plano | | −0.208 | | | | |
| 8 | Lens 4 | 4.2442 | (ASP) | 1.763 | Plastic | 1.544 | 56.0 | 4.16 |
| 9 | | −4.1316 | (ASP) | 0.133 | | | | |
| 10 | Lens 5 | −9.6755 | (ASP) | 0.750 | Plastic | 1.669 | 19.5 | −5.99 |
| 11 | | 7.0598 | (ASP) | 1.079 | | | | |
| 12 | Lens 6 | 9.1757 | (ASP) | 1.231 | Plastic | 1.544 | 56.0 | 64.96 |
| 13 | | 11.8078 | (ASP) | 0.815 | | | | |
| 14 | Lens 7 | 22.4640 | (ASP) | 1.506 | Plastic | 1.614 | 25.6 | −17.20 |
| 15 | | 6.9977 | (ASP) | 1.188 | | | | |

| | | | | | | | |
|---|---|---|---|---|---|---|---|
| 16 | Filter | Plano | 0.315 | Glass | 1.517 | 64.2 | — |
| 17 | | Plano | 0.170 | | | | |
| 18 | Image | Plano | — | | | | |

Note:
Reference wavelength is 587.6 nm (d-line).

TABLE 11B
Aspheric Coefficients

| Surface # | 1 | 2 | 3 | 4 |
|---|---|---|---|---|
| k= | 7.99605E−02 | −7.60642E−02 | −4.86841E+01 | −5.59188E+00 |
| A4= | −1.070595059E−05 | −5.394384508E−04 | −4.643543187E−03 | 1.493880742E−03 |
| A6= | 4.550308070E−06 | 3.235159880E−04 | 1.204221094E−03 | 4.305793713E−03 |
| A8= | −2.441631567E−07 | −8.136001136E−05 | −6.716632185E−04 | −3.618875132E−03 |
| A10= | 2.994048273E−09 | 9.232947828E−06 | 2.242601170E−04 | 1.707952006E−03 |
| A12= | 1.460217230E−11 | −3.914365679E−07 | −4.293257309E−05 | −4.757754425E−04 |
| A14= | — | — | 4.913646460E−06 | 8.532940293E−05 |
| A16= | — | — | −3.314042450E−07 | −1.030982903E−05 |
| A18= | — | — | 1.203847457E−08 | 8.077104057E−07 |
| A20= | — | — | −1.782548033E−10 | −3.080376632E−08 |

| Surface # | 5 | 6 | 8 | 9 |
|---|---|---|---|---|
| k= | 6.79773E−02 | 1.40218E−01 | −8.57162E−01 | −2.20213E−01 |
| A4= | −9.056872701E−04 | 1.439343607E−03 | 4.363219893E−03 | 2.962970771E−04 |
| A6= | 2.212373233E−03 | −2.420146880E−03 | −2.013483754E−03 | −1.014784016E−02 |
| A8= | −1.933309299E−03 | 2.204972381E−03 | 1.299811175E−03 | 3.072299019E−02 |
| A10= | 8.336304701E−04 | −1.275915638E−03 | −6.931028060E−04 | −4.414342780E−02 |
| A12= | −1.917742194E−04 | 4.413900228E−04 | 2.024916255E−04 | 3.707968600E−02 |
| A14= | 2.257340295E−05 | −8.256576928E−05 | −3.171848003E−05 | −1.989645936E−02 |
| A16= | −1.068783882E−06 | 6.449304271E−06 | — | 6.872253503E−03 |
| A18= | — | — | — | −1.478520049E−03 |
| A20= | — | — | — | 1.803335234E−04 |
| A22= | — | — | — | −9.530755670E−06 |

| Surface # | 10 | 11 | 12 | 13 |
|---|---|---|---|---|
| k= | −9.50155E+01 | −8.60184E+01 | −2.43346E+01 | −3.22247E+01 |
| A4= | −2.881340306E−02 | 2.158822983E−02 | −2.867064487E−03 | 9.371105209E−04 |
| A6= | 1.670330966E−02 | −1.490857677E−02 | 1.609950611E−03 | 4.103395654E−04 |
| A8= | −1.000719200E−02 | 1.145334969E−02 | −1.701933277E−03 | −6.380087394E−04 |
| A10= | 3.936895951E−03 | −6.108160605E−03 | 6.581664396E−04 | 1.841963421E−04 |
| A12= | −1.168187408E−03 | 2.149219769E−03 | −9.869045702E−05 | −2.751660331E−05 |
| A14= | 2.041831546E−04 | −4.759203043E−04 | −1.128544636E−05 | 2.195660439E−06 |
| A16= | −1.458171490E−05 | 5.992526131E−05 | 7.081858299E−06 | −8.167739212E−08 |
| A18= | — | −3.249911673E−06 | −1.198372560E−06 | 4.128213446E−10 |
| A20= | — | — | 9.436267318E−08 | 3.728328016E−11 |
| A22= | — | — | −2.962684594E−09 | — |

| Surface # | 14 | 15 |
|---|---|---|
| k= | −9.90000E+01 | −5.98967E+00 |
| A4= | −1.614120431E−02 | −1.066495116E−02 |
| A6= | 1.433838450E−02 | 3.371366311E−03 |
| A8= | −1.296544518E−02 | −1.256880971E−03 |
| A10= | 7.840842497E−03 | 3.144127254E−04 |
| A12= | −3.294977196E−03 | −5.142744923E−05 |
| A14= | 9.863955200E−04 | 5.509537780E−06 |
| A16= | −2.134534436E−04 | −3.728133074E−07 |
| A18= | 3.355909900E−05 | 1.326483881E−08 |
| A20= | −3.819038690E−06 | 6.598358905E−11 |
| A22= | 3.102192892E−07 | −3.236104243E−11 |
| A24= | −1.748147464E−08 | 1.648297971E−12 |
| A26= | 6.477727230E−10 | −4.230280180E−14 |
| A28= | −1.416972470E−11 | 5.686905758E−16 |
| A30= | 1.384724217E−13 | −3.165332563E−18 |

In the 11th embodiment, the equation of the aspheric surface profiles of the aforementioned lens elements is the same as the equation of the 1st embodiment. Also, the definitions of these parameters shown in Table 11C are the same as those stated in the 1st embodiment with corresponding values for the 11th embodiment, so an explanation in this regard will not be provided again.

Moreover, these parameters can be calculated from Table 11A and Table 11B as the following values and satisfy the following conditions:

TABLE 11C
Schematic Parameters

| | | | |
|---|---|---|---|
| f [mm] | 4.77 | f/R3 | 0.08 |
| Fno | 2.60 | f12/f56 | 0.52 |
| HFOV [deg.] | 71.8 | f45/f23 | 0.97 |
| FOV [deg.] | 143.5 | f45/(CT4 + T45 + CT5) | 3.32 |
| TL/ImgH | 2.89 | f2345/(CT2 + T23 + CT3) | 0.91 |
| SL/ImgH | 1.46 | (R3 + R4)/(R3 − R4) | 1.22 |
| SL/TL | 0.50 | R7/f3 | 0.83 |
| TD/f | 3.28 | SL/f4567 | 1.01 |
| BL/f | 0.35 | T12/T56 | 1.52 |
| TL/CT2 | 13.61 | T56/CT5 | 1.44 |
| TL/CT3 | 5.22 | (T34 + CT4)/CT3 | 0.56 |
| TL/R4 | 2.94 | (TL − SL)/f123 | 0.16 |
| ATmax/f | 0.34 | (CT2 + T23 + CT3)/ | 1.83 |
| | | (CT4 + T45 + CT5) | |
| (EPD × SL)/(ImgH × CT4) | 1.52 | V5 | 19.5 |
| f/f56 | −0.74 | V7 | 25.6 |

### 12th Embodiment

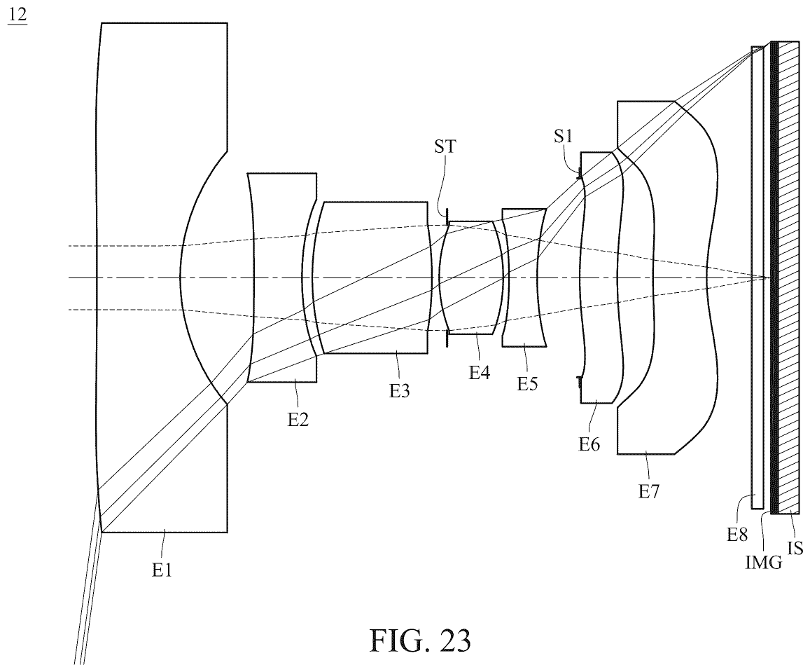

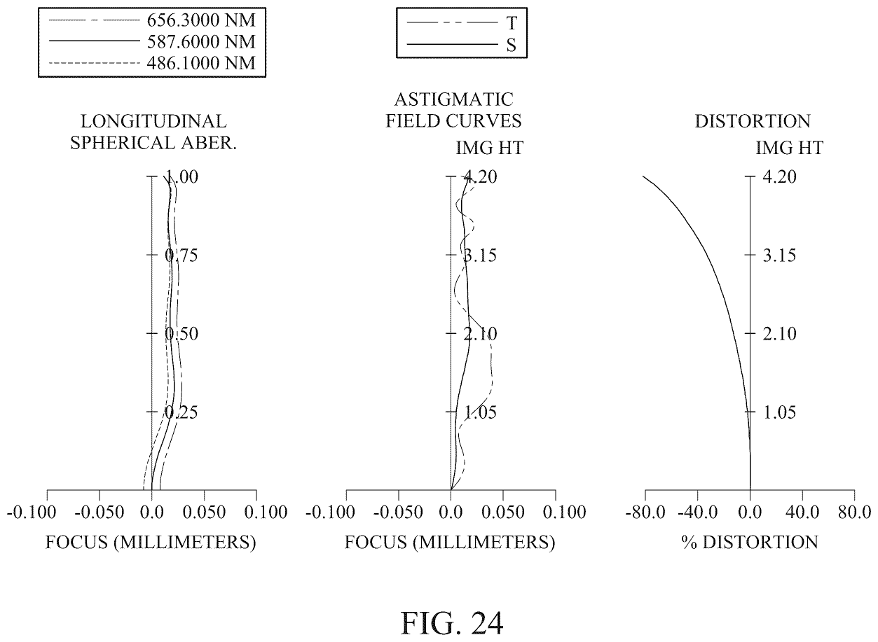

FIG. 23 is a schematic view of an image capturing unit according to the 12th embodiment of the present disclosure. FIG. 24 shows, in order from left to right, spherical aberration curves, astigmatic field curves and a distortion curve of the image capturing unit according to the 12th embodiment. In FIG. 23, the image capturing unit 12 includes the imaging optical lens assembly (its reference numeral is omitted) of the present disclosure and an image sensor IS. The imaging optical lens assembly includes, in order from an object side to an image side along an optical axis, a first lens element E1, a second lens element E2, a third lens element E3, an aperture stop ST, a fourth lens element E4, a fifth lens element E5, a stop S1, a sixth lens element E6, a seventh lens element E7, a filter E8 and an image surface IMG. The imaging optical lens assembly includes seven lens elements (E1, E2, E3, E4, E5, E6 and E7) with no additional lens element disposed between each of the adjacent seven lens elements.

The first lens element E1 with negative refractive power has an object-side surface being concave in a paraxial region thereof and an image-side surface being concave in a paraxial region thereof. The first lens element E1 is made of plastic material and has the object-side surface and the image-side surface being both aspheric. The object-side surface of the first lens element E1 has one inflection point. The object-side surface of the first lens element E1 has one critical point in an off-axis region thereof.

The second lens element E2 with negative refractive power has an object-side surface being concave in a paraxial region thereof and an image-side surface being concave in a paraxial region thereof. The second lens element E2 is made of plastic material and has the object-side surface and the image-side surface being both aspheric.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has one inflection point. The image-side surface of the sixth lens element E6 has one inflection point.

The object-side surface of the sixth lens element E6 has one critical point in an off-axis region thereof. The image-side surface of the sixth lens element E6 has one critical point in an off-axis region thereof.

The seventh lens element E7 with negative refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has two inflection points. The object-side surface of the seventh lens element E7 has one critical point in an off-axis region thereof. The image-side surface of the seventh lens element E7 has one critical point in an off-axis region thereof.

The filter E8 is made of glass material and located between the seventh lens element E7 and the image surface IMG, and will not affect the focal length of the imaging optical lens assembly. The image sensor IS is disposed on or near the image surface IMG of the imaging optical lens assembly.

In this embodiment, each of an Abbe number of the second lens element E2 and an Abbe number of the third lens element E3 is smaller than 40.0.

The detailed optical data of the 12th embodiment are shown in Table 12A and the aspheric surface data are shown in Table 12B below.

TABLE 12A
12th Embodiment
f = 3.18 mm, Fno = 2.80, HFOV = 82.3 deg.

| Surface # | | Curvature Radius | | Thickness | Material | Index | Abbe # | Focal Length |
|---|---|---|---|---|---|---|---|---|
| 0 | Object | Infinity | | 1000.000 | | | | |
| 1 | Lens 1 | −123.4568 | (ASP) | 1.483 | Plastic | 1.534 | 56.0 | −6.06 |
| 2 | | 3.3394 | (ASP) | 1.313 | | | | |
| 3 | Lens 2 | −101.8141 | (ASP) | 0.855 | Plastic | 1.639 | 23.5 | −6.63 |
| 4 | | 4.4286 | (ASP) | 0.184 | | | | |
| 5 | Lens 3 | 4.4371 | (ASP) | 2.129 | Plastic | 1.614 | 25.6 | 4.50 |
| 6 | | −5.9699 | (ASP) | 0.271 | | | | |
| 7 | Ape. Stop | Plano | | −0.141 | | | | |
| 8 | Lens 4 | 2.5976 | (ASP) | 1.139 | Plastic | 1.544 | 56.0 | 2.70 |
| 9 | | −2.8486 | (ASP) | 0.104 | | | | |
| 10 | Lens 5 | −7.3982 | (ASP) | 0.500 | Plastic | 1.669 | 19.5 | −4.10 |
| 11 | | 4.4813 | (ASP) | 0.758 | | | | |
| 12 | Stop | Plano | | 0.000 | | | | |
| 13 | Lens 6 | 5.9409 | (ASP) | 0.670 | Plastic | 1.544 | 56.0 | 43.40 |
| 14 | | 7.6228 | (ASP) | 0.636 | | | | |
| 15 | Lens 7 | 8.9711 | (ASP) | 0.955 | Plastic | 1.534 | 56.0 | −12.38 |
| 16 | | 3.6667 | (ASP) | 0.802 | | | | |

| | | | | | | | |
|---|---|---|---|---|---|---|---|
| 17 | Filter | Plano | 0.210 | Glass | 1.517 | 64.2 | — |
| 18 | | Plano | 0.134 | | | | |
| 19 | Image | Plano | — | | | | |

Note:
Reference wavelength is 587.6 nm (d-line).
An effective radius of the stop S1 (Surface 12) is 1.770 mm.

TABLE 12B
Aspheric Coefficients

| Surface # | 1 | 2 | 3 | 4 |
|---|---|---|---|---|
| k= | −9.90000E+01 | −2.03735E−01 | 9.90000E+01 | −5.87041E+00 |
| A4= | 6.270004617E−04 | −1.222704090E−03 | −9.271456309E−03 | 6.930223861E−03 |
| A6= | −3.097583017E−04 | 2.680648444E−03 | −1.737556511E−03 | 2.222608026E−02 |
| A8= | 7.701925060E−05 | −3.520216275E−03 | −7.004778267E−04 | −5.098718820E−02 |
| A10= | −9.066958502E−06 | 2.079482877E−03 | 2.472244046E−03 | 7.493767505E−02 |
| A12= | 6.074054055E−07 | −7.003623635E−04 | −1.640006273E−03 | −6.665104361E−02 |
| A14= | −2.386613595E−08 | 1.432809422E−04 | 5.433863952E−04 | 3.654484969E−02 |
| A16= | 5.134996628E−10 | −1.651361632E−05 | −9.953708739E−05 | −1.208711696E−02 |
| A18= | −4.674383535E−12 | 8.142548181E−07 | 9.633902464E−06 | 2.222878289E−03 |
| A20= | — | — | −3.854489266E−07 | −1.748238958E−04 |

| Surface # | 5 | 6 | 8 | 9 |
|---|---|---|---|---|
| k= | 3.87876E−01 | −5.44679E−02 | −8.38689E−01 | −1.77609E−02 |
| A4= | −1.900122319E−03 | 1.485276267E−03 | 1.014845669E−02 | 1.346100166E−03 |
| A6= | 4.977546679E−03 | −5.120681132E−03 | 4.383161148E−03 | −1.695473097E−01 |
| A8= | −4.226665367E−03 | 7.586831990E−03 | −2.153923914E−02 | 1.203836064E+00 |
| A10= | 1.427787791E−03 | −5.498817635E−03 | 3.558328371E−02 | −4.287059281E+00 |
| A12= | −1.563016664E−04 | 1.593415943E−03 | −3.118380477E−02 | 9.235957183E+00 |
| A14= | — | — | 9.307599165E−03 | −1.282067881E+01 |
| A16= | — | — | — | 1.152377624E+01 |
| A18= | — | — | — | −6.488527251E+00 |
| A20= | — | — | — | 2.081476690E+00 |
| A22= | — | — | — | −2.902299098E−01 |

| Surface # | 10 | 11 | 13 | 14 |
|---|---|---|---|---|
| k= | −9.55940E+01 | −8.63917E+01 | −1.69411E+01 | −2.73072E+01 |
| A4= | −9.627274076E−02 | 7.960157208E−02 | −1.890564291E−02 | −1.715428535E−03 |
| A6= | 1.199453431E−01 | −1.391552057E−01 | 4.864151176E−02 | 1.176477165E−02 |
| A8= | −1.413662385E−01 | 2.524114205E−01 | −9.747296521E−02 | −1.763697162E−02 |
| A10= | 7.842786511E−02 | −3.193474564E−01 | 1.123831321E−01 | 1.059456762E−02 |
| A12= | 7.341753350E−04 | 2.670157053E−01 | −8.469836971E−02 | −3.369363024E−03 |
| A14= | −3.045487408E−02 | −1.386574224E−01 | 4.283506570E−02 | 5.060895567E−04 |
| A16= | 1.201996382E−02 | 4.026597652E−02 | −1.450517220E−02 | −1.024125226E−05 |
| A18= | — | −4.980089367E−03 | 3.158409707E−03 | −5.933405421E−06 |
| A20= | — | — | −3.984738214E−04 | 4.966035117E−07 |
| A22= | — | — | 2.195831740E−05 | — |

| Surface # | 15 | 16 |
|---|---|---|
| k= | −8.98636E+01 | −4.99086E+00 |
| A4= | −4.252666297E−02 | 5.535963950E−04 |
| A6= | 1.212276608E−01 | −3.805498257E−02 |
| A8= | −3.754617131E−01 | 3.682519913E−02 |
| A10= | 6.763326277E−01 | −2.094783089E−02 |
| A12= | −7.903184627E−01 | 7.250180624E−03 |
| A14= | 6.313385273E−01 | −1.321451905E−03 |
| A16= | −3.544589008E−01 | 6.302957313E−07 |
| A18= | 1.417723623E−01 | 6.353894085E−05 |
| A20= | −4.049458818E−02 | −1.701548684E−05 |
| A22= | 8.183629292E−03 | 2.430727339E−06 |
| A24= | −1.141256800E−03 | −2.141994679E−07 |
| A26= | 1.043594364E−04 | 1.166999771E−08 |
| A28= | −5.626849268E−06 | −3.619557794E−10 |
| A30= | 1.355151234E−07 | 4.902587464E−12 |

In the 12th embodiment, the equation of the aspheric surface profiles of the aforementioned lens elements is the same as the equation of the 1st embodiment. Also, the definitions of these parameters shown in Table 12C are the same as those stated in the 1st embodiment with corresponding values for the 12th embodiment, so an explanation in this regard will not be provided again.

Moreover, these parameters can be calculated from Table 12A and Table 12B as the following values and satisfy the following conditions:

TABLE 12C
Schematic Parameters

| | | | |
|---|---|---|---|
| f [mm] | 3.18 | f/R3 | −0.03 |
| Fno | 2.80 | f12/f56 | 0.62 |
| HFOV [deg.] | 82.3 | f45/f23 | 0.52 |
| FOV [deg.] | 164.5 | f45/(CT4 + T45 + CT5) | 3.01 |
| TL/ImgH | 2.86 | f2345/(CT2 + T23 + CT3) | 1.04 |
| SL/ImgH | 1.37 | (R3 + R4)/(R3 − R4) | 0.92 |
| SL/TL | 0.48 | R7/f3 | 0.58 |
| TD/f | 3.42 | SL/f4567 | 1.16 |
| BL/f | 0.36 | T12/T56 | 1.73 |
| TL/CT2 | 14.04 | T56/CT5 | 1.52 |
| TL/CT3 | 5.64 | (T34 + CT4)/CT3 | 0.60 |
| TL/R4 | 2.71 | (TL − SL)/f123 | −0.04 |
| ATmax/f | 0.41 | (CT2 + T23 + CT3)/ | 1.82 |
| | | (CT4 + T45 + CT5) | |
| (EPD × SL)/(ImgH × CT4) | 1.37 | V5 | 19.5 |
| f/f56 | −0.71 | V7 | 56.0 |

### 13th Embodiment

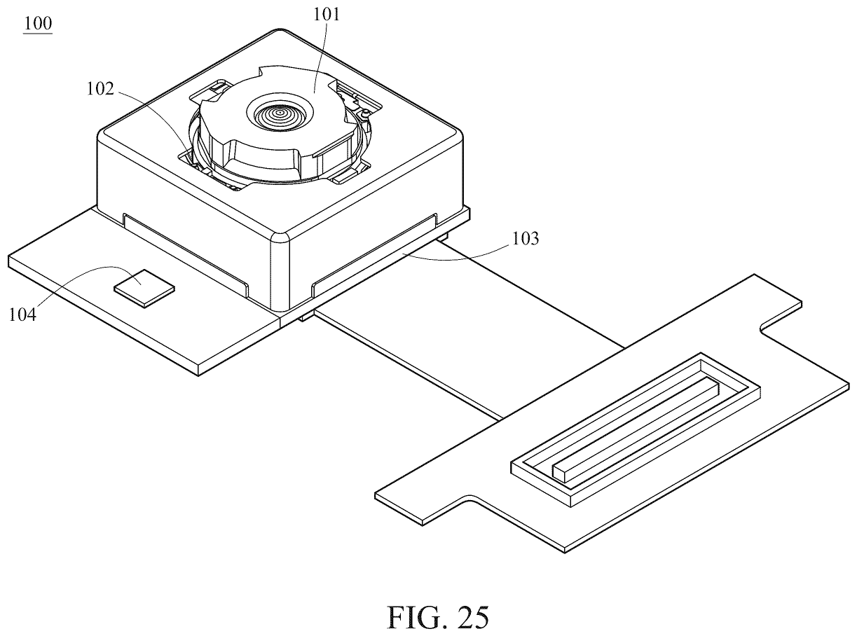

FIG. 25 is a perspective view of an image capturing unit according to the 13th embodiment of the present disclosure. In this embodiment, an image capturing unit 100 is a camera module including a lens unit 101, a driving device 102, an image sensor 103 and an image stabilizer 104. The lens unit 101 includes the imaging optical lens assembly disclosed in the 1st embodiment, a barrel and a holder member (their reference numerals are omitted) for holding the imaging optical lens assembly. However, the lens unit 101 may alternatively be provided with the imaging optical lens assembly disclosed in other embodiments of the present disclosure, and the present disclosure is not limited thereto. The imaging light converges in the lens unit 101 of the image capturing unit 100 to generate an image with the driving device 102 utilized for image focusing on the image sensor 103, and the generated image is then digitally transmitted to other electronic component for further processing.

The driving device 102 can have auto focusing functionality, and different driving configurations can be obtained through the usages of voice coil motors (VCM), micro electro-mechanical systems (MEMS), piezoelectric systems, or shape memory alloy materials. The driving device 102 is favorable for obtaining a better imaging position of the lens unit 101, so that a clear image of the imaged object can be captured by the lens unit 101 with different object distances. The image sensor 103 (for example, CCD or CMOS), which can feature high photosensitivity and low noise, is disposed on the image surface of the imaging optical lens assembly to provide higher image quality.

The image stabilizer 104, such as an accelerometer, a gyro sensor and a Hall effect sensor, is configured to work with the driving device 102 to provide optical image stabilization (OIS). The driving device 102 working with the image stabilizer 104 is favorable for compensating for pan and tilt of the lens unit 101 to reduce blurring associated with motion during exposure. In some cases, the compensation can be provided by electronic image stabilization (EIS) with image processing software, thereby improving image quality while in motion or low-light conditions.

### 14th Embodiment

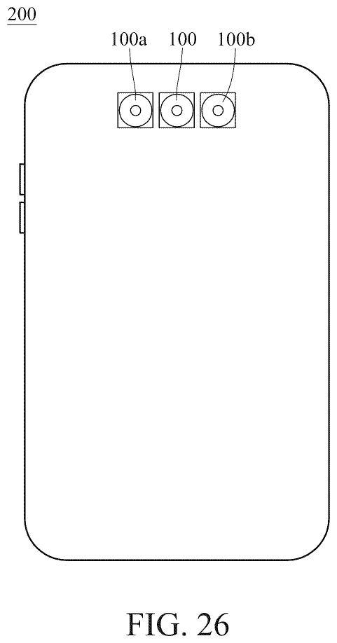

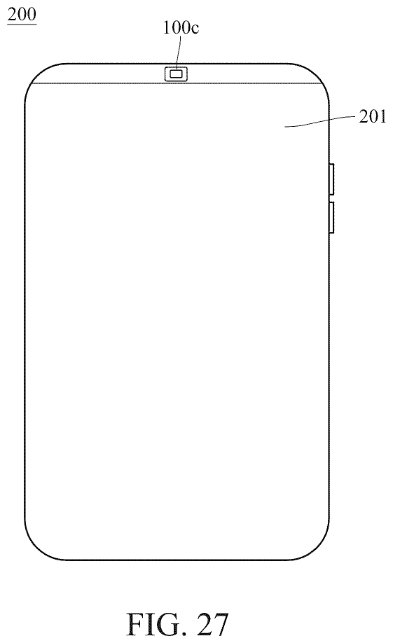

FIG. 26 is a perspective view of an electronic device according to the 14th embodiment of the present disclosure. FIG. 27 is another perspective view of the electronic device in FIG. 26.

In this embodiment, an electronic device 200 is a smartphone including the image capturing unit 100 disclosed in the 13th embodiment, an image capturing unit 100a, an image capturing unit 100b, an image capturing unit 100c and a display unit 201. As shown in FIG. 26, the image capturing unit 100, the image capturing unit 100a and the image capturing unit 100b are disposed on the same side of the electronic device 200 and face the same side, and each of the image capturing units 100, 100a and 100b has a single focal point. As shown in FIG. 27, the image capturing unit 100c and the display unit 201 are disposed on the opposite side of the electronic device 200, such that the image capturing unit 100c can be a front-facing camera of the electronic device 200 for taking selfies, but the present disclosure is not limited thereto. Furthermore, each of the image capturing units 100a, 100b and 100c can include the imaging optical lens assembly of the present disclosure and can have a configuration similar to that of the image capturing unit 100. In detail, each of the image capturing units 100a, 100b and 100c can include a lens unit, a driving device, an image sensor and an image stabilizer, and each of the lens unit can include an imaging optical lens assembly such as the imaging optical lens assembly of the present disclosure, a barrel and a holder member for holding the imaging optical lens assembly.

The image capturing unit 100 is a wide-angle image capturing unit, the image capturing unit 100a is a telephoto image capturing unit, the image capturing unit 100b is an ultra-wide-angle image capturing unit, and the image capturing unit 100c is a wide-angle image capturing unit. In this embodiment, the image capturing units 100, 100a and 100b have different fields of view, such that the electronic device 200 can have various magnification ratios so as to meet the requirement of optical zoom functionality. Moreover, as shown in FIG. 27, the image capturing unit 100c can have a non-circular opening, and the lens barrel or the lens elements in the image capturing unit 100c can have one or more trimmed edges at outer diameter positions thereof for corresponding to the non-circular opening. Therefore, it is favorable for further reducing the length of the image capturing unit 100c along single axis, thereby reducing the overall size of the lens, increasing the area ratio of the display unit 201 with respect to the electronic device 200, reducing the thickness of the electronic device 200, and achieving compactness of the overall module. In this embodiment, the electronic device 200 includes multiple image capturing units 100, 100a, 100b and 100c, but the present disclosure is not limited to the number and arrangement of image capturing units.

### 15th Embodiment

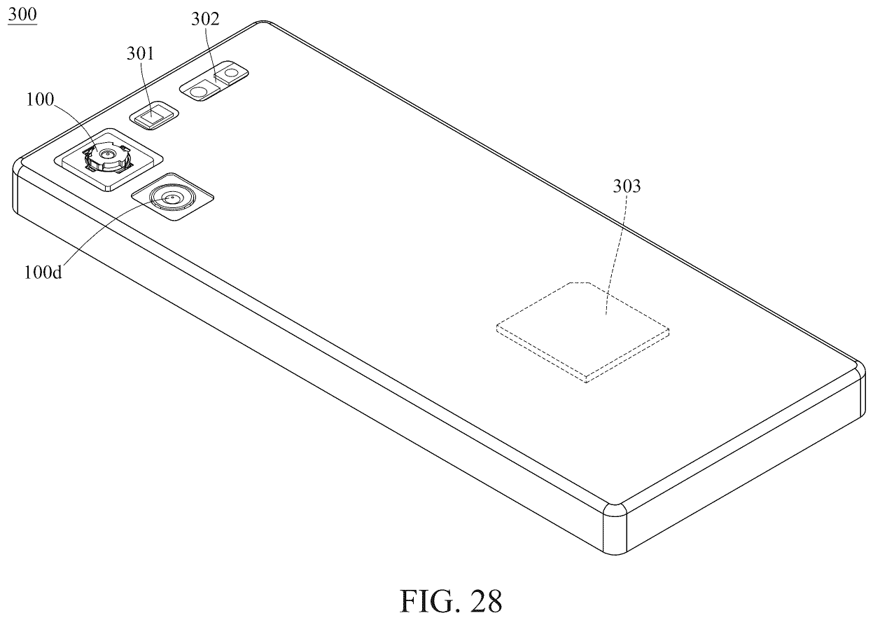

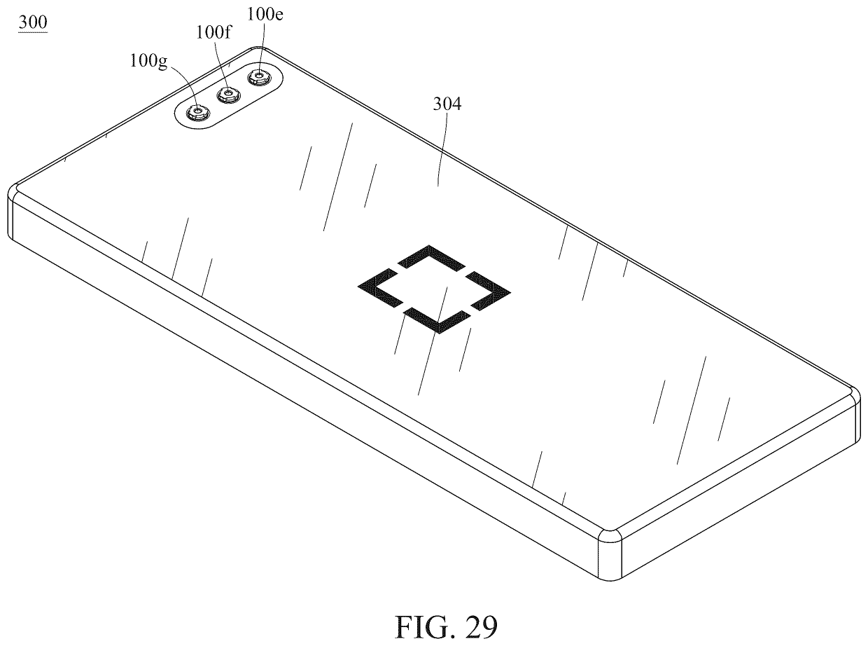

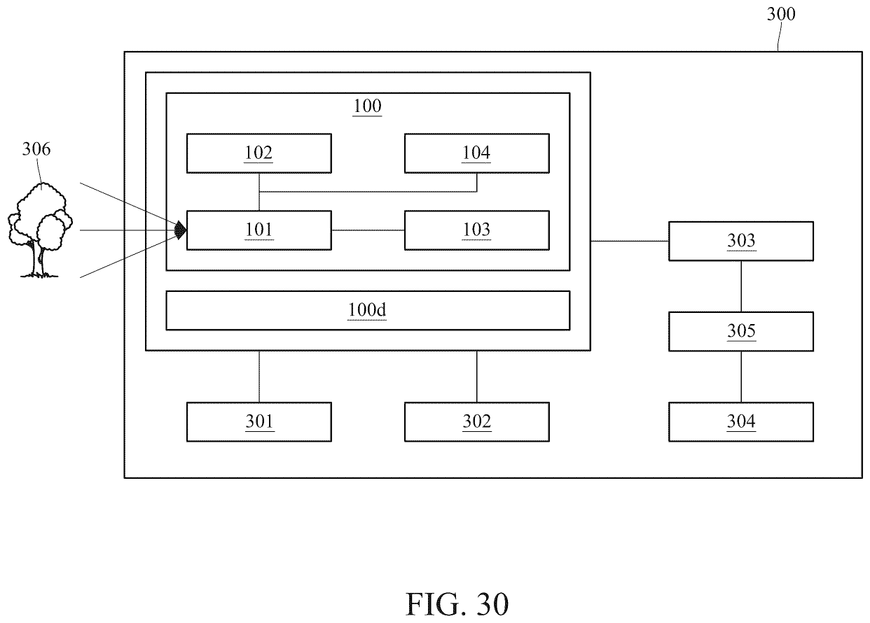

FIG. 28 is a perspective view of an electronic device according to the 15th embodiment of the present disclosure. FIG. 29 is another perspective view of the electronic device in FIG. 28. FIG. 30 is a block diagram of the electronic device in FIG. 28.

In this embodiment, an electronic device 300 is a smartphone including the image capturing unit 100 disclosed in the 13th embodiment, an image capturing unit 100d, an image capturing unit 100e, an image capturing unit 100f, an image capturing unit 100g, a flash module 301, a focus assist module 302, an image signal processor 303, a display module 304 and an image software processor 305. The image capturing unit 100 and the image capturing unit 100d are disposed on the same side of the electronic device 300. The focus assist module 302 can be a laser rangefinder or a ToF (time of flight) module, but the present disclosure is not limited thereto. The image capturing unit 100e, the image capturing unit 100f, the image capturing unit 100g and the display module 304 are disposed on the opposite side of the electronic device 300, and the display module 304 can be a user interface, such that the image capturing units 100e, 100f, 100g can be front-facing cameras of the electronic device 300 for taking selfies, but the present disclosure is not limited thereto. Furthermore, each of the image capturing units 100d, 100e, 100f and 100g can include the imaging optical lens assembly of the present disclosure and can have a configuration similar to that of the image capturing unit 100. In detail, each of the image capturing units 100d, 100e, 100f and 100g can include a lens unit, a driving device, an image sensor and an image stabilizer, and each of the lens unit can include an imaging optical lens assembly such as the imaging optical lens assembly of the present disclosure, a barrel and a holder member for holding the imaging optical lens assembly.

The image capturing unit 100 is a wide-angle image capturing unit, the image capturing unit 100d is an ultra-wide-angle image capturing unit, the image capturing unit 100e is a wide-angle image capturing unit, the image capturing unit 100f is an ultra-wide-angle image capturing unit, and the image capturing unit 100g is a ToF image capturing unit. In this embodiment, the image capturing units 100 and 100d have different fields of view, such that the electronic device 300 can have various magnification ratios so as to meet the requirement of optical zoom functionality. In addition, the image capturing unit 100g can determine depth information of the imaged object. In this embodiment, the electronic device 300 includes multiple image capturing units 100, 100d, 100e, 100f and 100g, but the present disclosure is not limited to the number and arrangement of image capturing units.

When a user captures images of an object 306, the light rays converge in the image capturing unit 100 or the image capturing unit 100d to generate images, and the flash module 301 is activated for light supplement. The focus assist module 302 detects the object distance of the imaged object 306 to achieve fast auto focusing. The image signal processor 303 is configured to optimize the captured image to improve image quality. The light beam emitted from the focus assist module 302 can be either conventional infrared or laser. In addition, the light rays may converge in the image capturing unit 100e, 100f or 100g to generate images. The display module 304 can include a touch screen, and the user is able to interact with the display module 304 and the image software processor 305 having multiple functions to capture images and complete image processing. Alternatively, the user may capture images via a physical button. The image processed by the image software processor 305 can be displayed on the display module 304.

### 16th Embodiment

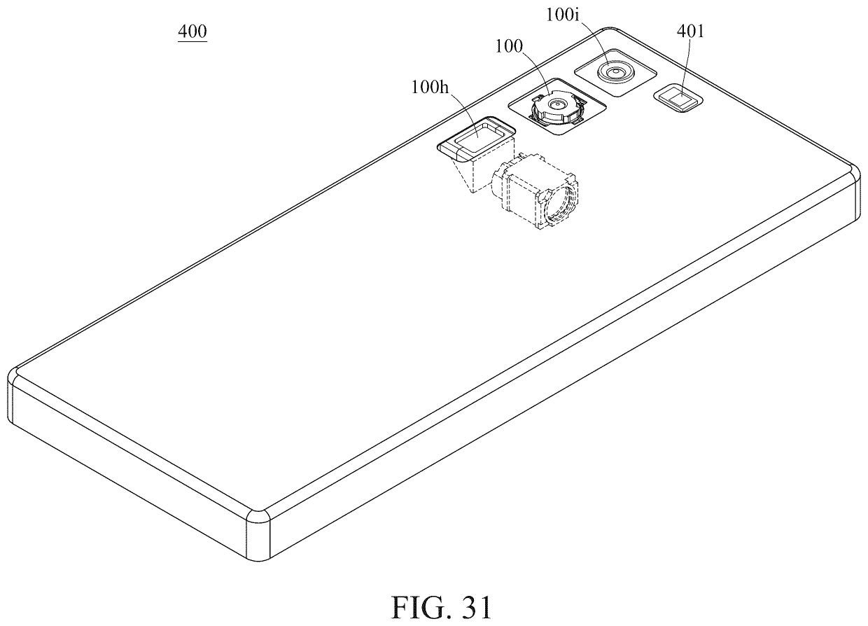

FIG. 31 is a perspective view of an electronic device according to the 16th embodiment of the present disclosure.

In this embodiment, an electronic device 400 is a smartphone including the image capturing unit 100 disclosed in the 13th embodiment, an image capturing unit 100h, an image capturing unit 100i, a flash module 401, a focus assist module, an image signal processor, a display module and an image software processor (not shown). The image capturing unit 100, the image capturing unit 100h and the image capturing unit 100i are disposed on the same side of the electronic device 400, while the display module is disposed on the opposite side of the electronic device 400. Furthermore, each of the image capturing units 100h and 100i can include the imaging optical lens assembly of the present disclosure and can have a configuration similar to that of the image capturing unit 100, and the details in this regard will not be provided again.

The image capturing unit 100 is a wide-angle image capturing unit, the image capturing unit 100h is a telephoto image capturing unit, and the image capturing unit 100i is an ultra-wide-angle image capturing unit. In this embodiment, the image capturing units 100, 100h and 100i have different fields of view, such that the electronic device 400 can have various magnification ratios so as to meet the requirement of optical zoom functionality. Moreover, the image capturing unit 100h can be a telephoto image capturing unit having a light-folding element configuration, such that the total track length of the image capturing unit 100h is not limited by the thickness of the electronic device 400. Moreover, the light-folding element configuration of the image capturing unit 100h can be similar to, for example, one of the structures shown in FIG. 35 to FIG. 37, which can be referred to foregoing descriptions corresponding to FIG. 35 to FIG. 37, and the details in this regard will not be provided again. In this embodiment, the electronic device 400 includes multiple image capturing units 100, 100h and 100i, but the present disclosure is not limited to the number and arrangement of image capturing units. When a user captures images of an object, light rays converge in the image capturing unit 100, 100h or 100i to generate images, and the flash module 401 is activated for light supplement. Further, the subsequent processes are performed in a manner similar to the abovementioned embodiment, so the details in this regard will not be provided again.

### 17th Embodiment

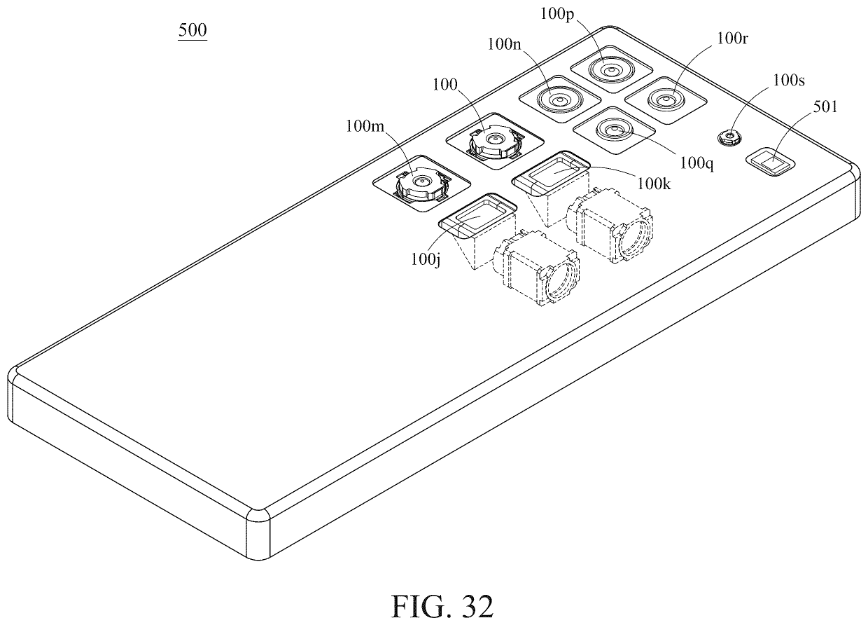

FIG. 32 is a perspective view of an electronic device according to the 17th embodiment of the present disclosure.

In this embodiment, an electronic device 500 is a smartphone including the image capturing unit 100 disclosed in the 13th embodiment, an image capturing unit 100j, an image capturing unit 100k, an image capturing unit 100m, an image capturing unit 100n, an image capturing unit 100p, an image capturing unit 100q, an image capturing unit 100r, an image capturing unit 100s, a flash module 501, a focus assist module, an image signal processor, a display module and an image software processor (not shown). The image capturing units 100, 100j, 100k, 100m, 100n, 100p, 100q, 100r and 100s are disposed on the same side of the electronic device 500, while the display module is disposed on the opposite side of the electronic device 500. Furthermore, each of the image capturing units 100j, 100k, 100m, 100n, 100p, 100q, 100r and 100s can include the imaging optical lens assembly of the present disclosure and can have a configuration similar to that of the image capturing unit 100, and the details in this regard will not be provided again.

The image capturing unit 100 is a wide-angle image capturing unit, the image capturing unit 100j is a telephoto image capturing unit, the image capturing unit 100k is a telephoto image capturing unit, the image capturing unit 100m is a wide-angle image capturing unit, the image capturing unit 100n is an ultra-wide-angle image capturing unit, the image capturing unit 100p is an ultra-wide-angle image capturing unit, the image capturing unit 100q is a telephoto image capturing unit, the image capturing unit 100r is a telephoto image capturing unit, and the image capturing unit 100s is a ToF image capturing unit. In this embodiment, the image capturing units 100, 100j, 100k, 100m, 100n, 100p, 100q and 100r have different fields of view, such that the electronic device 500 can have various magnification ratios so as to meet the requirement of optical zoom functionality. Moreover, each of the image capturing units 100j and 100k can be a telephoto image capturing unit having a light-folding element configuration. Moreover, the light-folding element configuration of each of the image capturing unit 100j and 100k can be similar to, for example, one of the structures shown in FIG. 35 to FIG. 37, which can be referred to foregoing descriptions corresponding to FIG. 35 to FIG. 37, and the details in this regard will not be provided again. In addition, the image capturing unit 100s can determine depth information of the imaged object. In this embodiment, the electronic device 500 includes multiple image capturing units 100, 100j, 100k, 100m, 100n, 100p, 100q, 100r and 100s, but the present disclosure is not limited to the number and arrangement of image capturing units. When a user captures images of an object, the light rays converge in the image capturing unit 100, 100j, 100k, 100m, 100n, 100p, 100q, 100r or 100s to generate images, and the flash module 501 is activated for light supplement. Further, the subsequent processes are performed in a manner similar to the abovementioned embodiments, and the details in this regard will not be provided again.

### 18th Embodiment

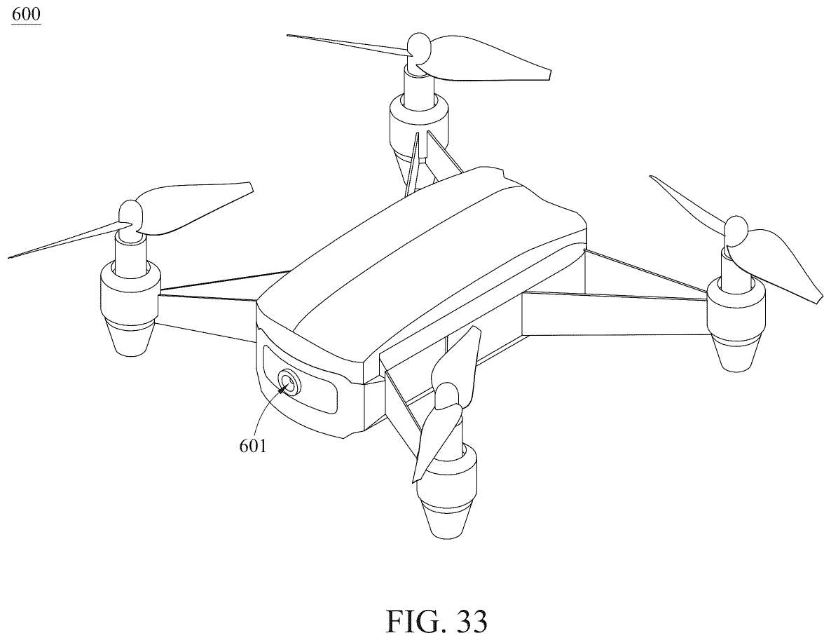

FIG. 33 is a schematic view of an electronic device according to the 18th embodiment of the present disclosure.

In this embodiment, an electronic device 600 may be a lightweight unmanned aerial vehicle, such as a drone camera. The electronic device 600 includes an image capturing unit 601. The image capturing unit 601 includes the imaging optical lens assembly disclosed in the 1st embodiment. The image capturing unit 601 can be a wide-angle image capturing unit. The image capturing unit 601, which is similar to the image capturing unit 100, can further include a barrel, a holder member or a combination thereof. The electronic device 600 captures an image by the image capturing unit 601. Preferably, the electronic device may further include a control unit, a display unit, a storage unit, a random access memory unit (RAM) or a combination thereof.

The smartphone in several embodiments is only exemplary for showing the image capturing unit of the present disclosure installed in an electronic device, and the present disclosure is not limited thereto. The image capturing unit can be optionally applied to optical systems with a movable focus. Furthermore, the imaging optical lens assembly of the image capturing unit features good capability in aberration corrections and high image quality, and can be applied to 3D (three-dimensional) image capturing applications, in products such as digital cameras, mobile devices, digital tablets, smart televisions, network surveillance devices, dashboard cameras, vehicle backup cameras, multi-camera devices, image recognition systems, motion sensing input devices, wearable devices and other electronic imaging devices.

The foregoing description, for the purpose of explanation, has been described with reference to specific embodiments. It is to be noted that TABLES 1A-12C show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An imaging optical lens assembly comprising seven lens elements, the seven lens elements being, in order from an object side to an image side along an optical path, a first lens element, a second lens element, a third lens element, a fourth lens element, a fifth lens element, a sixth lens element and a seventh lens element, and each of the seven lens elements having an object-side surface facing toward the object side and an image-side surface facing toward the image side;
wherein the first lens element has negative refractive power, the second lens element has negative refractive power, the image-side surface of the second lens element is concave in a paraxial region thereof, the fifth lens element has negative refractive power, the image-side surface of the fifth lens element is concave in a paraxial region thereof, the image-side surface of the sixth lens element is concave in a paraxial region thereof, the image-side surface of the seventh lens element is concave in a paraxial region thereof, and the image-side surface of the seventh lens element has at least one inflection point;
wherein an axial distance between the object-side surface of the first lens element and the image-side surface of the seventh lens element is TD, a focal length of the imaging optical lens assembly is f, an axial distance between the object-side surface of the first lens element and an image surface is TL, a central thickness of the third lens element is CT3, and the following conditions are satisfied:
$$2. < TD / f < 5.2 ; and$$
$$3. < TL / CT 3 < 8.00 .$$

2. The imaging optical lens assembly of claim 1, wherein the image-side surface of the fourth lens element is convex in a paraxial region thereof;
wherein a curvature radius of the object-side surface of the fourth lens element is R7, a focal length of the third lens element is f3, and the following condition is satisfied:
$$0.3 < R 7 / f 3 < 1.1 .$$

3. The imaging optical lens assembly of claim 1, wherein the seventh lens element has negative refractive power;
wherein an axial distance between the first lens element and the second lens element is T12, an axial distance between the fifth lens element and the sixth lens element is T56, and the following condition is satisfied:
$$0.25 < T 12 / T56 < 4.00 .$$

4. The imaging optical lens assembly of claim 1, wherein a maximum field of view of the imaging optical lens assembly is FOV, the axial distance between the object-side surface of the first lens element and the image surface is TL, a curvature radius of the image-side surface of the second lens element is R4, and the following conditions are satisfied:
$$110. degrees < FOV < 190. degrees ; and$$
$$0.1 < TL / R 4 < 12.00 .$$

5. The imaging optical lens assembly of claim 1, wherein a maximum value among axial distances between each of all adjacent lens elements of the imaging optical lens assembly is ATmax, the focal length of the imaging optical lens assembly is f, and the following condition is satisfied:
$$0.25 < A T max / f < 0.80 .$$

6. The imaging optical lens assembly of claim 1, wherein an axial distance between the image-side surface of the seventh lens element and the image surface is BL, the focal length of the imaging optical lens assembly is f, and the following condition is satisfied:
$$0. < BL / f < 0.90 .$$

7. The imaging optical lens assembly of claim 1, wherein a curvature radius of the object-side surface of the second lens element is R3, a curvature radius of the image-side surface of the second lens element is R4, and the following condition is satisfied:
$$0. < ( R 3 + R4 ) / ( R 3 - R 4 ) < 10.00 .$$

8. The imaging optical lens assembly of claim 1, further comprising an aperture stop, wherein an axial distance between the aperture stop and the image surface is SL, the axial distance between the object-side surface of the first lens element and the image surface is TL, and the following condition is satisfied:
$$0.35 < SL / TL < 0.65 .$$

9. The imaging optical lens assembly of claim 1, wherein the axial distance between the object-side surface of the first lens element and the image surface is TL, a central thickness of the second lens element is CT2, and the following condition is satisfied:
$$11. 00 < TL / CT 2 < 20.00 .$$

10. An image capturing unit, comprising:
the imaging optical lens assembly of claim 1; and
an image sensor disposed on the image surface of the imaging optical lens assembly.

11. An electronic device, comprising:
the image capturing unit of claim 10.

12. An imaging optical lens assembly comprising seven lens elements, the seven lens elements being, in order from an object side to an image side along an optical path, a first lens element, a second lens element, a third lens element, a fourth lens element, a fifth lens element, a sixth lens element and a seventh lens element, and each of the seven lens elements having an object-side surface facing toward the object side and an image-side surface facing toward the image side;
wherein the first lens element has negative refractive power, the image-side surface of the second lens element is concave in a paraxial region thereof, the fifth lens element has negative refractive power, the image-side surface of the fifth lens element is concave in a paraxial region thereof, the image-side surface of the sixth lens element is concave in a paraxial region thereof, the image-side surface of the seventh lens element is concave in a paraxial region thereof, and the image-side surface of the seventh lens element has at least one inflection point;
wherein an axial distance between the object-side surface of the first lens element and the image-side surface of the seventh lens element is TD, a focal length of the imaging optical lens assembly is f, a maximum value among axial distances between each of all adjacent lens elements of the imaging optical lens assembly is ATmax, a curvature radius of the object-side surface of the second lens element is R3, a curvature radius of the image-side surface of the second lens element is R4, and the following conditions are satisfied:
$$2. < TD / f < 6. ;$$
$$0.2 < ATmax / f < 0.85 ; and$$
$$0. < ( R 3 + R 4 ) / ( R 3 - R 4 ) < 10.00 .$$

13. The imaging optical lens assembly of claim 12, wherein the image-side surface of the first lens element is concave in a paraxial region thereof, and the object-side surface of the third lens element is convex in a paraxial region thereof.

14. The imaging optical lens assembly of claim 12, wherein the second lens element has negative refractive power;
wherein the imaging optical lens assembly further comprises an aperture stop, an axial distance between the object-side surface of the first lens element and an image surface is TL, a central thickness of the second lens element is CT2, an axial distance between the aperture stop and the image surface is SL, a maximum image height of the imaging optical lens assembly is ImgH, and the following conditions are satisfied:
$$11. 00 < TL / CT 2 < 20 \text{.00} ; and$$
$$1.2 < SL / ImgH < 1.7 .$$

15. The imaging optical lens assembly of claim 12, wherein an axial distance between the object-side surface of the first lens element and an image surface is TL, a maximum image height of the imaging optical lens assembly is ImgH, a maximum field of view of the imaging optical lens assembly is FOV, and the following conditions are satisfied:
$$2. < TL / ImgH < 4. ; and$$
$$110. degrees < FOV < 190. degrees .$$

16. The imaging optical lens assembly of claim 12, wherein an axial distance between the third lens element and the fourth lens element is T34, a central thickness of the third lens element is CT3, a central thickness of the fourth lens element is CT4, and the following condition is satisfied:
$$0.25 < ( T 34 + C T 4 ) / C T 3 < 0.90 .$$

17. The imaging optical lens assembly of claim 12, wherein an axial distance between the fifth lens element and the sixth lens element is T56, a central thickness of the fifth lens element is CT5, and the following condition is satisfied:
$$0.1 < T 56 / C T 5 < 5.00 .$$

18. The imaging optical lens assembly of claim 12, wherein an axial distance between the object-side surface of the first lens element and an image surface is TL, a central thickness of the third lens element is CT3, and the following condition is satisfied:
$$4. < T L / C T 3 < 6.50 .$$

19. The imaging optical lens assembly of claim 12, wherein an Abbe number of the fifth lens element is V5, and the following condition is satisfied:
$$5. < V 5 < 40.0 .$$

20. The imaging optical lens assembly of claim 12, wherein an Abbe number of the seventh lens element is V7, the focal length of the imaging optical lens assembly is f, a composite focal length of the fifth lens element and the sixth lens element is f56, and the following conditions are satisfied:
$$5. < V 7 < 40. ; and$$
$$- 2.5 \; 0 < f / f 56 < 0.00 .$$

21. An imaging optical lens assembly comprising seven lens elements, the seven lens elements being, in order from an object side to an image side along an optical path, a first lens element, a second lens element, a third lens element, a fourth lens element, a fifth lens element, a sixth lens element and a seventh lens element, and each of the seven lens elements having an object-side surface facing toward the object side and an image-side surface facing toward the image side;
wherein the first lens element has negative refractive power, the second lens element has negative refractive power, the image-side surface of the second lens element is concave in a paraxial region thereof, the fifth lens element has negative refractive power, the image-side surface of the fifth lens element is concave in a paraxial region thereof, the image-side surface of the sixth lens element is concave in a paraxial region thereof, the image-side surface of the seventh lens element is concave in a paraxial region thereof, and the image-side surface of the seventh lens element has at least one inflection point;
wherein an axial distance between the object-side surface of the first lens element and the image-side surface of the seventh lens element is TD, a focal length of the imaging optical lens assembly is f, a composite focal length of the second lens element, the third lens element, the fourth lens element and the fifth lens element is f2345, a central thickness of the second lens element is CT2, a central thickness of the third lens element is CT3, an axial distance between the second lens element and the third lens element is T23, and the following conditions are satisfied:
$$2. < TD / f < 5.2 ; and$$
$$0.8 < f 2345 / ( C T 2 + T 23 + C T 3 ) < 160 .$$

22. The imaging optical lens assembly of claim 21, wherein a composite focal length of the second lens element and the third lens element is f23, a composite focal length of the fourth lens element and the fifth lens element is f45, and the following condition is satisfied:
$$0. < f 45 / f 23 < 2.00 .$$

23. The imaging optical lens assembly of claim 21, further comprising an aperture stop, wherein an axial distance between the object-side surface of the first lens element and an image surface is TL, an axial distance between the aperture stop and the image surface is SL, a composite focal length of the first lens element, the second lens element and the third lens element is f123, and the following condition is satisfied:
$$- 2.00 < ( T L - S L ) / f 123 < 2.00 .$$

24. The imaging optical lens assembly of claim 21, further comprising an aperture stop, wherein an axial distance between the aperture stop and an image surface is SL, a composite focal length of the fourth lens element, the fifth lens element, the sixth lens element and the seventh lens element is f4567, and the following condition is satisfied:
$$0. < S L / f 4567 < 2.20 .$$

25. The imaging optical lens assembly of claim 21, wherein a composite focal length of the first lens element and the second lens element is f12, a composite focal length of the fifth lens element and the sixth lens element is f56, and the following condition is satisfied:
$$0.2 < f 12 / f 56 < 1.3 .$$

26. The imaging optical lens assembly of claim 21, further comprising an aperture stop, wherein an entrance pupil diameter of the imaging optical lens assembly is EPD, an axial distance between the aperture stop and an image surface is SL, a maximum image height of the imaging optical lens assembly is ImgH, a central thickness of the fourth lens element is CT4, and the following condition is satisfied:
$$0.5 < ( EPD \times SL ) / ( ImgH \times CT 4 ) < 2.50 .$$

27. The imaging optical lens assembly of claim 21, wherein the central thickness of the second lens element is CT2, the central thickness of the third lens element is CT3, a central thickness of the fourth lens element is CT4, a central thickness of the fifth lens element is CT5, the axial distance between the second lens element and the third lens element is T23, an axial distance between the fourth lens element and the fifth lens element is T45, the focal length of the imaging optical lens assembly is f, a curvature radius of the object-side surface of the second lens element is R3, and the following conditions are satisfied:
$$1. 40 < ( C T 2 + T 23 + C T 3 ) / ( C T 4 + T 45 + C T 5 ) < 2.6 ; and$$
$$- 0.5 < f / R 3 < 0.5 .$$

28. The imaging optical lens assembly of claim 21, wherein a composite focal length of the fourth lens element and the fifth lens element is f45, a central thickness of the fourth lens element is CT4, a central thickness of the fifth lens element is CT5, an axial distance between the fourth lens element and the fifth lens element is T45, and the following condition is satisfied:
$$2. < f 45 / ( C T 4 + T 45 + C T 5 ) < 7.00 .$$

29. The imaging optical lens assembly of claim 21, wherein each of at least two of an Abbe number of the second lens element, an Abbe number of the third lens element and an Abbe number of the sixth lens element is smaller than 40.0.

30. The imaging optical lens assembly of claim 21, wherein the axial distance between the object-side surface of the first lens element and the image-side surface of the seventh lens element is TD, the focal length of the imaging optical lens assembly is f, an axial distance between the object-side surface of the first lens element and an image surface is TL, the central thickness of the second lens element is CT2, the central thickness of the third lens element is CT3, a maximum value among axial distances between each of all adjacent lens elements of the imaging optical lens assembly is ATmax, a curvature radius of the object-side surface of the second lens element is R3, a curvature radius of the image-side surface of the second lens element is R4, the composite focal length of the second lens element, the third lens element, the fourth lens element and the fifth lens element is f2345, the axial distance between the second lens element and the third lens element is T23, and the following conditions are satisfied:
$$2.86 \leq TD / f \leq 4.95 ;$$
$$4.73 \leq TL / CT 3 \leq 5.73 ;$$
$$0.31 \leq ATmax / f \leq 0.61 ;$$
$$0.7 \leq ( R3 + R 4 ) / ( R 3 - R 4 ) \leq 4.15 ; and$$
$$0.89 \leq f 2 \; 345 / ( C T 2 + T 23 + C T 3 ) \leq 1.1 .$$
